(19) United States
(12) Patent Application Publication
(10) Pub. No.: US 2022/0272798 A1
(43) Pub. Date: Aug. 25, 2022

(54) TRANSPARENT HEATING FILM

(71) Applicant: ITED INC., Daejeon (KR)

(72) Inventors: Jee Hoon SEO, Namyangju-si, Gyeonggi-do (KR); Kum Pyo YOO, Anseong-si, Gyeonggi-do (KR); Bu Jong KIM, Seoul (KR)

(21) Appl. No.: 17/631,151

(22) PCT Filed: Jul. 30, 2020
(86) PCT No.: PCT/KR2020/010086

§ 371 Date: Jan. 28, 2022

(30) Foreign Application Priority Data
Jul. 31, 2019 (KR) 10-2019-0092816
Oct. 16, 2019 (KR) 10-2019-0128648
Mar. 26, 2020 (KR) 10-2020-0036643

(51) Int. Cl. H05B 3/86

(52) U.S. Cl. CPC H05B 3/86; H01Q 1/22

(57) ABSTRACT

A transparent heating film according to an embodiment includes: a transparent substrate including a top surface in which a plurality of grooves are formed and a flat bottom surface; and a plurality of metal nanostructures located on the top surface of the transparent substrate. The metal nanostructures have a first distance from a middle plane of the transparent heating film, and an imaginary line extending from the top surface of the transparent substrate has a second distance from the middle plane of the transparent heating film. The transparent heating film includes a first region in which the first distance is shorter than the second distance, and the first distance is a shortest distance between a first point at which each of the metal nanostructure and the transparent substrate are in contact with each other and the middle plane, the first point being located in each of the grooves. A radius of curvature of the metal nanostructures in a region adjacent to the first points may be equal to or smaller than a radius of curvature of the groove in the region adjacent to the first point.

### BACKGROUND OF THE INVENTION

### 1. Field of the Invention

An embodiment relates to a transparent heating film. Specifically, the embodiment relates to a transparent heating film that can be used as a heating element in the form of a film.

### 2. Description of the Prior Art

Carbon nanotubes, graphene, metal meshes, metal nanowires, and the like are being developed as next-generation transparent electrode materials to replace ITO. In particular, silver nanowires are attracting attention from the industry for high conductivity and high flexibility unique to metal.

In the traffic (transportation) industry centered on automobiles, there has been a problem in that a driver's view may not be secured due to fogging or frost caused by a temperature difference between the interior and exterior of a vehicle. To date, various attempts have been made to remove such fogging or frost, and recently, a method of mounting a conductive heating element such as a tungsten wire or a metal thin film inside laminated glass has been invented. However, it seems that such a conductive heating element is not universally installed in automobiles due to a high cost, a complicated manufacturing process, and a difficulty in repairing when glass is broken. In particular, the conductive heating element used in a vehicle window requires high electrical conductivity for rapid heating, high light transmittance to secure visibility, and sufficient flexibility to prevent the conductive heating element from being damaged in a glass bending process.

### SUMMARY OF THE INVENTION

In view of the foregoing, an embodiment provides a transparent heating film that is easy to install on a target member, is excellent in transparency and electrical conductivity, and is improved in terms of haze.

A transparent heating film according to an embodiment includes: a transparent substrate including a top surface in which a plurality of grooves are formed and a flat bottom surface; and a plurality of metal nanostructures located on the top surface of the transparent substrate. The metal nanostructures have a first distance from a middle plane of the transparent heating film, and an imaginary line extending from the top surface of the transparent substrate has a second distance from the middle plane of the transparent heating film. The transparent heating film includes a first region in which the first distance is shorter than the second distance, the first distance being the shortest distance between a first point at which each of the metal nanostructure and the transparent substrate are in contact with each other and the middle plane. The first point is located in each of the grooves, and a radius of curvature of the metal nanostructures in a region adjacent to the first points is equal to or smaller than a radius of curvature of the groove in the region adjacent to the first point.

The transparent heating film according to an embodiment is easy to install and is excellent in electrical conductivity to be capable of uniformly generating current within a short time.

The transparent heating film according to an embodiment is improved in terms of haze compared to a conventional one and is excellent in transparency. Even when the transparent heating film is attached to a transparent member, a user may not be able to recognize an attached conductive film.

### BRIEF DESCRIPTION OF THE DRAWINGS

The above and other aspects, features, and advantages of the present disclosure will be more apparent from the following detailed description taken in conjunction with the accompanying drawings, in which:

FIG. 1 is a perspective view of a transparent heating film according to a first embodiment.

FIG. 2 is a perspective view of a metal nanostructure.

FIG. 3 is a cross-sectional view of a transparent heating film according to the first embodiment.

FIG. 4 is another cross-sectional view of the transparent heating film according to the first embodiment.

FIG. 5 is a partially enlarged view of the transparent heating film of the first embodiment.

FIG. 6 is a perspective view of a transparent heating film according to a second embodiment.

FIG. 7 is a cross-sectional view of a transparent heating film according to the second embodiment.

FIG. 8 is another cross-sectional view of the transparent heating film according to the second embodiment.

FIG. 9 is a perspective view of a transparent heating film according to a third embodiment.

FIG. 10 is a cross-sectional view of the transparent heating film according to the third embodiment.

FIG. 11 is a cross-sectional view of a transparent heating film according to a fourth embodiment.

FIG. 12 illustrates cross-sectional SEM photographs of the transparent heating film according to the first embodiment.

FIG. 13 illustrates an AFM measurement result of the transparent heating film according to the first embodiment.

FIG. 14 illustrates an AFM measurement result and a front SEM photograph of the transparent substrate of the transparent heating film according to the first embodiment.

FIG. 15 is a front SEM photograph of a conductive network on a transparent substrate.

FIG. 16 illustrates an AFM measurement result of a conductive network on a transparent substrate.

FIG. 17 is a front SEM photograph of the transparent heating film of the third embodiment.

FIG. 18 illustrates an AFM measurement result of the transparent heating film of the third embodiment.

FIG. 19 is a table comparing AFM measurement results before and after formation of an adhesive layer.

FIG. 20 is a cross-sectional SEM photograph of the transparent heating film of the third embodiment.

FIG. 21 is another cross-sectional SEM photograph of the transparent heating film of the third embodiment.

FIG. 22 is a cross-sectional view of a transparent heating film according to a fifth embodiment.

FIG. 23 is a view illustrating the conductive layer of the transparent heating film according to the fifth embodiment in detail.

FIG. 24 is another view illustrating the conductive layer of the transparent heating film according to the fifth embodiment in detail.

FIG. 25 is an exploded perspective view of the transparent heating film according to the fifth embodiment.

FIG. 26 is another cross-sectional view of the transparent heating film according to the fifth embodiment.

FIG. 27 is still another cross-sectional view of the transparent heating film according to the fifth embodiment.

FIG. 28 is a view illustrating electromagnetic wave signal reception of the transparent heating film according to the fifth embodiment.

FIG. 29 is a cross-sectional view of the transparent heating film according to the fifth embodiment and a light blocking member.

FIG. 30 is another cross-sectional view of the transparent heating film according to the fifth embodiment and a light blocking member.

FIG. 31 is a cross-sectional view of a transparent heating film according to a sixth embodiment.

FIG. 32 is a cross-sectional view of a transparent heating film according to a seventh embodiment.

FIG. 33 is a perspective view illustrating a middle layer and an antenna of the transparent heating film according to the seventh embodiment.

FIG. 34 is a cross-sectional view of a transparent heating film according to an eighth embodiment.

FIG. 35 is a view illustrating electromagnetic wave signal reception of the transparent heating film according to the eighth embodiment.

FIG. 36 is a cross-sectional view of the transparent heating film according to the eighth embodiment and a light blocking member.

### DETAILED DESCRIPTION OF THE EXEMPLARY EMBODIMENTS

Hereinafter, specific embodiments will be described in detail with reference to the drawings. However, the technical idea of the present disclosure is not limited to the presented embodiments, and a person ordinarily skilled in the art who understands the idea of the present disclosure may easily propose other degenerative inventions or other embodiments falling within the scope of the idea of the present disclosure through addition, change, deletion, etc. of other components within the scope of the same idea, but these also fall within the scope of the idea of the present disclosure.

In addition, components having the same functions within the scope of the same idea illustrated in the drawings of respective embodiments will be described using the same reference numerals.

A transparent heating film according to an embodiment may include: a transparent substrate including a top surface in which a plurality of grooves are formed and a flat bottom surface; and a plurality of metal nanostructures located on the top surface of the transparent substrate. The metal nanostructures may have a first distance from a middle plane of the transparent heating film, and an imaginary line extending from the top surface of the transparent substrate may have a second distance from the middle plane of the transparent heating film. The transparent heating film may include a first region in which the first distance is shorter than the second distance, the first distance being the shortest distance between a first point at which each of the metal nanostructure and the transparent substrate are in contact with each other and the middle plane. The first point may be located in each of the grooves, and a radius of curvature of the metal nanostructures in a region adjacent to the first points may be equal to or smaller than a radius of curvature of the groove in the region adjacent to the first point. The distance of the middle plane of the transparent heating film from the bottom surface of the transparent substrate may be half of an average distance between the bottom surface of the transparent substrate and upper surfaces of the plurality of metal nanostructures. The distance of the middle plane of the transparent heating film from the bottom surface of the transparent substrate may be half of an average distance between the imaginary line and the bottom surface of the transparent substrate. The metal nanostructures may each include a first portion and a second portion, the first portion may be a portion located away from the bottom surface of the transparent substrate with reference to the imaginary line extending from the top surface of the transparent substrate, and the second portion may be a portion located close to the bottom surface of the transparent substrate with reference to the imaginary line. The first portion may include a region having a smaller radius of curvature than the second portion. When the transparent heating film is cut in a plane perpendicular to the bottom surface of the transparent substrate, a cross-sectional area of the first portion may be greater than a cross-sectional area of the second portion. When the transparent heating film is cut in a plane perpendicular to the bottom surface of the transparent substrate, the metal nanostructures may each have a circular cross section, the center of the cross-section may have a third distance from the middle plane, and the third distance may be greater than the second distance. When the transparent heating film is cut in a plane perpendicular to the bottom surface of the transparent substrate, the cross section of the metal nanostructure may have a short axis and a major axis, the major axis may have a fourth distance from the middle plane, and the fourth distance may be greater than the second distance.

The transparent heating film of an embodiment may further include a coating layer coated on the metal nanostructures, and wherein the coating layer may be in contact with the transparent substrate, but may not be in contact with the first point. The radius of curvature of the metal nanostructure in the region adjacent to the first point may be smaller than the radius of curvature of the groove in the region adjacent to the first point, and the coating layer may be interposed between the groove and the metal nanostructure. The transparent heating film may further include a bus bar, and at least one of the metal nanostructures may be in contact with the bus bar, but may not be in contact with the coating layer. The radius of curvature of the at least one metal nanostructure in a region adjacent to the first point may be smaller than the radius of curvature of the grooves in the regions adjacent to the first point, and the bus bar may be interposed between the grooves and the metal nanostructures.

Heat may be generated from the metal nanostructures due to movement of electrons transferred to the metal nanostructures via an external voltage, the heat generated from the metal nanostructures may be transferred to the outside of the bottom surface via the top surface of the transparent substrate, and the temperature of the bottom surface of the transparent substrate facing the plurality of grooves may correspond to the temperature of the bottom surface of the transparent substrate not facing the plurality of grooves.

A second region of the transparent film of an embodiment is defined as a region in which the first distance and the second distance are equal to each other, and no groove may be formed on the top surface of the transparent substrate corresponding to the metal nanostructures of the second region.

The top surface of the transparent substrate of the first region may include protrusions, the protrusions may have a fifth distance from the middle plane, the fifth distance being greater than the second distance, and an imaginary straight line connecting the protrusions may pass through the metal nanostructures. One metal nanostructure may be located between two of the protrusions, and the distance between the protrusions may be greater than the diameter of the metal nanostructure. At least one metal nanostructure may be enclosed in the coating layer, the coating layer may be divided into three equal sections by planes parallel to the bottom surface of the transparent substrate, and when the sections are defined as a first space, a second space, and a third space from a space closest to the transparent substrate, a first area occupied by the metal nanostructures in the first space may be greater than a second area occupied by the metal nanostructures in the second space, and the second area occupied by the metal structures in the third space may be greater than a third area occupied by the metal nanostructures in the third space. An edge of the transparent substrate of the transparent heating film may be curved, the coating layer may be curved in a same direction as the transparent substrate, and the transparent substrate and the coating layer may have different radii of curvature.

A transparent heating film according to an embodiment may include: a transparent substrate including a first surface including curved surfaces and non-curved surfaces and a second surface located in a direction opposite to the first surface; and a plurality of metal nanostructures located at positions corresponding to the curved surfaces and forming a conductive network by intersecting each other. The distance between the second surface and the curved surface may be smaller than the distance between the second surface and the non-curved surfaces.

### 1. First Embodiment

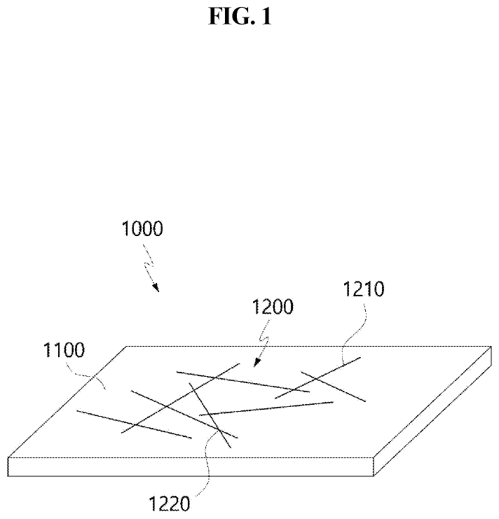

FIG. 1 is a perspective view of a transparent heating film according to a first embodiment.

Referring to FIG. 1, a transparent heating film 1000 includes a transparent substrate 1100 and a conductive network 1200. The conductive network 1200 includes intersection points 1220 formed since different metal nanostructures 1210 intersect with each other.

The transparent heating film 1000 may be attached to a transparent target member. The target member may be a base material on which the transparent conductive film 1000 is installed. The target member may be a member for maintaining the shape of the transparent conductive film 1000. The transparent conductive film 1000 may be installed on one surface of the target member. The other surface of the target member opposite to the one surface may be in contact with the outside air. The temperatures of one surface and the other surface of the target member may be different from each other.

The target member may be a plastic member, a glass member, or another transparent member. The target member may be a wind glass, a windscreen, or a windshield of a vehicle. The target member may be a window located at the front side of the vehicle. The target member may be a window located at the lateral side or rear side of the vehicle. In addition, the target member may be a window for construction.

The transparent heating film 1000 may be optically transparent. The transparent heating film 1000 may not block the wavelength of the visible ray region. The transparent heating film 1000 may be invisible. The transparent heating film 1000 may be invisible even after being attached to the target member. The transparent heating film 1000 may not block the user's view. The transparent heating film 1000 may not block the driver's view even when it is attached to the windshield of a vehicle.

The transparent heating film 1000 may include a conductive material. The transparent heating film 1000 may have electrical conductivity. The transparent heating film 1000 may provide a passage for electrons and current to move. The transparent heating film 1000 may receive external electric energy and transfer thermal energy generated from the electric energy. The transparent heating film 1000 may generate and transfer heat. When a voltage applied from the outside is transferred to the transparent heating film 1000, electrons move in the transparent heating film 1000, so that heat can be generated from the transparent heating film 1000. Heat generated from the transparent heating film 1000 may be transferred to the outside of the transparent heating film 1000 and a target member.

The transparent heating film 1000 may block external heat. The transparent heating film 1000 may block external infrared and ultraviolet rays. When the transparent heating film 1000 is located in an enclosed space, the transparent heating film 1000 may block external infrared and ultraviolet rays, thereby maintaining the internal temperature constant. When the temperature difference between the outside and the inside is large, the transparent heating film 1000 may help prevent the internal temperature from rising sharply.

The transparent heating film 1000 may block electromagnetic waves. The transparent heating film 1000 may block a signal in a specific frequency region.

When the target member is located between an external space and an enclosed internal space, a temperature difference between the internal and external spaces may be large. That is, the temperature difference between the inside air and the outside air may be large. Accordingly, a temperature difference between one side and the other side of the target member may be large. When water vapor contained in air comes into contact with the target member and the temperature of one side or the other side of the target member is lower than or equal to the dew point temperature of the water vapor, fogging or frost may occur on one side or the other side of the target member.

The temperature of the target member may be changed when heat generated from the transparent heating film 1000 is transferred to the target member. Therefore, when water vapor contained in the air of the internal space and the external space comes into contact with the target member, the temperature of one side or the other side of the target member may rise to be higher than or equal to the dew point temperature of the water vapor that comes into contact with the target member by the heat generated from the transparent heating film 1000. The heat generated from the transparent heating film 1000 may remove fogging or frost generated on one side or the other side of the target member, or prevent occurrence of the same.

The transparent substrate 1100 may be used for maintaining the shape of the transparent heating film 1000. The transparent substrate 1100 may be optically transparent. The transparent substrate 1100 may transmit light, electromagnetic waves, and heat. The transparent substrate 1100 may transfer thermal energy generated in another layer. The transparent substrate 1100 may have a flexible structure. The transparent substrate 1100 may have a hydrocarbon polymer structure, but is not limited thereto. Specifically, the transparent substrate may be a thermoplastic plastic such as polyethylene terephthalate (PET).

The conductive network 1200 may be formed on the transparent substrate 1100. The conductive network 1200 may be located on the transparent substrate 1100.

The conductive network 1200 may be optically transparent. The conductive network 1200 may not block a wavelength in the visible ray region. When the conductive network 1200 is transparently formed, the light transmittance of the conductive network 1200 may be lower than that of the transparent substrate 1100.

The conductive network 1200 may include a conductive material. The conductive material included in the conductive network 1200 may be a metal. The material included in the conductive network 1200 may be silver (Ag), gold (Au), platinum (Pt), copper (Cu), or another metal. The material included in the conductive network 1200 may be a nanostructure made of silver (Ag), gold (Au), platinum (Pt), copper (Cu), or another metal, but is not limited thereto. The conductive network 1200 may have electrical conductivity, and the conductive network 1200 may provide a passage for electrons to move. The conductive network 1200 may receive external electric energy and transfer thermal energy generated from the electric energy. The conductive network 1200 may generate and transfer heat. The sheet resistance value of the conductive network 1200 may be smaller than the sheet resistance value of the transparent substrate 1100.

The conductive network 1200 may be formed by a plurality of metal nanostructures 1210. The conductive network 1200 may have a network structure in which the plurality of metal nanostructures 1210 are connected by the intersection points 1220. The sheet resistance of the conductive network 1200 may vary depending on the number, diameter, and length of the metal nanostructures 1210. The sheet resistance of the conductive network 1200 may be lower as the number of metal nanostructures 1210 increases, the diameter of metal nanostructures 1210 increases, and the length of metal nanostructures 1210 decreases. The sheet resistance of the conductive network 1200 may be lower as the number of intersection points 1220 increases. Alternatively, the sheet resistance of the conductive network 1200 may also vary depending on the shape and size of the intersection points 1220. The conductive network 1200 may receive a voltage from an external power source, and when the voltage applied from the outside is transmitted to the conductive network 1200, electrons move in the conductive network 1200 so that heat can be generated from the transparent heating film 1000. Electrons on the conductive network 1200 may move from one metal nanostructure 1210 to another metal nanostructure 1210 through an intersection point 1210.

The conductive network 1200 may block external heat. The conductive network 1200 may block external infrared and ultraviolet rays. When the conductive network 1200 is located in an enclosed space, the conductive network 1200 blocks external infrared and ultraviolet rays so that the internal temperature can be maintained constant. When the temperature difference between the outside and the inside of the conductive network 1200 is large, the conductive network 1200 may help prevent the internal temperature from rising sharply.

The conductive network 1200 may block electromagnetic waves. The conductive network 1200 may block a signal in a specific frequency region.

Electromagnetic waves including light in the visible light region may be scattered, reflected, refracted, diffracted, or dispersed. The scattered, reflected, refracted, diffracted, or dispersed property of electromagnetic waves as described above may occur when passing through a medium or collide with an obstacle. The conductive network 1200 may be a medium or an obstacle of a wavelength including light. When light is scattered or diffusely reflected in the conductive network 1200, haze may occur in the transparent heating film 1000. Haze refers to a phenomenon in which light appears cloudy due to scattering or reflection by particles. The degree of scattering, reflection (including diffuse reflection), refraction, diffraction, or dispersion of light may vary depending on the surface roughness of the conductive network 1200, and the haze value of the transparent heating film 1000 may vary. As the surface of the conductive network 1200 is smoother, the haze of the transparent heating film 1000 may be reduced. As the surface roughness of the conductive network 1200 increases, the haze of the transparent heating film 1000 may increase. In addition, since a refractive index value may be changed depending on the material forming the conductive network 1200, the haze of the transparent heating film 1000 may vary. The haze of the transparent heating film 1000 may vary depending on the spectral coefficient of the material forming the conductive network 1200. When a light incident path is provided with an additional layer with which light collides before the conductive network 1200, the transparent heating film 1000 may be improved in haze depending on the refractive index of the additional layer. In addition, the haze of the transparent heating film 1000 may vary depending on the density of the conductive network 1200. The haze of the transparent heating film 1000 may increase as the volume or volume area occupied by the metal material in the volume occupied by the conductive network 1200 increases. As the number of the metal nanostructures 1210 included in the conductive network 1200 increases, the haze of the transparent heating film 1000 may increase. As the diameter and length of the metal nanostructures 1210 included in the conductive network 1200 increase, the haze of the transparent heating film 1000 may increase. As the aspect ratios of the metal nanostructures 1210 included in the conductive network 1200 becomes more non-uniform, the haze of the transparent heating film 1000 may increase.

The metal nanostructures 1210 may be located on the transparent substrate 1100. The metal nanostructures 1210 may form a portion of the conductive network 1200. The metal nanostructures 1210 may form the conductive network 1200. The metal nanostructures 1210 may be irregularly located.

The metal nanostructures 1210 may have a constant aspect ratio. The metal nanostructures 1210 may be in the form of a straight or curved nanowire, and may be invisible. The metal nanostructures 1210 may be a metal such as silver (Ag), platinum (Pt), copper (Cu), or gold (Au), but are not limited thereto.

The metal nanostructures 1210 may block external heat. The metal nanostructures 1210 may block electromagnetic waves. The metal nanostructures 1210 may block a signal of a specific frequency region that is incident from the outside.

The metal nanostructures 1210 may have electrical conductivity, and the metal nanostructures 1210 may provide a passage for electrons to move. The metal nanostructures 1210 have a resistance value that may vary depending on the aspect ratios thereof. As the aspect ratio of the metal nanostructures 1210 increases, resistance may be high and electrical conductivity may be low. As the cross-sectional areas of the metal nanostructures 1210 are larger, resistance may be lower, and electrical conductivity may be higher. As the lengths of the metal nanostructures 1210 increase, resistance may increase, and thus electrical conductivity may decrease. The metal nanostructures 1210 may receive external electric energy and transfer thermal energy generated from the electric energy. The metal nanostructures 1210 may generate and transmit heat. When a voltage applied from the outside is transferred to the metal nanostructures 1210, electrons move in the metal nanostructure 1210, so that heat can be generated from the transparent heating film 1000.

The haze may vary depending on the type of metal included in the metal nanostructures 1210. When the metal nanostructures 1210 are formed of a metal having a small spectral coefficient, haze may be reduced. The haze may vary depending on the aspect ratios of the metal nanostructures 1210. The haze may vary depending on the diameters of the metal nanostructures 1210. As the diameters of the metal nanostructures 1210 increase, the haze may increase. That is, as the area in which light collides with the metal nanostructures 1210 increases, the haze may increase. Accordingly, as the diameters or cross-sectional areas of the metal nanostructures 1210 increase, the resistance may decrease, but the haze may increase.

The intersection points 1220 may be located on the transparent substrate 1100. The intersection points 1220 may be formed since the metal nanostructures 1210 intersect with each other. The intersection points 1220 may be formed when at least two of the metal nanostructures 1210 come into contact with each other. The intersection points 1220 may be non-uniformly or irregularly located on the conductive network 1200. The intersection points 1220 may be located at irregular intervals. The intersection points 1220 may connect the metal nanostructures 1210 with each other. As the widths of the intersection points 1220 increase, the metal nanostructures 1210 may be well-connected to each other. As the widths of the intersection points 1210 increase, electrons can move more easily.

The intersection points 1220 may be easily formed as the number of the metal nanostructures 1210 increases. The intersection points 1220 may be easily formed as the lengths of the metal nanostructures 1210 increase. The intersection points 1220 may be easily formed as the aspect ratios of the metal nanostructures 1210 increase. The sheet resistance of the conductive network 1200 may vary depending on the number, shape, and size of intersection points 1220. The electrical conductivity of the conductive network 1200 may vary depending on the number, shape, and size of the intersection points 1220. The sheet resistance of the conductive network 1200 may be lowered as the number of the intersection points 1220 increases, the size is large, and the width of each of the intersection points 1220 increases. The haze of the conductive network 1200 may vary depending on the number, shape, and size of the intersection points 1220. The haze of the conductive network 1200 may be increased as the number of the intersection points 1220 increases, the size is large, and the width of each of the intersection points 1220 increases. This may be because light scattering or reflection occurs more easily as the area where light meets the intersection points 1210 increases. In addition, the haze may increase as the heights of the portions of the conductive network 1200 in which the intersection points 1220 are located increase. This may be because, in the conductive network 1200, the intersection points 1220 have a larger surface roughness than non-intersection portions of the metal nanostructures 1210. Accordingly, as the intersection points 1220 are formed lower, the transparent heating film 1000 may be improved in terms of haze.

The intersection points 1220 may be formed while the metal nanostructures 1210 form the conductive network 1200. The intersection points 1220 may be formed without applying heat or pressure to the metal nanostructures 1220. The intersection points 1220 may be formed by heat, pressure, or both heat and pressure. After heat is applied to the metal nanostructures 1210, pressure may be applied, and after the pressure is applied to the metal nanostructure 1210, heat may be applied. In this case, an induced current may be used to transfer the heat or pressure to the metal nanostructure 1210, and various methods not mentioned above may be used.

The heat may deform the metal nanostructures 1210. The heat may cause the metal nanostructures 1210 to be bent. The heat may form curved surfaces in the metal nanostructures 1210. The heat may deform the cross sections of the metal nanostructures 1210. When the metal nanostructures 1210 are overheated, the metal nanostructures 1210 may be deformed in a round shape, and thus a network may not be formed. The temperature at which the metal nanostructures 1210 are deformed in a round shape may be 120° C. or higher. When the heat applied to the metal nanostructures 1210 is around 100° C. and between 80° C. and 120° C., the metal nanostructures 1210 that intersect with each other may be connected to each other. The metal nanostructures 1210 may be softened or partially melted by heat, thereby forming intersections 1220 between the metal nanostructures 1210. In this case, the diameters of the metal nanostructures 1210 may be increased compared with the previous ones. When heat is not sufficiently transferred, the diameters of the metal nanostructures 1210 may not increase. The widths of the intersection points 1220, the bonding surfaces, the contact surfaces, or the intersection points 1220 between the metal nanostructures 1210 may be formed wider by heat, and two metal nanostructures 1210 may be well-connected to each other. The heat may be transferred to the metal nanostructures 1210 through a laser process, an intense pulsed light (IPL) process, or various methods not mentioned above.

The pressure may deform the metal nanostructures 1210. The pressure may deform the cross sections of the metal nanostructures 1210. The pressure may change the cross sections of the metal nanostructures 1210 from a circular shape to an elliptical shape. The pressure may change the diameters of the cross sections of the metal nanostructures 1210. The diameters of the cross sections of the metal nanostructures 1210 before the pressure is applied may be constant, and the ratio of axes orthogonal to each other may be 1:1. After the pressure is applied, the cross-sectional diameters of the metal nanostructure 1210 may not be constant. The ratio of orthogonal axes may be x:1, and x may have a real value greater than 1. Among the axes of each cross section, the longer axis may be defined as the major axis, and the shorter axis may be defined as the minor axis. When the pressure is not sufficient, the cross sections of the metal nanostructures 1210 may not be deformed. When heat and pressure are applied to the metal nanostructures 1210 together, intersections 1220 between the metal nanostructures 1210 and a conductive network 1200 may be formed even at a relatively lower temperature due to the pressure than when only heat is applied. The pressure may cause the intersections 1220, bonding surfaces, or contact surfaces between the metal nanostructures 1210 to be well-formed. The pressure may cause the intersections 1220, the bonding surfaces, or the contact surfaces between the two metal nanostructures 1210, or the widths of the intersections 1220 to be formed wider. The pressure may cause the intersections 1220, the bonding surfaces, or the contact surfaces to be formed more widely. The pressure may make the bonding between the two metal nanostructures stronger.

By applying heat or pressure, the diameter of each of the metal nanostructures 1210 may increase, and the intersection point 1220 may be formed to be low. Due to the heat or pressure, the metal nanostructures 1210 may have a pressed shape, and the cross sections of the metal nanostructures 1210 may be deformed into an elliptical shape having a major axis and a minor axis. The lengths of the minor axis and the major axis of each of the metal nanostructures 1210 may be changed due to the heat or pressure. The increased diameter may be the width or the major axis of the ellipse of each of the metal nanostructures 1210. The increased diameter, i.e., the main axis, of each of the metal nanostructures 1210 may be a width of each intersection point 1220. Due to the heat or pressure, the intersection points 1220 may be formed to be larger and wider. Due to the heat or pressure, the widths of the intersection points 1220 may be formed to be wider than the widths of the metal nanostructures 1210. As the sizes and widths of the intersection points 1220 increase, electrons can easily move between the metal nanostructures 1210, and the sheet resistance of the conductive network 1200 can be reduced so that electrical conductivity can be improved. However, the haze of the transparent heating film 1000 may increase due to the increased diameters of the nano-metal nanostructures 1210.

When the pressure is applied to each of the metal nanostructures 1210, the diameter in the direction in which the pressure is applied may be reduced. The reduced diameter may be the height or the short axis of the ellipse of each the metal nanostructures 1210. The intersection points 1220 may have a shape in which the short axes of respective metal nanostructures 1210 overlap each other. The height of a portion of the conductive network 1200 in which the intersection points 1220 are located may be smaller than the sum of diameters of two metal nanostructures 1210. Accordingly, by applying the heat or pressure, the height of the portion of the conductive network 1200 in which the intersection points 1220 are located may be lowered. Due to this, the conductive network 1200 may be improved in terms of surface roughness. Since the conductive network 1200 is improved in terms of surface roughness, scattering, reflection, or the like of light is reduced, so that the transparent heating film 1000 can be improved in terms of haze.

Meanwhile, the intersection points 1220 may be formed by irradiating the metal nanostructures 1210 with electronic beams. Through this, the metal nanostructures 1210 may be partially welded to each other. The welding may be performed by the energy of the electron beams. Through the radiation of electron beams, the metal nanostructures 1210 may be partially recrystallized. The intersection points between the metal nanostructures 1210 may be formed through the radiation of electron beams.

The intersection points 1220 may be located on the metal nanostructures 1210. The intersection points 1220 may be portions of the metal nanostructures 1210. The portions of the metal nanostructure 1210 in which the intersection points 1220 are located may be flat. The widths of the portions of the metal nanostructures 1210 in which the intersection points 1220 are located may be greater than the widths of other portions of the metal nanostructures 1220 in which the intersection points 1220 are not located. The heights of the portions of the metal nanostructures 1210 in which the intersection points 1220 are located may be lower than the heights of other portions of the metal nanostructures 1210 in which the intersection points 1220 are not located.

The intersection points 1220 may provide a passage for electrons to move. At least two of the metal nanostructures 1210 sharing an intersection point 1220 may be connected via the intersection point 1220. Each of the metal nanostructures 1210 may be electrically connected to other metal nanostructures 1210 via the intersection points 1220. As the intersection points 1220 are formed to be larger, respective metal nanostructure 1210 may be better electrically connected to each other, and the sheet resistance of the conductive network 1200 may be lowered.

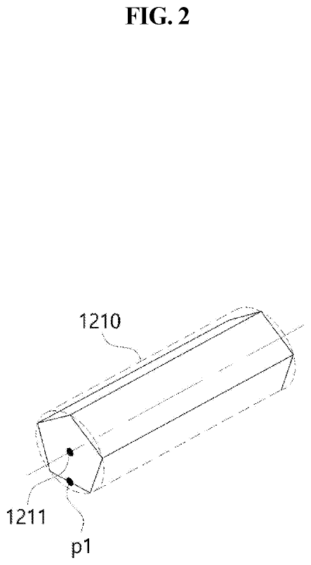

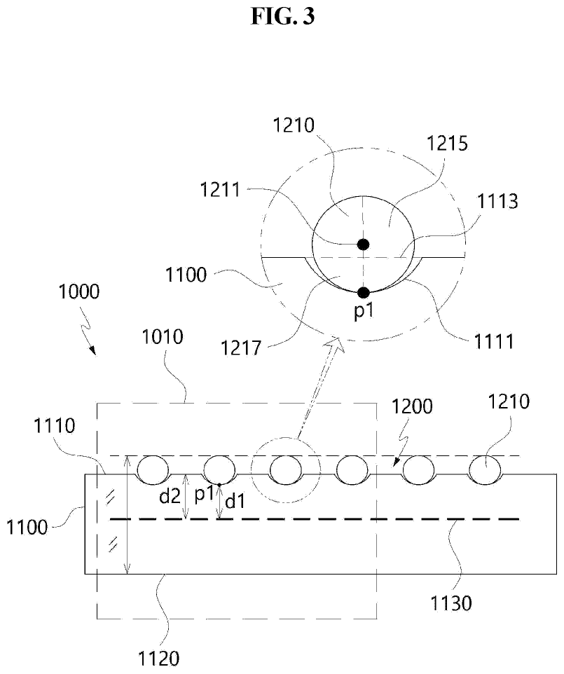

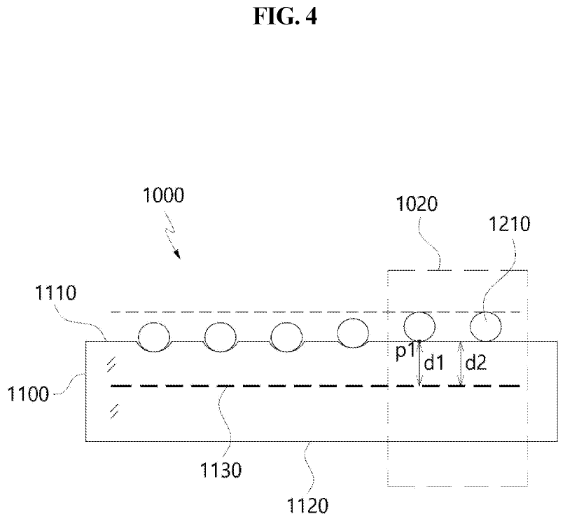

FIG. 2 is a perspective view of a metal nanostructure, FIG. 3 is a cross-sectional view of a transparent heating film according to the first embodiment, and FIG. 4 is another cross-sectional view of the transparent heating film according to the first embodiment. Referring to FIGS. 2 to 4, a transparent substrate 1100 includes a top surface 1110 and a bottom surface 1120, and the top surface 1110 of the transparent substrate 1100 includes a plurality of grooves 1111. An imaginary middle plane 1130 is located between the top surface 1110 and the bottom surface 1120 of the transparent substrate 1100. Each metal nanostructure 1210 has a structure extending along a center 1211, and be located at a positions corresponding to one of the grooves 1111.

The transparent substrate 1100 includes a top surface 1110 on which the grooves 1111 are formed, a flat bottom surface 1120, and an imaginary middle plane 1130 located between the top surface 1110 and the bottom surface 1120.

The top surface 1110 may have curved surfaces and non-curved surfaces. The curved surfaces of the top surface 1110 may be the grooves 1111. The grooves 1111 may not be located on the non-curved surfaces of the top surface 1110. The non-curved surfaces of the top surface 1110 may be flat, and an imaginary line 1113 extending along the non-curved surface may exist.

The grooves 1111 may be located on the top surface 1110 of the transparent substrate 1100. The surface of the top surface 1110 on which the grooves 1111 are not formed may be flat. The grooves 1111 may be curved surfaces. The grooves 1111 may be concavely curved surfaces. The grooves 1111 may be recessed portions. The grooves 1111 may be formed in the process of manufacturing the transparent heating film 1000. The grooves 1111 may be used for improving characteristics of the transparent heating film 1000. The grooves 1111 may be used for improving the heating characteristics and light transmittance of the transparent heating film 1000, and improving the transparent heating film in terms of haze.

The middle plane 1130 may be located in the transparent substrate 1100. The middle plane 1130 may be an imaginary plane. The middle plane 1130 may be parallel to the bottom surface 1120. The middle plane 1130 may be parallel to the imaginary line 1113 of the top surface 1110. The middle plane 1130 may be a plane that crosses the center of the cross section of the transparent heating film 1000. The middle plane 1130 may be located between the highest position and the lowest position of the transparent heating film 1000. The middle plane 1130 may be a plane that bisects the distance between the highest position of the metal nanostructure 1210 and the lowest position of the transparent substrate 1100. The middle plane 1130 may be a plane that bisects the distance between the top surface of the metal nanostructure 1210 and the bottom surface 1120 of the transparent substrate 1100. The distance of the middle plane 1130 from the bottom surface 1120 may be half of the average distance between the bottom surface 1120 and the top surfaces of the metal nanostructures 1210. In addition, the middle plane 1130 may be a plane that crosses the center of the cross section of the transparent substrate 1100. The middle plane 1130 may be located between the top surface 1110 or the imaginary line 1113 and the bottom surface 1120 of the transparent substrate 1100. The middle plane 1130 may be a plane that bisects the thickness of the transparent substrate 1100. The distance of the middle plane 1130 from the bottom surface 1120 of the transparent substrate 1100 may be half of the average distance between the imaginary line 1113 and the bottom surface 1120 of the transparent substrate 1100.

The metal nanostructures 1210 may be located on the top surface 1110 of the transparent substrate 1100. The metal nanostructures 1210 may be located at positions corresponding to the grooves 1111. The metal nanostructures 1210 may be located at positions that do not correspond to the grooves 1111. The metal nanostructures 1210 may be in contact with some of the grooves 1111, or may be in contact with all of the grooves 1111. A point where each metal nanostructure 1210 and the top surface 1110 of the transparent substrate 1100 are in contact with each other may be defined as a first point p1. When the metal nanostructures 1210 correspond to the grooves 1111, the first point p1 may be located in each of the grooves 1111. When the metal nanostructures 1210 do not correspond to the grooves 1111, the first point p1 may not be located in each of the grooves 1111.

When the metal nanostructures 1210 are located at positions corresponding to the grooves 1111, the distance between the conductive network 1200 and the transparent substrate 1100 and the overall thickness of the transparent heating film 1000 can be reduced. In this case, since the conductive network 1200 is located close to the bottom surface 1120 of the transparent substrate 1100, heat can be quickly transferred to the outside of the transparent heating film 1000. Accordingly, the heating rate and heating efficiency of the transparent heating film 1000 can be improved. In addition, since the metal nanostructures 1210 correspond to the grooves 1111, the metal nanostructures 1210 may be partially enclosed in the transparent substrate 1100. Due to this, the conductive network 1200 or the transparent heating film 1000 may be improved in terms of the surface roughness. Due to the improvement in terms of surface roughness, the transparent heating film 1000 may be improved in terms of haze and light transmittance.

Each metal nanostructure 1210 may be formed through a reduction reaction of metal ions. The metal nanostructure 1210 may be grown in an anisotropic structure through the reduction of metal ions. The metal nanostructure 1210 may grow along one straight line, and the straight line may pass through the center 1211 of the metal nanostructure. That is, the metal nanostructure 1210 is formed along a first straight line extending along the center 1211 of the metal nanostructure. The first straight line may be a straight line perpendicular to the cross section of the metal nanostructure 1210. The first straight line may extend along a direction oriented from one cross section to another cross section of the metal nanostructure 1210. The direction may be a growth direction of the metal nanostructure 1210.

The metal nanostructure 1210 may have a pentagonal cross section. The cross section of the metal nanostructure 1210 may have a circumscribed circle. The sides of the pentagon and the circumscribed circle may be adjacent to each other. The distance from the center of the cross section of the metal nanostructure 1210 to the sides of the pentagon may have a value similar to the distance from the center of the cross section of the metal nanostructure 1210 to the circumscribed circle. The cross section of the metal nanostructure 1210 may have a nano size, and thus the pentagonal shape may be observed similarly to the circumscribed circle. The cross section of the metal nanostructure 1210 may be a pentagon close to a circle. The cross section of the metal nanostructure 1210 may be close to a circumscribed circle of a pentagon. The cross-section of the metal nanostructure 1210 may be a circle.

The top surface of the metal nanostructure 1210 may be a surface that does not come in contact with the transparent substrate 1100. The top surface of the metal nanostructure 1210 may be a portion farthest from the bottom surface 1120 of the transparent substrate 1100 in the metal nanostructure 1210. The top surface of the metal nanostructure 1210 may be a surface facing the first point p1. The top surface of the metal nanostructure 1210 may be a surface symmetrical to the first point p1 with respect to the center 1211 of the metal nanostructure.

The first point p1 may have a first distance d1 from the middle plane 1130. The imaginary line 1113 extending along the top surface 1110 of the transparent substrate 1100 and the middle plane 1130 may have a second distance d2.

A first region 1010 may be a portion of the transparent heating film 1000. The first region 1010 may include the metal nanostructures 1210 and a portion of the transparent substrate 1100. The first region 1010 may be a region in which the first distance d1 is smaller than the second distance d2. In this case, metal nanostructures 1210 may correspond to the grooves 1111. Each metal nanostructure 1210 may be in contact with each groove 1111 at the first point p1. The first point p1 may be simultaneously located on the metal nanostructure 1210 and the groove 1111. The first point p1 may be a point located closest to the bottom surface 1120 of the transparent substrate 1100 in the metal nanostructure 1210. The radius of curvature of the metal nanostructure 1210 and the groove 1111 at the first point p1 may be the same. The radius of curvature of the metal nanostructure 1210 in a region adjacent to the first point p1 may be the same as or different from the radius of curvature of the groove 1111 in the region adjacent to the first point p1.

When the radius of curvature of the metal nanostructure 1210 in the region adjacent to the first point p1 and the radius of curvature of the groove 1111 are the same, a portion of the metal nanostructure 1210 may completely adhere to or may be in contact with the groove 1111. In this case, the bonding between the metal nanostructure 1210 and the transparent substrate 1100 may be excellent. When heat and pressure are applied to the metal nanostructure 1210 and the transparent substrate 1100 to form the transparent heating film 1000, the metal nanostructure 1210 and the transparent substrate 1100 can be made flexible by the heat and can be pressed by the pressure. In this process, the metal nanostructure 1210 may be located in close contact with the groove 1111 of the transparent substrate 1100. Since the metal nanostructure 1210 is located in close contact with the groove 1111 of the transparent substrate 1100, the metal nanostructure 1210 and the transparent substrate 1100 may be strongly bonded to each other. The metal nanostructure 1210 may be protected by being surrounded by the groove 1111 of the transparent substrate 1110.

When the radius of curvature of the metal nanostructure 1210 in the region adjacent to the first point p1 is smaller than the radius of curvature of the groove 1111, a portion of the metal nanostructure 1210 may not be in completely close contact with nor in contact with the groove 111. There may be a space between the metal nanostructure 1210 and the groove 1111. A space between the metal nanostructure 1210 and the groove 1111 may be filled with a separate material through an additional process. The metal nanostructure 1210 and the groove 1111 may be connected with each other by a separate material by an additional process. The groove 111 may be formed using the metal nanostructure 1210 by applying heat and pressure, and thereafter, the metal nanostructure 1210 may shrink according to temperature drop so that the radius of curvature of the metal nanostructure 1210 may become smaller than the radius of curvature of the groove 1111. Alternatively, in the process of forming the groove 1111, the metal nanostructure 1210 may move in the left-right direction so that the radius of curvature of the metal nanostructure 1210 may be formed greater than the radius of curvature of the groove 1111. The radius of curvature of the metal nanostructure 1210 and the radius of curvature of the groove 1111 in the region adjacent to the first point p1 may become, but not exclusively, different from each other due to causes other than those described above.

In the first region 1010, the metal nanostructure 1210 may be divided into a first portion 1215 and a second portion 1217 by the imaginary line 1113.

The first portion 1215 may be an upper portion of the metal nanostructure 1210. The first portion 1215 may include the top surface of the metal nanostructure. The first portion 1215 may be a portion located far away from the bottom surface 1120 of the transparent substrate 1100 with respect to the imaginary line 1113. The first portion 1215 may not come into contact with the groove 1111 of the transparent substrate 1100. The first portion 1215 may face the groove 1111 of the transparent substrate 1100 with reference to the imaginary line 1113. The first portion 1215 may protrude above the top surface 1110 of the transparent substrate 1100 without being buried or enclosed in the transparent substrate 1100. The first portion 1215 is a protruding portion and may be a portion that determines the surface roughness of the transparent heating film 1000. As the first portion 1215 is larger, the surface roughness of the transparent heating film 1000 may be greater and may be uneven. As the first portion 1215 is larger, the haze of the transparent heating film 1000 may increase.

The second portion 1217 may be a lower portion of the metal nanostructure 1210. The second portion 1217 may be a portion located close to the bottom surface 1120 of the transparent substrate 1100 with respect to the imaginary line 1113. The second portion 1217 may be in contact with at least a portion of the groove 1111 of the transparent substrate 1100. The second portion 1217 may include the first point p1. The second portion 1217 may be in contact with the groove 1111 of the transparent substrate 1100 at the first point p1. The second portion 1217 may be a portion buried or enclosed in the transparent substrate 1100. The second portion 1217 may be a portion that does not protrude above the top surface 1110 of the transparent substrate 1100. The second portion 1217 is buried or enclosed, and may be a portion that determines the surface roughness of the transparent heating film 1000. As the second portion 1217 is larger, the surface roughness of the transparent heating film 1000 may be small and may be smooth. As the second portion 1217 is larger, the haze of the transparent heating film 1000 may be reduced.

The first portion 1215 and the second portion 1217 may be formed in the process of forming the transparent heating film 1000 or the conductive network 1200. The second portion 1217 may not be greater than the first portion 1215. This may be because the heat or pressure applied to the metal nanostructure 1210 is not large enough. When the heat or pressure applied to the metal nanostructure 1210 is sufficiently large, the second portion 1217 may be formed to be greater than the first portion 1215.

When the first portion 1215 is greater than the second portion 1217, the first portion 1215 may include the center 1211 of the metal nanostructure 1210. The first portion 1215 may include at least half of the metal nanostructure 1210. When the cross section of the metal nanostructure 1210 has an elliptical shape having a major axis and a minor axis, the first portion 1215 may include a region having a smaller radius of curvature than that of the second portion 1217. When the transparent heating film 1000 is cut in a plane perpendicular to the bottom surface 1120 of the transparent substrate 1100, the cross-sectional area of the first portion 1215 may be greater than the cross-sectional area of the second portion 1217.

When the first portion 1215 is smaller than the second portion 1217, the second portion 1217 may include the center 1211 of the metal nanostructure 1210. The second portion 1217 may include at least half of the metal nanostructure 1210. When the cross section of the metal nanostructure 1210 has an elliptical shape having a major axis and a minor axis, the second portion 1217 may include a region having a smaller radius of curvature than that of the first portion 1215. When the transparent heating film 1000 is cut in a plane perpendicular to the bottom surface 1120 of the transparent substrate 1100, the cross-sectional area of the first portion 1215 may be smaller than the cross-sectional area of the second portion 1217.

The transparent heating film 1000 may be improved in terms of surface roughness as the first portion 1215 is smaller and the second portion 1217 is larger. The transparent heating film 1000 may be improved in terms of surface roughness as the first portion 1215 is smaller than the second portion 1217. The transparent heating film 1000 may be improved in terms of haze value as the first portion 1215 is smaller than the second portion 1217. As the first portion 1215 of the transparent heating film 1000 is smaller than the second portion 1217, the transparent heating film 1000 having excellent performance with higher transparency and lower haze may be manufactured.

The heating characteristic of the transparent heating film 1000 may be improved as the second portion 1217 is greater than the first portion 1215. The second portion 1217 may be a portion of the nano-metal structure 1210 that is in contact with the top surface 1110 of the transparent substrate 1100 and is located close to the bottom surface 1120 of the transparent substrate 1100. Therefore, as the second portion 1217 is larger, the transparent substrate 1100 may receive heat evenly, and the transparent heating film 1000 may quickly transfer heat to the outside of the transparent heating film 1000.

The second region 1020 may be a portion of the transparent heating film 1000. The second region 1020 may include the metal nanostructures 1210 and a portion of the transparent substrate 1100. The second region 1020 may be a region in which the first distance d1 is equal to the second distance d2. In this case, no groove 1111 may be formed in the top surface 1110 of the transparent substrate 1100 that corresponds to the metal nanostructures 1210. The top surface 1110 of the transparent substrate 1100 that corresponds to the metal nanostructures 1210 may not have a curved surface.

Each metal nanostructure 1210 of the second region 1020 may meet the top surface 1110 of the transparent substrate 1100 at a first point p1. The first point p1 may not be located in a groove 1111. The metal nanostructures 1210 in the second region 1020 may be located on the imaginary line 1113. The metal nanostructures 1210 of the second region 1020 may be located farther from the bottom surface 1120 of the transparent substrate 1100 than the metal nanostructures 1210 of the first region 1010.

The second region 1020 may be a region in which the grooves 1111 are not formed because heat or pressure applied to the metal nanostructure 1210 during the process of forming the transparent heating film 1000 is not sufficient. The second portion 1217 may not be formed in each of the metal nanostructure 1210 in the second region 1020. Each metal nanostructure 1210 in the second region 1020 may not have a portion buried or enclosed in the transparent substrate 1100. The bonding between the metal nanostructure 1210 and the transparent substrate 1100 in the second region 1020 may not be as strong as that of the first region 1010. The surface roughness of the second region 1020 may be greater than that of the first region 1010. The second region 1020 may not be smoother than the first region 1010. Light scattering or reflection may occur more in the second region 1020 than in the first region 1010. The haze of the second region 1020 may be greater than that of the first region 1010.

The transparent heating film 1000 may be improved in terms of surface roughness as more first regions 1010 are formed and fewer second regions 1020 are formed. The transparent heating film 1000 may be improved in terms of surface roughness as the number of first regions 1010 formed therein is larger than the number of second regions 1020 or fewer second regions 1020 are formed therein. The transparent heating film 1000 may be improved in terms of haze value as the number of first regions 1010 formed therein is larger than the number of second regions 1020 or fewer second regions 1020 are formed therein. As the number of first regions 1010 formed in the transparent heating film 1000 is larger than the number of second regions 1020 or fewer second regions 1020 are formed, the transparent heating film 1000 having excellent performance with higher transparency and lower haze may be manufactured.

The heating characteristic of the transparent heating film 1000 may be improved as more first regions 1010 are formed and fewer second regions 1020 are formed. This may be because the first regions 1010 are regions to which sufficient heat and pressure are applied during the process of manufacturing the transparent heating film 1000. That is, in the metal nanostructures 1210 to which sufficient heat and pressure are applied, wide intersection points 1220 may be formed, and a conductive network 1200 having a low resistance may be formed. Due to this, the electrical conductivity of the transparent heating film 1000 may be excellent, and the transparent heating film 1000 may be rapidly and uniformly heated. In addition, since the first regions 1010 include the grooves 1111, the nano-metal structures 1210 may be located close to the bottom surface 1120 of the transparent substrate 1100. Accordingly, the first regions 1010 may rapidly transfer heat to the outside of the transparent heating film 1000. This may have the same effect as that exhibited when the first portion 1215 is smaller and the second portion 1217 is larger in each metal nanostructure 1210.

More specifically, when electrons start to move in the metal nanostructures 1210 and the transparent heating film 1000 starts to be heated, the temperature of the transparent substrate 1100 may not be uniform. A portion of the transparent heating film 1000 that is located closer to the metal nanostructure 1210 may have a higher temperature. In the transparent substrate 1100, the top surface 1100 may have a higher temperature than the bottom surface 1120. A portion of the top surface 1110 of the transparent substrate 1100 that corresponds to each metal nanostructure 1210 may be heated first or more rapidly. However, the temperature of the top surface 1110 may become uniform within several minutes or seconds. This may be because the intersections 1220 between the metal nanostructures 1210 are formed widely, so that the electrons in the conductive network 1200 move smoothly, and the electrons are evenly located inside the conductive network 1200. In addition, when the metal nanostructures 1210 are located in the grooves 1111, the top surface 1110 of the transparent substrate 1100 is able to receive heat transferred from the metal nanostructures 1210 through the large area of the grooves 1111. Therefore, the transparent heating film 1000 can be more uniformly heated. The top surface 1110 of the transparent substrate 1100 may transfer heat to the bottom surface 1120. Since the portions of the top surface 1110 in which the grooves 1111 are formed are located close to the bottom surface 1120 of the transparent substrate 1100, heat can be transferred quickly. As the number or the size of formed grooves 1111 is large, the temperatures of the top surface 1110 and the bottom surface 1120 can be made similar within a short time, and the temperature inside the transparent substrate 1100 can be made uniform. The portions of the bottom surface 1120 of the transparent substrate 1100 corresponding to the grooves 1111 or the metal nanostructures 1210 can be heated more rapidly than other portions. However, the temperature of the bottom surface 1120 can be made uniform within several minutes or seconds. The rapid and uniform heating characteristics may be obtained due to the characteristics of the intersection points 1220 of the metal nanostructures 1210 and the positions of the metal nanostructures 1210, as described above.

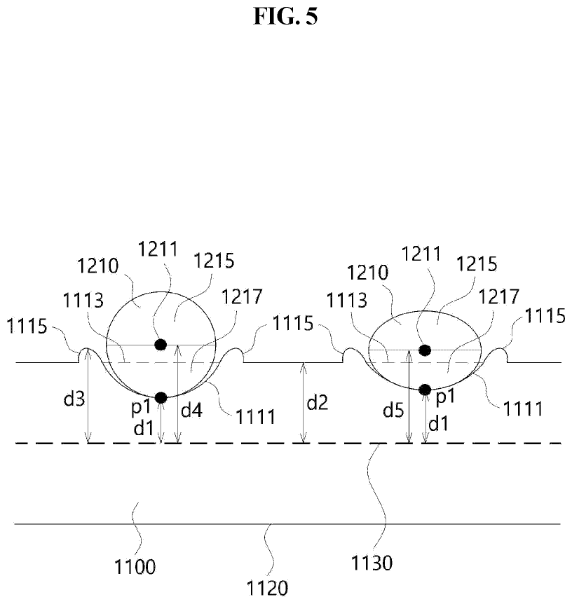

FIG. 5 is a partially enlarged view of the transparent heating film of the first embodiment. Referring to FIG. 5, the top surface 1110 of the transparent substrate 1100 includes protrusions 1115. The cross sections of the metal nanostructures 1210 may have a circular or elliptical shape.

The protrusions 1115 may be portions of the transparent substrate 1100. The protrusions 1115 may be located on the top surface 1110 of the transparent substrate 1100. Each protrusion 1115 may be located between a curved surface and a non-curved surface. The protrusion 1115 may connect the curved surface and the non-curved surface. The protrusion 1115 may be connected to the groove 1111. The protrusions 1115 may be located on the imaginary line 1113. Each protrusion 1115 may be located next to a groove 1111 and a metal nanostructure 1210. A protrusion 1115 may be located along each of the edges of the groove 1111 and the metal nanostructure 1210. Each metal nanostructure 1210 may be located between two of protrusions 1115, and a distance between the two protrusions 1115 may be greater than an overlapping length between the metal nanostructure 1210 and the imaginary line 1113. The distance between the two protrusions 1115 may be greater than the diameter of the metal nanostructure 1210.

The highest point of the protrusions 1115 may not be higher than the top surface of the metal nanostructures 1210. The distance between a protrusion 1115 and the middle plane 1130 may be smaller than the distance between the top surface of the metal nanostructure 1210 adjacent to the protrusion 1115 and the middle plane 1130. An imaginary straight line connecting two protrusions 1115 may pass through the metal nanostructure 1210. The protrusions 1115 may be formed in the process of forming the transparent heating film 1000. The protrusions 1115 may be formed by applying heat or pressure to the metal nanostructures 1210 and the transparent substrate 1100. The protrusions 1115 may be formed by the grooves 1111. The protrusions 1115 may be portions of the transparent substrate 1100 that were pushed up by applying heat or pressure to the metal nanostructures 1210 and the transparent substrate 1100 to form the grooves 1111.

The protrusions 1115 may be used for maintaining the shape of the transparent substrate 1100. The protrusions 1115 may be used for maintaining the overall shape of the top surface 1110 of the transparent substrate 1100. When the grooves 1111 are formed, the transparent substrate 1100 may be deformed as much as the portions occupied by the grooves 1111 in the transparent substrate 1100. In this case, the deformation may occur in a horizontal or vertical direction, and may occur in a diagonal or radial direction. When the deformation of the transparent substrate 1100 occurs in the horizontal direction, the overall size of the top surface 1110 of the transparent substrate 1100 may be changed. Here, the horizontal direction may be defined as a direction from one end of one side of the transparent substrate 1100 to the other end. The horizontal direction may be defined as a direction crossing the top surface 1110 of the transparent substrate 1100. The overall size of the top surface 1110 may be increased to form the grooves 1111. In this case, the sizes of the top surface 1110 and the bottom surface 1120 may be different from each other, and the transparent substrate 1100 may be distorted. Alternatively, wrinkles may occur in order to prevent the change of the size of the top surface 1110 of the transparent substrate 1100. Wrinkles may also be form at unpredictable positions, i.e. in flat portions. When the transparent substrate 1100 is distorted or wrinkled, the surface roughness and haze of the transparent heating film 1000 may increase, and transparency may decrease. Due to this, the performance of the transparent heating film 1000 may be deteriorated. Since the portions of the transparent heating film 1000 having the greatest surface roughness located around the metal nanostructures 1210, the surface roughness may be minimized as more wrinkles occur around the metal nanostructures 1210. Even when the transparent substrate 1100 is deformed in another direction including the horizontal direction, the transparent substrate 1100 may be distorted or wrinkled. Therefore, it may be safe for the transparent substrate 1100 to be deformed in the vertical direction around the metal nanostructures 1210 to minimize the distortion or wrinkles. Here, the vertical direction may be defined as a direction from the bottom surface 1120 to the top surface 1110 of the transparent substrate 1100. The protrusions 1115 may be formed due to the deformation of the transparent substrate 1100 in the vertical direction. The protrusions 1115 may be formed due to the vertical deposition of portions of the transparent substrate 1100 corresponding to the grooves 1111. The protrusions 1115 may be bulged over the top surface 1110 of the transparent substrate 1100. In addition, the protrusions 1115 may be formed around the metal nanostructures 1210. Since the protrusions 1115 are formed around the metal nanostructures 1210, degradation in performance of the transparent substrate 1100 due to the protrusions 1115 can be minimized.

Each protrusion 1115 may have a third distance d3 from the middle plane 1130. The third distance d3 may be greater than the first distance d1 and the second distance d2. The protrusions 1115 may be located higher than the grooves 1111 with respect to the middle plane 1130. The protrusions 1115 may be located higher than the imaginary line 1113 with respect to the middle plane 1130. The protrusions 1115 may not be located higher than the top surfaces of the metal nanostructures 1210 with respect to the middle plane 1130.

The highest point of each protrusion 1115 may be located between the top surface 1110 of the transparent substrate 1100 and the top surfaces of the metal nanostructures 1210. Each protrusion 1115 may connect the top surface 1110 of the transparent substrate 1100 and the top surface of the corresponding metal nanostructure 1210. Each protrusion 1115 may reduce a step difference between the top surface 1110 of the transparent substrate 1100 and the top surface of the corresponding metal nanostructure 1210. Each protrusion 1115 may smoothen the inclination between the top surface 1110 of the transparent substrate 1100 and the top surface of the corresponding metal nanostructure 1210. Each protrusion 1115 is located between the top surface 1110 of the transparent substrate 1100 and the top surface of the corresponding metal nanostructure 1210, so that the amount of light reflected or scattered by the metal nanostructure 1210 can be reduced. That is, each protrusion 1115 may prevent light reflection by adjusting the inclination between the corresponding metal nanostructure 1210 and the transparent substrate 1100. The protrusions 1115 may prevent reflection or scattering of light generated from the transparent heating film 1000. Accordingly, the protrusions 1115 may reduce haze of the transparent heating film 1000. The shapes of the protrusions 1115 may not be constant, and the shapes of the protrusions 1115 are not limited to those illustrated in the drawings.

Each metal nanostructure 1210 may be divided into a first portion 1215 and a second portion 1217 by the imaginary line 1113, wherein, when the first portion 1215 is larger than the second portion 1217, the center 1211 of the metal nanostructure may be included in the first portion 1215. The distance between the center 1211 of the metal nanostructure and the middle plane 1130 may be greater than the first distance d1 and the second distance d2. The center 1211 of the metal nanostructure may be located higher than the groove 1111 and the imaginary line 1113.

Although not illustrated, when the first portion 1215 is smaller than the second portion 1217, the center 1211 of the metal nanostructure may be included in the second portion 1217. The distance between the center 1211 of the metal nanostructure and the middle plane 1130 may be greater than the first distance d1 and smaller than the second distance d2.

When the transparent heating film 1000 is cut in a plane perpendicular to the bottom surface 1120 of the transparent substrate 1100, the cross section of the metal nanostructure 1210 may be pentagonal. The pentagon may be close to a circle. In this case, the distance between the center 1211 of the metal nanostructure and the middle plane 1130 may be defined as a fourth distance d4. The first portion 1215 may be greater than the second portion 1217, and the center 1211 of the metal nanostructure may be included in the first portion 1215. The fourth distance d4 may be greater than the first distance d1 and the second distance d2. The center 1211 of the metal nanostructure may be located higher than the groove 1111 and the imaginary line 1113. As the fourth distance d4 is closer to the second distance d2, the first portion 1215 may decrease and the second portion 1217 may increase. As the fourth distance d4 is closer to the second distance d2, the surface roughness of the transparent heating film 1000 may be reduced, and the transparent heating film 1000 may be improved in terms of haze.

Although not illustrated, when the first portion 1215 is smaller than the second portion 1217, the center 1211 of the metal nanostructure may be included in the second portion 1217. The fourth distance d4 may be greater than the first distance d1 and smaller than the second distance d2. In this case, the surface roughness of the transparent heating film 1000 may be further reduced than that in the above-described case. Accordingly, the transparent heating film 1000 may be improved in terms of haze. As the fourth distance d4 is closer to the first distance d1, the first portion 1215 may further decrease and the second portion 1217 may further increase. Alternatively, as the diameter of the metal nanostructure 1210 increases, the major axis of the cross section of the metal nanostructure 1210 may further increase and the minor axis may further decrease. As the fourth distance d4 is closer to the first distance d1, the surface roughness of the transparent heating film 1000 may be further reduced, and the transparent heating film 1000 may also be improved in terms of haze.

When the transparent heating film 1000 is cut in a plane perpendicular to the bottom surface 1120 of the transparent substrate 1100, the cross section of the metal nanostructure 1210 may be pentagonal. The pentagon, as a pressed shape, may be close to an elliptical shape having a major axis and a minor axis. In this case, the distance between the center 1211 of the metal nanostructure and the middle plane 1130 may be defined as a fifth distance d5. The fifth distance may be a distance between the major axis and the middle plane 1130. The first portion 1215 may be greater than the second portion 1217, and the center 1211 of the metal nanostructure may be included in the first portion 1215. The fifth distance d5 may be greater than the first distance d1 and the second distance d2. The major axis of the ellipse may be located higher than the groove 1111 and the imaginary line 1113. As the fifth distance d5 is closer to the second distance d2, the first portion 1215 may decrease and the second portion 1217 may increase. As the fifth distance d5 is closer to the second distance d2, the surface roughness of the transparent heating film 1000 may be reduced, and the transparent heating film 1000 may be improved in terms of haze.

The fifth may be larger than the first distance d1 and smaller than the second distance d2. In this case, the surface roughness of the transparent heating film 1000 may be further reduced than that in the above-described case. Accordingly, the transparent heating film 1000 may be improved in terms of haze. As the fifth distance d5 is closer to the first distance d1, the first portion 1215 may further decrease and the second portion 1217 may further increase. Alternatively, as the diameter of the metal nanostructure 1210 increases, the major axis of the cross section of the metal nanostructure 1210 may further increase and the minor axis may further decrease. As the fifth distance d5 is closer to the first distance d1, the surface roughness of the transparent heating film 1000 may be further reduced, and the transparent heating film 1000 may also be improved in terms of haze.

### 2. Second Embodiment

Hereinafter, a transparent heating film according to a second embodiment will be described.

The transparent heating film according to the second embodiment is the same as the first embodiment except that a bus bar 1300 and a coating layer 1400 are further included in the transparent heating film according to the first embodiment. Accordingly, in the description of the second embodiment, the same reference numerals are assigned to the components common to the first embodiment, and detailed descriptions thereof are omitted.

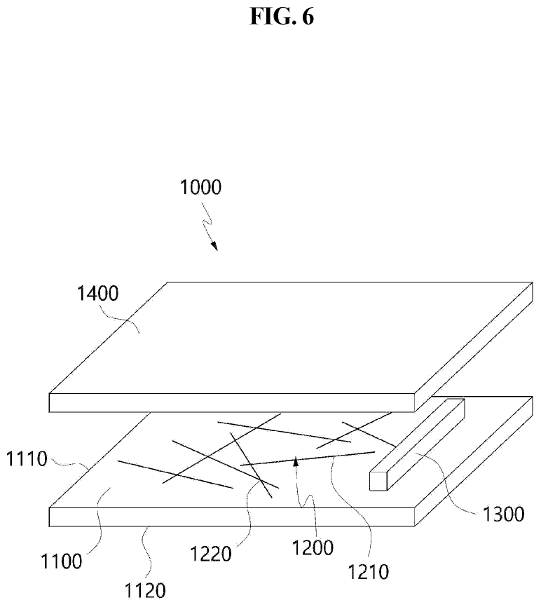

FIG. 6 is a perspective view of a transparent heating film according to a second embodiment.

Referring to FIG. 6, the transparent heating film 1000 includes a transparent substrate 1100, a conductive network 1200, a bus bar 1300, and a coating layer 1400.

The bus bar 1300 may be located on the top surface 1110 of the transparent substrate 1100. The bus bar 1300 may be located on at least a partial area of the conductive network 1200. The bus bar 1300 may be located on an edge of the conductive network 1200.

The shape of the bus bar 1300 may vary. The thickness, height, and width of the bus bar 1300 may vary. The bus bar 1300 may be in the form of a line.

The bus bar 1300 may be formed to be transparent or may be formed to be opaque. The bus bar 1300 may or may not include the same material as the conductive network 1200. The bus bar 1300 may include the same material as the conductive network 1200 and may be formed to be transparent. The light transmittance of the bus bar 1300 may be lower than the light transmittance of the conductive network 1200.

The bus bar 1300 may include a conductive material. The bus bar 1300 may include a metal such as silver (Ag), but is not limited thereto. Specifically, the bus bar may be a silver paste. In addition, the bus bar 1300 may include a metal nanostructure, and may include a silver nanowire. The bus bar 1300 may have electrical conductivity, and the bus bar 1300 may provide a passage for electrons to move. The sheet resistance value of the bus bar 1300 may be smaller than the sheet resistance value of the conductive network 1200. A voltage may be applied to the bus bar 1300 from an external power source, and the movement speed of electrons when the voltage applied from the outside is transferred to the bus bar 1300 may be more rapidly than the movement speed of electrons when the voltage applied from the outside is transferred to the conductive network 1200.

The bus bar 1300 may be in contact with the conductive network 1200, and electrons may move via the portion in which the bus bar 1300 and the conductive network 1200 are in contact with each other. When an external voltage is transferred to the conductive network 1200 through the bus bar 1300, electrons may be transferred to the conductive network 1200 via the portion in which the bus bar 1300 and the conductive network 1200 are in contact with each other. When the external voltage is connected to the conductive network 1200, electrons may be transferred to the conductive network 1200 via the portion in which the external voltage and the conductive network 1200 come into contact with each other. The portion in which the bus bar 1300 and the conductive network 1200 are in contact with each other may be wider than the portion in which the external voltage and the conductive network 1200 come into contact with each other. Accordingly, as compared to that in the case in which the voltage is directly connected to the conductive network 1200, the movement speed of electrons moving through the conductive network 1200 may be more rapidly in the case in which the voltage is connected via the bus bar 1300. Since heat can be generated from the transparent heating film 1000 due to the movement of electrons in the conductive network 1200, the heating rate of the conductive network 1200 may be improved by increasing the movement speed of the electrons.

There may be a plurality of bus bars 1300. The plurality of bus bars 1300 may be located at different edges. The plurality of bus bars 1300 may face each other or may be parallel to each other.

The bus bar 1300 may be electrically connected to at least one metal nanostructure 1210. When a voltage is applied to the bus bar 1300, electrons may be transferred from the bus bar 1300 to the metal nanostructures 1210 connected to the bus bar 1300, and the transferred electrons may move to other metal nanostructures 1210 via one or more intersection points 1220. The electrons may move in a direction away from the bus bar 1300.

The coating layer 1400 may be located on the transparent substrate 1100, the conductive network 1200, and the bus bar 1300. The coating layer 1400 may be for coating the transparent substrate 1100, the conductive network 1200, and the bus bar 1300. The coating layer 1400 may be used for protecting the transparent substrate 1100, the conductive network 1200, and the bus bar 1300 from external air and moisture. The conductive network 1200 and the bus bar 1300 may be buried or enclosed in the coating layer 1400. The coating layer 1400 may be used for protecting the bus bar 1300 and the metal nanostructures 1210 from moisture or air.

The coating layer 1400 may be in contact with a portion of the top surface 1110 of the transparent substrate 1100. The coating layer 1400 may be in contact with the metal nanostructures 1210. The coating layer 1400 may be located between the metal nanostructures 1210. The coating layer 1400 may be in contact with the intersection points 1220 and may be located between the intersection points 1220. The coating layer 1400 may be located between the metal nanostructures 1210 and the intersection points 1220.

The metal nanostructures 1210 may be located inside the coating layer 1400. The metal nanostructures 1210 may be densely concentrated inside the coating layer 1400 at a position close to the transparent substrate 1100, or densely concentrated inside the coating layer 1400 at a position far from the transparent substrate 1100. Some of the metal nanostructures 1210 may be located on the surface of the coating layer 1400 or may protrude to the outside of the coating layer 1400. One surface of the coating layer 1400 including the metal nanostructures 1210 may be flat or curved.

The bus bar 1300 may be located inside the coating layer 1400. The bus bar 1300 may be located between the transparent substrate 1100 and the coating layer 1400. A bottom surface of the bus bar 1300 may be in contact with the transparent substrate 1100. Side and top surfaces of the bus bar 1300 may be in contact with the coating layer 1400.

The coating layer 1400 may be formed of a polymer having a hydrocarbon structure or a conductive material, but is not limited thereto. The coating layer 1400 may be formed of a single material or may be formed of a composite of several materials. The coating layer 1400 may be optically transparent. The light transmittance of the coating layer 1400 may be similar to or equal to the light transmittance of the transparent substrate 1100. The light transmittance of the coating layer 1400 may be higher than the light transmittances of the conductive network 1200 and the bus bar 1300. The coating layer 1400 may transmit light, electromagnetic waves, and heat. The coating layer 1400 may transfer thermal energy generated in another layer. The coating layer 1400 may have a flexible structure.

When the coating layer 1400 is formed of a conductive material, the coating layer 1400 may have electrical conductivity, and the coating layer 1400 may provide a passage for electrons to move. The coating layer 1400, which is formed of a conductive material, may provide an electrical connection between the bus bar 1300 and an external voltage. The coating layer 1400, which is formed of a conductive material, may provide an electrical connection between the metal nanostructures 1210 and the bus bar 1300. The coating layer 1400, which is formed of a conductive material, may provide an additional electron movement path between the bus bar 1300 and the metal nanostructure 1210. When a voltage is applied to the bus bar 1300, electrons of the bus bar 1300 may be transferred not only to the metal nanostructures 1210 connected to the bus bar 1300, but also to the coating layer 1400, which is formed of a conductive material. Electrons transferred to the coating layer 1400, which is formed of a conductive material, may move in a direction away from the bus bar 1300 via the coating layer 1400, the metal nanostructures 1210, or the intersection points 1220. The coating layer 1400, which is formed of a conductive material, may increase the speed of electrons moving from the bus bar 1300 to the metal nanostructures 1210. The coating layer 1400, which is formed of a conductive material, may increase the electrical conductivity and heating efficiency of the transparent heating film 1000 by increasing the movement speed of electrons.

When the coating layer 1400 is not formed of a conductive material, the coating layer 1400 may not have electrical conductivity. The coating layer 1400, which is not formed of a conductive material, may not provide an electrical connection between the bus bar 1300 and an external voltage or between the bus bar 1300 and the metal nanostructures 1210. An external voltage source may be directly connected to the bus bar 1300. The coating layer 1400 may not exist in the portion in which the external voltage source and the bus bar 1300 are connected to each other, and may be connected via an additional separate metal material.

Although not shown, a separate through hole may be formed in the coating layer 1400. The through hole may be formed in a portion in which the external voltage source and the bus bar 1300 are connected to each other. The through hole may be formed in an area adjacent to the bus bar 1300. The through hole may be a region from which a portion of the coating layer 1400 is removed. The through hole may be formed to provide an electrical connection to the bus bar 1300. The through hole may be formed in the process of connecting the bus bar 1300 to the external voltage source. The bus bar 1300 may receive a voltage from the external voltage source via the through hole.

As the transparent heating film 1000 is in closer contact with the target member, the heat of the transparent heating film 1000 may be better transferred to the target member. Accordingly, although not illustrated, when the target member has a curved shape, the transparent heating film 1000 may also have a curved shape to match the target member. When the transparent heating film 1000 has a curved shape, each layer of the transparent heating film 1000 may have a curvature. The curvatures of respective layers of the transparent heating film 1000 may be different from each other. The radii of curvature of respective layers of the transparent heating film 1000 may be different from each other.

The target member may partition an internal space and an external space. The curved target member may have a concave surface and a convex surface located in opposite directions. The concave surface may be located in the internal space, and the convex surface may be located in the external space. The transparent heating film 1000 may be attached to the concave surface of the target member. With respect to the target member, the transparent heating film 1000 may be located in the internal space. This may be to protect the transparent heating film 1000 from the external space. When the transparent heating film 1000 is attached to the target member, respective layers of the transparent heating film 1000 may be located in the order of the transparent substrate 1100, the conductive network 1200, the bus bar 1300, and the coating layer 1400 in the direction away from the target member. Alternatively, in contrast to this, the coating layer 1400, the bus bar 1300, the conductive network 1200, and the transparent substrate 1100 may be located in this order. When the transparent substrate 1100 is located closest to the target member among the respective layers of the transparent heating film 1000 attached to the concave surface of the target member, the transparent substrate 1100 may have the largest radius of curvature and the smallest curvature among the respective layers of the transparent heating film 1000. In this case, the radii of curvature of the respective layers may decrease in the order of the conductive network 1200, the bus bar 1300, and the coating layer 1400. The curvatures of the respective layer may decrease in the reverse order. The bus bar 1300 may not have a curvature or a radius of curvature depending on the installed shape. When the transparent substrate 1100 is located furthest from the target member in the transparent heating film 1000 attached to the target member, the transparent substrate 1100 may have the smallest radius of curvature and the largest curvature among the respective layers of the transparent heating film 1000. In this case, the radii of curvature of the respective layers may increase in the order of the conductive network 1200, the bus bar 1300, and the coating layer 1400. The curvatures of the respective layer may increase in the reverse order. The bus bar 1300 may not have a curvature or a radius of curvature depending on the installed shape. That is, when the transparent heating film 1000 is attached to a concave surface of the target member, the radii of curvature of the respective layers of the transparent heating film 1000 may increase toward the target member. The curvatures of the respective layers of the transparent heating film 1000 may decrease toward the target member. This may be to ensure that each layer is not lifted or separated when the transparent heating film 1000 in which a plurality of layers are laminated is curved. Each layer of the transparent heating film 1000 may be made of a flexible material in order to withstand the above-described deformation. Each layer of the transparent heating film 1000 may be manufactured according to a specific design to withstand the above-described deformation.

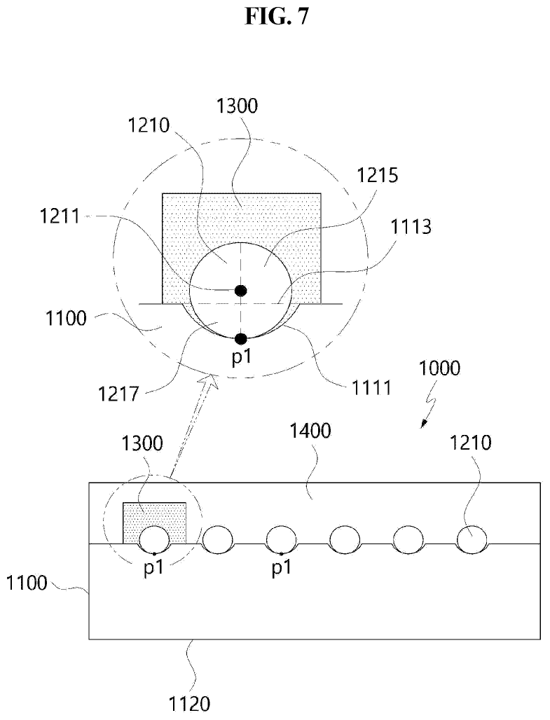

FIG. 7 is a cross-sectional view of a transparent heating film according to the second embodiment. Referring to FIG. 7, a transparent substrate 1100 meets metal nanostructures 1210 at first points p1, respectively, and a bus bar 1300 is located in contact with at least one metal nanostructure 1210.

When the metal nanostructure 1210, which is in contact with the bus bar 1300, is located in a groove 1111 of the transparent substrate 1100, the first point p1 may be located in the groove 1111. The metal nanostructure 1210, which is in contact with the bus bar 1300, may be in contact with a portion of the groove 1111 or in contact with the entirety of the groove 1111.

When the radius of curvature of the metal nanostructure 1210 in a region adjacent to the first point p1 is the same as the radius of curvature of the groove 1111 in the region adjacent to the first point p1, the bus bar 1300 may not contact be in contact with the groove 1111. The bus bar 1300 may contact a non-curved surface of the top surface 1110 of the transparent substrate 1100. When the radius of curvature of the metal nanostructure 1210 in the region adjacent to the first point p1 is smaller than the radius of curvature of the groove 1111 in the region adjacent to the first point p1, the bus bar 1300 may be partially interposed between the groove 1111 and the metal nanostructure 1210. The bus bar 1300 may be in contact with the first portion 1215 and the second portion 1217 of the metal nanostructure 1210 at the same time. The bus bar 1300 may connect the groove 1111 and the metal nanostructure 1210 to each other. As a result, the connection between the groove 1111 and the metal nanostructure 1210 may be strengthened.

When the metal nanostructure 1210, which is in contact with the bus bar 1300, is not located in a groove 1111 of the transparent substrate 1100, no first point p1 may be located in the groove 1111. The bus bar 1300 may be in contact the metal nanostructure 1210 and a portion of the transparent substrate 1100. The bus bar 1300 may be in contact with the first portion 1215 of the metal nanostructure 1210.

In the process of forming the bus bar 1300, heat or pressure or may be transferred to the transparent substrate 1100 and the conductive network 1200. As a result, the transparent substrate 1100 and the conductive network 1200 around the bus bar 1300 may be partially melted. In the process of forming the bus bar 1300, the transparent substrate 1100 and the conductive network 1200 may be partially recessed. Since the conductive network 1200 is partially recessed, the bus bar 1300 may advantageously secure an electrical connection with the conductive network 1200. In addition, since the bus bar 1300 is partially enclosed, the bus bar 1300 can be prevented from being separated by an external impact, and the stability of the product can be improved.

Although not illustrated, protrusions may be formed around the groove 1111 of the top surface 1110 of the transparent substrate 1100 in which the metal nanostructure 1210 in contact with the bus bar 1300 is located. The functions, sizes and shapes of the protrusions are the same as those described in the first embodiment. The protrusions formed along the edges of the metal nanostructure 1210 in contact with the bus bar 1300 may be in contact with the bus bar 1300. The protrusions are parts of the transparent substrate 1100 and may be strongly bonded to the bus bar 1300 than a flat surface. This may be due to the protruding shape of the protrusions. The metal nanostructure 1210, which is in contact with the bus bar 1300, may be more safely protected through the bonding between the protrusions and the bus bar 1300.

The coating layer 1400 may be in contact with the metal nanostructures 1210, which are not in contact with the bus bar 1300. The metal nanostructures 1210, which are in contact with the coating layer 1400, may or may not be located in the grooves 1111. When the metal nanostructures 1210, which are in contact with the coating layer 1400, are located in the grooves 1111 of the transparent substrate 1100, the first point p1 may be located in each of the grooves 1111. The metal nanostructure 1210, which is in contact with the coating layer 1400, may be in contact with a portion of the groove 1111 or in contact with the entirety of the groove 1111.

When the radius of curvature of the metal nanostructure 1210 in the region adjacent to the first point p1 is the same as the radius of curvature of the groove 1111 in the region adjacent to the first point p1, the coating layer 1400 may not be contact with the groove 1111. The coating layer 1400 may be in contact with the non-curved surfaces of the top surface 1110 of the transparent substrate 1100. When the radius of curvature of the metal nanostructure 1210 in the region adjacent to the first point p1 is smaller than the radius of curvature of the groove 1111 in the region adjacent to the first point p1, the coating layer 1400 may be partially interposed between the grooves1111 and the metal nanostructures 1210. The coating layer 1400 may be in contact with the first portion 1215 and the second portion 1217 of each metal nanostructure 1210 at the same time. The coating layer 1400 may connect the grooves 1111 and the metal nanostructures 1210 to each other. As a result, the connection between the grooves 1111 and the metal nanostructures 1210 may be strengthened.

When the metal nanostructures 1210, which are in contact with the coating layer 1400 are not located in the grooves 1111 of the transparent substrate 1100, no first point p1 may be located in the grooves 1111. The coating layer 1400 may be in contact the metal nanostructures 1210 and a portion of the transparent substrate 1100. The coating layer 1400 may be in contact with the first portion 1215 of each metal nanostructure 1210.

Although not illustrated, protrusions may be formed around the grooves 1111 in which the metal nanostructures 1210, which are in contact with the coating layer 1400, are located, respectively. The functions, sizes, and shapes of the protrusions are the same as those described in the first embodiment. The protrusions formed along the edges of the metal nanostructures 1210, which are in contact with the coating layer 1400, may be in contact with the coating layer 1400. The protrusions are portions of the transparent substrate 1100 and may be strongly bonded to the coating layer 1400 than the flat surfaces. This may be due to the protruding shape of the protrusions. The metal nanostructures 1210, which are in contact with the coating layer 1400, may be more safely protected through the bonding between the protrusions and the coating layer 1400.

The conductive network 1200 and the bus bar 1300 may provide a passage for electrons to move. The bus bar 1300 supplied with electrical energy from an external voltage source may transfer the electrical energy to the conductive network 1200. The conductive network 1200 and the bus bar 1300 may generate heat by converting the electrical energy into thermal energy. The transparent substrate 1100 may be in contact with the conductive network 1200 and the bus bar 1300, and may receive the thermal energy from the conductive network 1200 and the bus bar 1300. The transparent substrate 1100 may transfer the thermal energy received via the top surface 1110 to the outside of the bottom surface 1120. The transparent substrate 1100 may transfer the received thermal energy to the outside of the transparent substrate 1100. The transparent substrate 1100 may transmit thermal energy to a separate member that is in contact with the transparent substrate 1100. The coating layer 1400 may be in contact with the conductive network 1200 and the bus bar 1300, and may receive the thermal energy from the conductive network 1200 and the bus bar 1300. The coating layer 1400 may transfer the received thermal energy to the outside of the coating layer 1400. The coating layer 1400 may transfer the thermal energy to a separate member that is in contact with the coating layer 1400. When electrons start to move to the metal nanostructures 1210 and the transparent heating film 1000 starts to be heated, the temperatures of the transparent substrate 1100 and the coating layer 1400 may not be constant. However, the temperature of each of the transparent substrate 1100 and the coating layer 1400 may become uniform within several minutes or seconds. As described above, the excellent heating characteristics may be obtained due to the characteristics of the intersection points 1220 of the metal nanostructures 1210 and the positions of the metal nanostructures 1210.

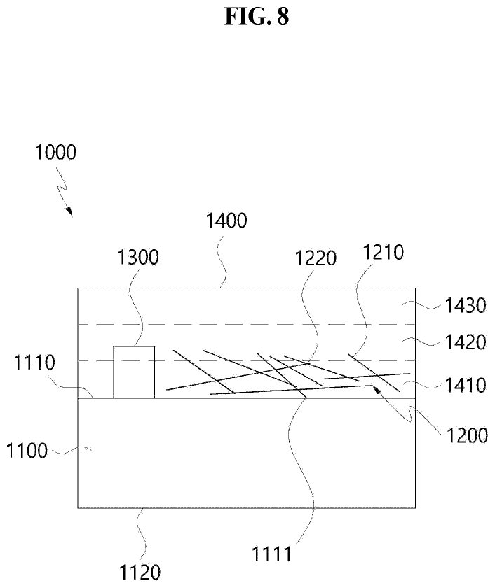

FIG. 8 is another cross-sectional view of the transparent heating film according to the second embodiment. Referring to FIG. 8, the conductive network 1200 and the bus bar 1300 are buried or enclosed in the coating layer 1400.

The coating layer 1400 may include three spaces divided by planes parallel to the bottom surface 1120 of the transparent substrate 1100. The coating layer 1400 may include a first space 1410, a second space 1420, and a third space 1430. A first space 1410, a second space 1420, and a third space 1430 may be sequentially located with reference to the transparent substrate 1100.

The first space 1410 may be defined as a region in which both ends of metal nanostructures 1210 are included, the second space 1420 may be defined as an area in which only one ends of metal nanostructures 1210 are included, and the third space 1430 may be defined as a region in which no metal nanostructure 1210 exists. Accordingly, a first area occupied by the metal nanostructures 1210 in the first space 1410 may be greater than a second area occupied by the metal nanostructures 1210 in the second space 1420, and the second area occupied by the metal nanostructures 1210 may be greater than a third area occupied by the metal nanostructures 1210 in the third space 1430.

The first space 1410 may be located closest to the transparent substrate 1100 in the coating layer 1400. The first space 1410 may be a space in which the metal nanostructures 1210 are buried. The first space 1410 may be a space in which the intersection points 1220 are buried. The first space 1410 may be a space in which most of the metal nanostructures 1210 are densely concentrated. The first space 1410 may be a space in which most of the intersection points 1220 are densely concentrated. This may be because the metal nanostructures 1210 are subjected to heat or pressure in the process of forming the conductive network 1200 and are thus located close to the transparent substrate 1100. The first space 1410 may include a portion or the entirety of the bus bar 1300.

Although not illustrated, the first space 1410 may include an electron movement plane. The electron movement plane may be one of the planes located in a space defined by the conductive network 1200. The electron movement plane may be a plane in which the sum of distances to respective intersection points 1220 is the smallest. The electron movement plane may be a plane in which the average value of distances from respective intersection points 1220 is the smallest. The electron movement plane may be a plane in which the standard deviation value of the distances to respective intersection points 1220 is the smallest. The electron movement plane may be located in which the intersection points 1220 are most densely concentrated. The electron movement plane may be a plane that most frequently intersects with the paths through which electrons transferred to the conductive network 1200 have moved. In this way, the first space 1410 may be a space in which the electrons most frequently move in the coating layer 1400. The first space 1410 may be a space having the highest electrical conductivity in the coating layer 1400.

The second space 1420 may be located farther from the transparent substrate 1100 than the first space 1410, and the second space 1420 may be located closer to the transparent substrate 1100 than the third space 1430. The second space 1420 may be located in the center of the coating layer 1400. The second space 1420 may be a space in which the metal nanostructures 1210 are buried. The second space 1420 may be a space in which the metal nanostructures 1210 are less densely collected than the first space 1410. The second space 1420 may or may not include a portion of the bus bar 1300. The electrical conductivity of the second space 1420 may not be higher than that of the first space 1410.

The third space 1430 may be a space located farthest from the transparent substrate 1100 in the coating layer 1400. The third space 1430 may be located farther from the transparent substrate 1100 than the first space 1410 and the second space 1420. The third space 1430 may be located at the upper end of the coating layer 1400. The third space 1430 may not be a space in which the metal nanostructures 1210 are buried. The third space 1430 may be a space in which the metal nanostructures 1210 are less densely collected than the first space 1410 and the second space 1420. The third space 1430 may not include the metal nanostructures 1210.

The third space 1430 may not include the bus bar 1300. The electrical conductivity of the third space 1430 may not be higher than those of the first space 1410 and the second space 1420 in the coating layer 1400. The third space 1430 may be a space having the lowest electrical conductivity in the coating layer 1400. The third space 1430 may not include the electron movement plane. The third space 1430 may be a space for protecting the metal nanostructures 1210 from external air and moisture by being located at the upper end of coating layer 1400 and not including the metal nanostructures 1210.

The coating layer 1400 may be heated more rapidly as the area that is in contact with the metal nanostructures 1210 or the bus bar 1300 increases. Accordingly, the first space 1410 of the coating layer 1400 may be heated more rapidly than the second space 1420, and the second space 1420 may be heated more rapidly than the third space 1430.

The first space 1410 may be a space to which thermal energy generated from a portion of the conductive network 1200, i.e., the metal nanostructures 1210, and the bus bar 1300 is transferred first. When a voltage is applied to the bus bar 1300 and the metal nanostructures 1210 and electrons start to move, heat may start to be generated in the first space 1410. The first space 1410 may be a space in which thermal energy is generated and starts to move. The first space 1410 may be heated from a lower space close to the transparent substrate 1100 in which the metal nanostructures 1210 are densely collected. In the first space 1410, a space located farther away from the transparent substrate 1100 may be less heated. A temperature gradient in the form of a gradation may be formed between the upper space and the lower space of the first space 1410. After a predetermined period of time elapses, the lower space and the upper space of the first space 1410 may have the same temperature gradient. After a predetermined period of time elapses, the first space 1410 may reach an equilibrium temperature. In addition, the first space 1410 may transfer thermal energy to the second space 1420 and the transparent substrate 1100.

The second space 1420 may receive the thermal energy from the first space 1410. Alternatively, the thermal energy may be transferred from the bus bar 1300 or the metal nanostructures 1210 included in the second space 1420. The second space 1420 is close to the first space 1410 and may be heated from a lower space in which the metal nanostructures 1210 are densely concentrated. In the second space 1420, a space located farther away from the first space 1410 may be less heated. A temperature gradient in the form of a gradation may be formed between the upper space and the lower space of the second space 1420. After a predetermined period of time elapses, the lower space and the upper space of the second space 1420 may have the same temperature gradient. After a predetermined period of time elapses, the second space 1420 may reach an equilibrium temperature. After a predetermined period of time elapses, the second space 1420 may reach a temperature close to that of the first space 1410 and may be maintained at the temperature. In addition, the second space 1420 may transfer thermal energy to the third space 1430, and the second space 1420 may exchange thermal energy with the first space 1410.

The third space 1430 may be a space that finally receives the thermal energy generated from a portion of the conductive network 1200, i.e., the metal nanostructures 1210, and the bus bar 1300 in the coating layer 1400. When a separate member is located outside the coating layer 1400, the third space 1430 may be a space for transferring the thermal energy to the separate member. The third space 1430 may be a space that receives the thermal energy from the second space 1420. The third space 1430 may be heated from a lower space close to the second space 1420. In the third space 1430, a space located farther away from the second space 1420 may be less heated. A temperature gradient in the form of a gradation may be formed between the upper space and the lower space of the third space 1430. After a predetermined period of time elapses, the lower space and the upper space of the third space 1430 may have the same temperature gradient. After a predetermined period of time elapses, the third space 1430 may reach an equilibrium temperature. After a predetermined period of time elapses, the third space 1430 may reach a temperature close to those of the first space 1410 and the second space 1420 and may be maintained at the temperature. In addition, the third space 14230 may transfer the thermal energy to a separate member, and the third space 1430 may exchange the thermal energy with the second space 1420.

The third space 1430 may be a space that receives the greatest external influence in the coating layer 1400. The first space 1410 may be a space that receives the least external influence in the coating layer 1400. Since the first space 1410 includes most of the conductive network 1200, i.e., the metal nanostructures 1210, the conductive network 1200 may be safely protected from external moisture and air. Since the first space 1410 includes most of the conductive network 1200, oxidation of the conductive network 1200 may be prevented and long-term stability may be ensured. In addition, since the first space 1410 includes most of the conductive network 1200, the transparent substrate 1100 and the outside of the bottom surface 1120 of the transparent substrate 1100 can be quickly heated. When the target member is located close to the transparent substrate 1100, it may be advantageous for the metal nanostructures 1210 to be densely concentrated in the first space 1410.

### 3. Third Embodiment

Hereinafter, a transparent heating film according to a third embodiment will be described. The transparent heating film according to the third embodiment is the same as the above-described embodiments except for those described below. Accordingly, in the description of the third embodiment, the same reference numerals are assigned to the components common to the above-described embodiments, and detailed descriptions thereof are omitted.

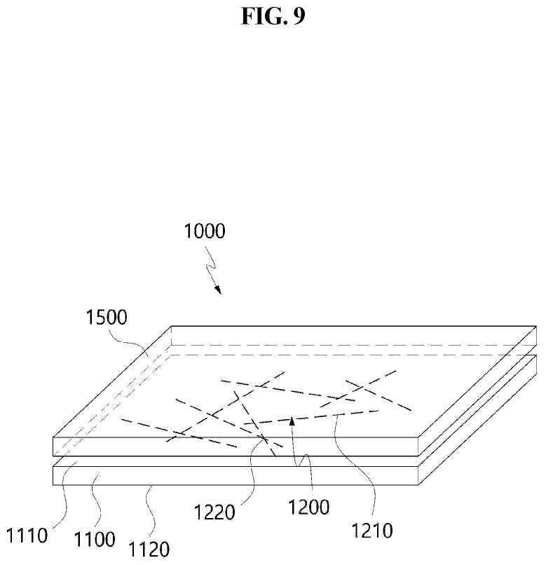

FIG. 9 is a perspective view of the transparent heating film according to the third embodiment. Referring to FIG. 9, the transparent heating film 1000 includes a transparent substrate 1100, a conductive network 1200, and an adhesive layer 1500. The transparent substrate 1100 includes a top surface 1110 and a bottom surface 1120. The conductive network 1200 includes intersection points 1220 formed by different metal nanostructures 1210 which intersect with each other.

The transparent substrate 1100 may be used for fixing and supporting the transparent heating film 1000. The conductive network 1200 and the adhesive layer 1500 may be located on the transparent substrate 1100. The transparent substrate 1100 may be flat. The top surface 1110 of the transparent substrate 1100 may be flat. No groove 1111 may be formed on the top surface 1110 of the transparent substrate 1100. The top surface 1110 of the transparent substrate 1100 may not be in contact with the conductive network 1200. The top surface 1110 of the transparent substrate 1100 may be in contact with the adhesive layer 1500.

The conductive network 1200 may include a metal to provide a passage for electrons to move. The conductive network 1200 may be formed by the metal nanostructures 1210. In the conductive network 1200, the plurality of metal nanostructures 1210 may be irregularly located. The conductive network 1200 may include a plurality of intersection points 1220 formed by the metal nanostructures 1210. The conductive network 1200 may be formed by applying heat, pressure, or both heat and pressure to the metal nanostructures 1210. The conductive network 1200 may be formed without applying heat or pressure to the metal nanostructures 1210. When heat or pressure is applied to the metal nanostructures 1210, bonding surfaces or adhesion surfaces between the metal nanostructures 1210 at which the intersection points 1220 are located may have a width larger than the diameter of the metal nanostructures 1210. As a result, electrons in the conductive network 1200 may move rapidly between the metal nanostructures 1210, and the electrical conductivity of the transparent heating film 1000 may be improved. Since the electrons move rapidly within the transparent heating film 1000 in this way, the transparent heating film 1000 may be rapidly and uniformly heated.

The height of a portion of the conductive network 1200 in which the intersection points 1220 formed by heat or pressure are located may be smaller than the sum of diameters of two metal nanostructures 1210. Accordingly, the overall thickness of the conductive network 1200 may be reduced, and the conductive network 1200 may be improved in terms of surface roughness. Since the conductive network 1200 is improved in terms of surface roughness, scattering or reflection of light is reduced so that the transparent heating film 1000 can be improved in terms of haze. Therefore, the electrical conductivity of the conductive network 1200 formed by applying heat or pressure to the metal nanostructures 1210 may be superior to that of the conductive network 1200 formed without applying heat or pressure to the metal nanostructures 1210, and an improvement may be achieved in terms of haze.

The adhesive layer 1500 may be formed of a polymer having a hydrocarbon structure. The adhesive layer 1500 may be formed of a single material or may be formed of a composite of several materials. The adhesive layer 1500 may be optically transparent. The adhesive layer 1500 may be difficult to be distinguished from the transparent substrate 1100. The adhesive layer 1500 may include the same material as the transparent substrate 1100. The adhesive layer 1500 may include a material having a property similar to that of the transparent substrate 1100. The adhesive layer 1500 may be a flexible material. When the transparent substrate 1100 on which the adhesive layer 1500 is placed is flexible, the transparent heating film 1000 may be made of a flexible film. The adhesive layer 1500 of the third embodiment is formed on the transparent substrate 1100, but may be utilized for various purposes when the adhesive layer is formed on a flexible member such as a fiber. The light transmittance of the adhesive layer 1500 may be higher than the light transmittances of the conductive network 1200 and the bus bar 1300. The light transmittance of the adhesive layer 1500 may be similar to or equal to that of the transparent substrate 1100. The adhesive layer 1500 may transmit light, electromagnetic waves, and heat. The adhesive layer 1500 may transfer thermal energy.

The adhesive layer 1500 may be located between the transparent substrate 1100 and the conductive network 1200. The adhesive layer 1500 may be located on the transparent substrate 1100, and the conductive network 1200 may be located within the adhesive layer 1500. The adhesive layer 1500 may be in contact with the top surface 1110 of the transparent substrate 1100. The adhesive layer 1500 may be used for fixing the transparent substrate 1100 and the conductive network 1200. The adhesive layer 1500 may be provided to bury and protect the conductive network 1200.

The conductive network 1200 may be located inside the adhesive layer 1500. The conductive network 1200 may be enclosed or buried in the adhesive layer 1500. The conductive network 1200 may be located on the adhesive layer 1500. The adhesive layer 1500 may be in contact with the conductive network 1200. The adhesive layer 1500 may be in contact with the metal nanostructures 1210. The adhesive layer 1500 may be in contact with the intersection points 1220. The material constituting the adhesive layer 1500 may be coated on the metal nanostructures 1210. The material constituting the adhesive layer 1500 may enclose or cover the metal nanostructures 1210. The adhesive layer 1500 may be partially located between the metal nanostructures 1210. The adhesive layer 1500 may be partially located between the intersection points 1220. The adhesive layer 1500 may be partially located between the metal nanostructures 1210 and the intersection points 1220.

The adhesive layer 1500 may fill the curved portions of the conductive network 1200 to make the conductive network flat. The adhesive layer 1500 may fill spaces between the irregularly located metal nanostructures 1210. Due to the adhesive layer 1500, the spaces between the metal nanostructures 1210 may be filled without gaps. Accordingly, one surface of the adhesive layer 1500 on which the metal nanostructures 1210 are located may be flat, and the surface roughness of the one surface of the adhesive layer 1500 may be small. Due to this, the surface roughness of the transparent heating film 1000 including the adhesive layer 1500 may be reduced. When the surface roughness of the transparent heating film 1000 is reduced, light scattering or reflection is reduced, so that the transparent heating film 1000 can be improved in terms of haze.

In addition, the adhesive layer 1500 may protect the metal nanostructures 1210 from external air and moisture since the metal nanostructures 1210 are buried in the adhesive layer. Oxidation of the metal nanostructure 1210 may be prevented due to the adhesive layer 1500, and long-term stability of the transparent heating film 1000 may be ensured.

When the conductive network 1200 formed by applying heat and pressure to the metal nanostructures 1210 rather than the conductive network 1200 formed without applying heat or pressure to the metal nanostructure 1210 is buried in the adhesive layer 1500, the transparent heating film 1000 may be more improved than the above-described first embodiment in terms of haze. This may be because the surface roughness value of the transparent heating film 1000 is smaller than that of the transparent heating film 1000 according to the first embodiment. This effect can be achieved since the conductive network 1200 itself is improved in terms of surface roughness by applying heat or pressure, and the conductive network 1200 is buried in the adhesive layer 1500 so that the transparent heating film 1000 is further improved in terms of surface roughness. By applying these various methods to improve the transparent heating film 1000 in terms of the surface roughness, the haze value of the transparent heating film 1000 may be lowered, and the transparency of the transparent heating film 1000 may be enhanced.

In addition, when the conductive network 1200 is located on the adhesive layer 1500, the conductive network 1200 is disposed outside the transparent heating film 1000, which may facilitate the connection of the conductive network with a voltage source. When the conductive network 1200 is easily connected to a voltage source, the process of manufacturing the transparent heating film 1000 may be simplified and the manufacturing cost may be reduced. By burying the conductive network 1200 outside in this way, the connection to a voltage source is facilitated while preventing the oxidation of the conductive network 1200, whereby the manufacturing cost of the transparent heating film 1000 can be reduced.

When a plurality of metal nanostructures 1210 or the conductive network 1200 are located on a separate substrate are shifted to the adhesive layer 1500 by applying pressure, the conductive network 1200 may be located in the upper portion of the adhesive layer 1500. In this case, the adhesive layer 1500 may be formed by coating and curing a material constituting the adhesive layer 1500 on a separate substrate and metal nanostructures 1210. By forming a composite in which one surface of the adhesive layer 1500 is in contact with the metal nanostructures 1210 and a separate substrate and the other surface of the adhesive layer 1500 is in contact with the transparent substrate 1100, then applying pressure to the composite, and removing the separate substrate, it is possible to locate the conductive network 1200 in the upper portion of the adhesive layer 1500. The pressure may be applied before the other surface of the adhesive layer 1500 comes into contact with the transparent substrate 1100.

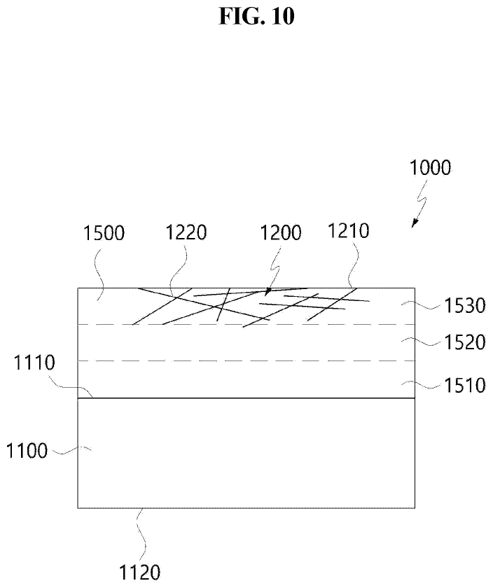

FIG. 10 is a cross-sectional view of the transparent heating film according to the third embodiment. Referring to FIG. 10, the conductive network 1200 is buried or enclosed in the adhesive layer 1500.

The adhesive layer 1500 may include three spaces divided by planes parallel to the bottom surface 1120 of the transparent substrate 1100. The adhesive layer 1500 may include a fourth space 1510, a fifth space 1520, and a sixth space 1530.

The fourth space 1510 may be located closer to the transparent substrate 1100 than the fifth space 1520, the fifth space 1520 may be located closer to the transparent substrate 1100 than the sixth space 1530. That is, the fourth space 1510, the fifth space 1520, and the sixth space 1530 may be sequentially located with reference to the transparent substrate 1100.

The fourth space 1510 is defined as a region in which the metal nanostructures 1210 do not exist, the fifth space 1520 is defined as a region in which only one ends of the metal nanostructures 1210 are included, and the sixth space 1530 may be defined as a region in which including both ends of the metal nanostructures 1210 are included. Accordingly, a fourth area occupied by the metal nanostructures 1210 in the fourth space 1510 may be greater than a fifth area occupied by the metal nanostructures 1210 in the fifth space 1520, and the fifth area occupied by the metal nanostructures 1210 may be greater than a sixth area occupied by the metal nanostructures 1210 in the sixth space 1530.

The fourth space 1510 may be located closest to the transparent substrate 1100 in the adhesive layer 1500. The fourth space 1510 may be a space in which the metal nanostructures 1210 are less densely collected than the fifth space 1520 and the sixth space 1530. The fourth space 1510 may not include the metal nanostructures 1210. The fourth space 1510 may be a space having the lowest electrical conductivity in the adhesive layer 1500. The fourth space 1510 may be a space for forming an adhesive surface with the transparent substrate 1100. The adhesive surface may be used for fixing the metal nanostructures 1210, i.e., the conductive network 1200, and the transparent substrate 1100.

The fifth space 1520 may be located farther from the transparent substrate 1100 than the fourth space 1510, and the fifth space 1520 may be located closer to the transparent substrate 1100 than the sixth space 1530. The fifth space 1520 may be a space in which the metal nanostructures 1210 are buried. The fifth space 1520 may be a space in which the metal nanostructures 1510 are more densely collected than the fourth space 1510. The electrical conductivity of the fifth space 1520 may be higher than that of the fourth space 1510. The fifth space 1520 may be located between the fourth space 1510 and the sixth space 1530 to interconnect these two spaces.

The sixth space 1530 may be a space located farthest from the transparent substrate 1100 in the adhesive layer 1500. The sixth space 1530 may be the outermost space in the adhesive layer 1500. The sixth space 1530 may be located farther from the transparent substrate 1100 than the fourth space 1510 and the fifth space 1520. The sixth space 1530 may be located on the upper end of the adhesive layer 1500. The sixth space 1530 may be a space in which most of the metal nanostructures 1210 are buried. The sixth space 1530 may be a space in which most of the intersection points 1220 are buried. The sixth space 1530 may be a space in which most of the metal nanostructures 1210 are densely concentrated. The sixth space 1530 may be a space in which most of the intersection points 1220 are densely concentrated. The electrical conductivity of the sixth space 1530 may be higher than those of the fourth space 1510 and the fifth space 1520. The sixth space 1530 may be a space having the highest electrical conductivity in the adhesive layer 1500.

Although not illustrated, the sixth space 1530 may include an electron movement plane. The electron movement plane may be one of the planes located in a space defined by the conductive network 1200. The electron movement plane may be a plane in which the sum of distances to respective intersection points 1220 is the smallest. The electron movement plane may be a plane in which the average value of distances from respective intersection points 1220 is the smallest. The electron movement plane may be a plane in which the standard deviation value of the distances to respective intersection points 1220 is the smallest. The electron movement plane may be located in which the intersection points 1220 are most densely concentrated. The electron movement plane may be a plane that most frequently intersects with the paths through which electrons transferred to the conductive network 1200 have moved. In this way, the sixth space 1530 may be a space in which the electrons most frequently move in the adhesive layer 1500. The sixth space 1530 may be a space having the highest electrical conductivity in the adhesive layer 1500.

Some of the metal nanostructures 1210 located at the uppermost end of the sixth space 1530 may be exposed to the outside beyond the sixth space 1530. When the top surface of the sixth space 1530 is exposed to external air and moisture, some of the metal nanostructures 1210 may also be exposed to the external air and moisture. Some of the metal nanostructures 1210 exposed to the outside on the top surface of the sixth space 1530 may be the intersection points 1220. When the conductive network 1200 is formed by applying heat and pressure, and the conductive network 1200 is located in the upper portion of the adhesive layer 1500, at least one of the intersection points 1220 may be exposed to the outside at the uppermost end of the sixth space 1530.

By locating some of the metal nanostructures 1210 or intersection points 1220 at the uppermost end of the sixth space 1530, electrical characteristics of the transparent heating film 1000 may be further improved. When a separate conductive member capable of applying an external voltage, for example, a bus bar 1300, comes into contact with some of the metal nanostructures 1210 or the intersection points 1220, the conductive member may cause electrons to rapidly move. When a separate conductive member such as the bus bar 1300 comes into contact with the intersection points 1220, the conductive member may come into contact a plurality of metal nanostructures 1210 at the same time, and due to the wide widths of the intersection points 1220, the electrons may move faster. In this way, the adhesive layer 1500 fixes the metal nanostructures 1210 to the transparent substrate 1100, and causes the metal nanostructures 1210 to be buried therein so that the adhesive layer may serve to protect the metal nanostructures from external influences while maintaining an excellent electrical connection. The upper end of the adhesive layer 1500 in which the sixth space 1530 is located may be flat. As described above, the adhesive layer 1500 may improve the transparent heating film 1000 in terms of haze by improving the surface roughness of the transparent heating film 1000.

Some of the metal nanostructures 1210 located at the uppermost end of the sixth space 1530 may be exposed to the outside, but most of the metal nanostructures 1210 may still be buried in the adhesive layer 1500 to be protected from external air and moisture. In addition, the metal nanostructures 1210 exposed to the outside may also be partially buried in the adhesive layer 1500 to be protected from external air and moisture. Even when some of the metal nanostructures 1210 are exposed to the outside as described above, oxidation of the metal nanostructure 1210 can be prevented due to the adhesive layer 1500 and long-term stability can be ensured.

The adhesive layer 1500 may be heated more rapidly as the area in contact with the metal nanostructures 1210 increases. Accordingly, the sixth space 1530 of the coating layer 1500 may be heated more rapidly than the fourth space 1520, and the fifth space 1520 may be heated more rapidly than the fourth space 1510.

The sixth space 1530 may be a space to which thermal energy generated in a portion of the conductive network 1200, i.e., the metal nanostructures 1210, is transmitted first. When a voltage is applied to the metal nanostructures 1210 and electrons start to move, heat may start to be generated in the sixth space 1530. The sixth space 1530 may be a space in which thermal energy is generated and starts to move. The sixth space 1530 may be heated from the upper space in which the metal nanostructures 1210 are densely collected, i.e., the space located far away from the transparent substrate 1100. In the sixth space 1530, a space located closer to the transparent substrate 1100 may be less heated. A temperature gradient in the form of a gradation may be formed between the lower space below and the upper space of the sixth space 1530. After a predetermined period of time elapses, the lower space and the upper space of the sixth space 1530 may have the same temperature gradient. After a predetermined period of time elapses, the sixth space 1530 may reach an equilibrium temperature. In addition, when a separate member is located outside the adhesive layer 1500, the sixth space 1530 may transfer the thermal energy to the separate member. Since the sixth space 1530 includes most of the metal nanostructures 1210, the separate member located outside the adhesive layer 1500 may be rapidly heated. Therefore, when the target member is located close to the adhesive layer 1500, it may be advantageous for the metal nanostructures 1210 to be densely concentrated in the sixth space 1530. In this way, the sixth space 1530 may transfer the generated thermal energy to the outside of the fifth space 1520 and the adhesive layer 1500.

The fifth space 1520 may receive thermal energy from the sixth space 1530. Alternatively, thermal energy may be transferred from the metal nanostructures 1210 included in the fifth space 1520. The fifth space 1520 may be heated from the upper space which is close to the sixth space 1530 and in which the metal nanostructures 1210 are densely collected. In the fifth space 1520, a space located farther away from the sixth space 1530 may be less heated. A temperature gradient in the form of a gradation may be formed between the lower space below and the upper space of the fifth space 1520. After a predetermined period of time elapses, the lower space and the upper space of the fifth space 1520 may have the same temperature gradient. After a predetermined period of time elapses, the fifth space 1520 may reach an equilibrium temperature. After a predetermined period of time elapses, the fifth space 1520 may reach a temperature close to that of the sixth space 1530 and may be maintained at the temperature. In addition, the fifth space 1520 may transfer thermal energy to the fourth space 1510, and the fifth space 1520 may exchange thermal energy with the sixth space 1530.

The fourth space 1510 may be a space that finally receives the thermal energy generated from a portion of the conductive network 1200, i.e., the metal nanostructures 1210, in the adhesive layer 1500. The fourth space 1510 may be a space that receives the thermal energy from the fifth space 1520 and transfers the thermal energy to the transparent substrate 1100 which is in contact with the adhesive layer 1500. The fourth space 1510 may be heated from an upper space close to the fifth space 1520. In the fourth space 1510, a space located farther away from the fifth space 1520 may be less heated. A temperature gradient in the form of a gradation may be formed between the lower space below and the upper space of the fourth space 1510. After a predetermined period of time elapses, the lower space and the upper space of the fourth space 1510 may have the same temperature gradient. After a predetermined period of time elapses, the fourth space 1510 may reach an equilibrium temperature. After a predetermined period of time elapses, the fourth space 1510 may reach a temperature close to those of the fifth space 1520 and the sixth space 1530 and may be maintained at the temperature. In addition, the fourth space 1510 may transfer thermal energy to the transparent substrate 1100, and the fourth space 1510 may exchange thermal energy with the fifth space 1520.

The metal nanostructures 1210 are densely concentrated in the sixth space 1530, which is the upper end of the adhesive layer 1500. This may be due to the process of manufacturing the transparent heating film 1000. This may be due to the process of forming the adhesive layer 1500 on a separate substrate and then attaching and shifting the adhesive layer 1500 to the transparent substrate 1100. This may be caused because, in this process, the metal nanostructures 1210 are located at the upper end while the metal nanostructures 1210 placed on the separate substrate are fixed to the transparent substrate 1100 together with the adhesive layer 1500. For this reason, the metal nanostructures 1210 and the transparent substrate 1100 may be connected or fixed with the adhesive layer 1500 interposed therebetween.

When the conductive network 1200 is formed by applying pressure to the metal nanostructures 1210 placed on the separate substrate, the intersection points 1220 may be formed in the lowermost portion of the conductive network 1200, that is, the portion located closest to the separate substrate. The adhesive layer 1500 may serve to shift the conductive network 1200 formed of the metal nanostructures 1210 and connect the conductive network 1200 to the transparent substrate 1100. In this case, the adhesive layer 1500 is placed on the transparent substrate 1100 in the reverse direction, and the intersection points 1220 may be located at the uppermost end of the adhesive layer 1500 located in the reverse direction, that is, the sixth space 1530.

### 4. Fourth Embodiment

Hereinafter, a transparent heating film according to a fourth embodiment will be described. The transparent heating film according to the fourth embodiment is the same as the third embodiment except that it further includes a bus bar and a coating layer. Accordingly, in the description of the fourth embodiment, the same reference numerals are assigned to the components common to the above-described embodiments, and detailed descriptions thereof are omitted.

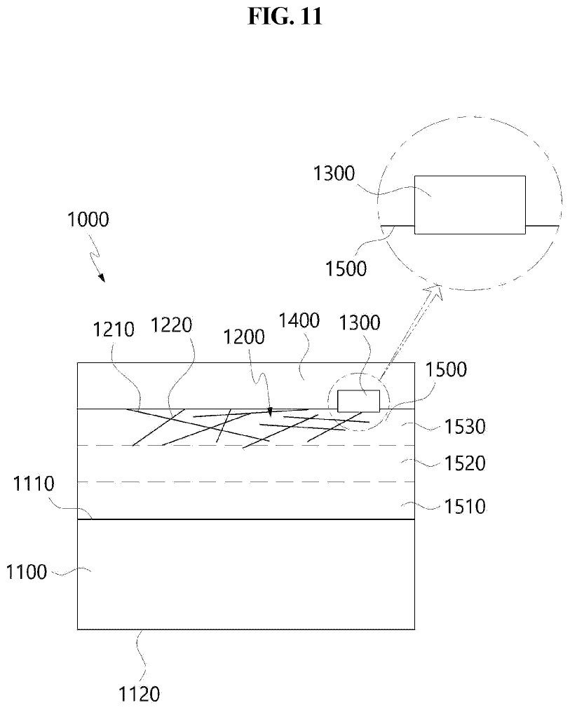

FIG. 11 is a cross-sectional view of the transparent heating film according to the fourth embodiment. Referring to FIG. 11, the transparent heating film 1000 may further include a bus bar 1300 and a coating layer 1400 in addition to the transparent substrate 1100, the conductive network 1200, and the adhesive layer 1500, and the bus bar 1300 may be located on the adhesive layer 1500. The coating layer 1400 may be omitted.

The bus bar 1300 and the coating layer 1400 may have the same functions, shapes, materials, and the like as those described in the second embodiment, except for those described below. Therefore, for the bus bar 1300 and the coating layer 1400, refer to the second embodiment. A detailed description thereof is omitted.

The bus bar 1300 may be a conductive member electrically connected to the conductive network 1200 to move electrons. The bus bar 1300 may transfer electrical energy to the conductive network 1200 to generate thermal energy.

The bus bar 1300 may be located on the adhesive layer 1500, and may be in contact with a portion of the conductive network 1200 or the metal nanostructures 1210. The bus bar 1300 may be located between the adhesive layer 1500 and the coating layer 1400. As described above, when the bus bar 1300 comes into contact with the intersection point 1220, the bus bar 1300 may cause electrons to quickly move to the conductive network 1200. For this reason, the electrical conductivity and heating characteristics of the transparent heating film 1000 may be excellent.

Heat or pressure may be applied in the process of forming or attaching the bus bar 1300. This may be performed to fix the bus bar 1300 to the adhesive layer 1500, and to cause the bus bar 1300 to be electrically connected to the metal nanostructure 1210 well. In the process of forming or attaching the bus bar 1300, a portion of the metal nanostructure 1210 and a portion of the adhesive layer 1500 that come into contact with the bus bar 1300 may receive heat or pressure transferred thereto. In this process, the portion of the metal nanostructure 1210 and the portion the adhesive layer 1500 may be deformed. After the bus bar 1300 is attached, the metal nanostructure 1210 located around the bus bar 1300 may be deformed. The adhesive layer 1500 may be partially recessed or dented so that the bus bar 1300 can be well positioned. A portion of the side surface of the bus bar 1300 may come into contact the adhesive layer 1500. A portion of the bus bar 1300 may be buried or enclosed in the adhesive layer 1500. Since the bus bar 1300 is partially buried or enclosed, the bus bar 1300 may make it possible to advantageously secure an electrical connection with the conductive network 1200. In addition, since the bus bar 1300 is partially enclosed, the bus bar 1300 can be prevented from being separated by an external impact, and the stability of the product can be improved.

Although not illustrated, the adhesive layer 1500 around the bus bar 1300 may be curved. The adhesive layer 1500 around the bus bar 1300 may have a protrusion. The protrusion may be formed since the material of the adhesive layer 1500 that has been located in the space in which the bus bar is buried or enclosed is moved and accumulated as much as the enclosed or buried amount of bus bar 1300. The protrusion may be formed around the bus bar 1300. Since the protrusion is formed around the bus bar 1300, the surface roughness of the transparent heating film 1000 may be minimized.

The coating layer 1400 may be used for protecting the conductive network 1200, i.e., the metal nanostructures 1210, and the bus bar 1300 from external moisture and air. The coating layer 1400 may be located on the adhesive layer 1500. The coating layer 1400 may be located on the conductive network 1200 and the bus bar 1300. The conductive network 1200 may be doubly protected by the coating layer 1400 and the adhesive layer 1500. In the conductive network 1200, the portions of the metal nanostructures 1210, which are located at the uppermost end of the adhesive layer 1500 and exposed to the outside of the adhesive layer 1500, may be protected by the coating layer 1400. When the intersection points 1220 are located at the uppermost end of the adhesive layer 1500 and exposed to the outside of the adhesive layer 1500, the intersection points 1220 may also be protected by the coating layer 1400. The intersection points 1220 may be located between the adhesive layer 1500 and the coating layer 1400. The bus bar 1300 may be protected by the coating layer 1400 while being excellently electrically connected with the conductive network 1200.

The coating layer 1400 may be omitted. Even if the coating layer 1400 is omitted, since the conductive network 1200 is buried in the adhesive layer 1500, the conductive network 1200 can be protected from external moisture and air.

When the target member has a curved shape, the transparent heating film 1000 may also have a curved shape to match the target member. The concave surface of the target member may be located in the internal space, the transparent heating film 1000 may be attached to the concave surface. When the transparent heating film 1000 is attached to the target member, respective layers of the transparent heating film 1000 may be located in the order of the transparent substrate 1100, the adhesive layer 1500, the conductive network 1200, the bus bar 1300, and the coating layer 1400 in the direction away from the target member. Alternatively, in contrast to this, the coating layer 1400, the bus bar 1300, the conductive network 1200, the adhesive layer 1500, and the transparent substrate 1100 may be located in this order. When the transparent substrate 1100 is located closest to the target member among the respective layers of the transparent heating film 1000, the transparent substrate 1100 may have the largest radius of curvature and the smallest curvature among the respective layers of the transparent heating film 1000. In this case, the radii of curvature of the respective layers may decrease in the order of the adhesive layer 1500, the conductive network 1200, the bus bar 1300, and the coating layer 1400. The curvatures of the respective layers may decrease in the reverse order. The bus bar 1300 may not have a curvature or a radius of curvature depending on the installed shape. When the transparent substrate 1100 is located furthest from the target member in the transparent heating film 1000 attached to the target member, the transparent substrate 1100 may have the smallest radius of curvature and the largest curvature among the respective layers of the transparent heating film 1000. In this case, the radii of curvature of the respective layers may increase in the order of the adhesive layer 1500, the conductive network 1200, the bus bar 1300, and the coating layer 1400. The curvatures of the respective layers may increase in the reverse order. The bus bar 1300 may not have a curvature or a radius of curvature depending on the installed shape.

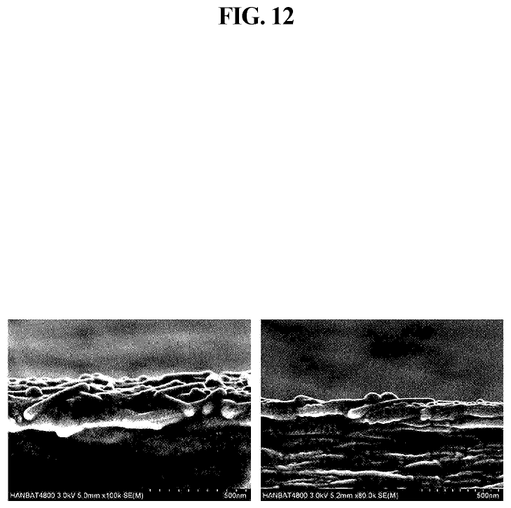

FIG. 12 illustrates cross-sectional SEM photographs of the transparent heating film according to the first embodiment. The transparent heating film 1000 is formed by applying heat or pressure to the silver nanowires located on the transparent substrate. Referring to FIG. 12, the conductive network 1200 is located on the top surface of the transparent substrate 1100 of the transparent heating film 1000. The conductive network 1200 includes a plurality of metal nanostructures 1210, and the conductive network 1200 may be formed by applying heat or pressure to the plurality of metal nanostructures 1210. The metal nanostructures 1210 subjected to heat or pressure may have intersection points 1220. The intersection points 1220 may have a width greater than the diameter of the metal nanostructures 1210.

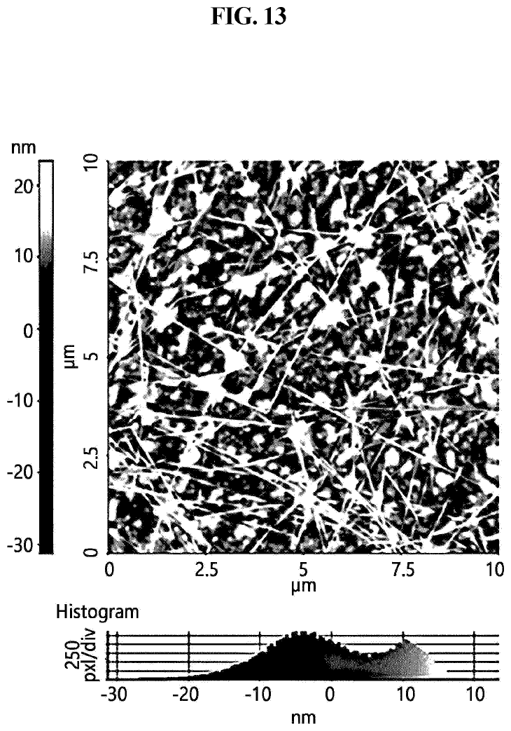

FIG. 13 illustrates an AFM measurement result of the transparent heating film according to the first embodiment. The conductive network 1200 of the transparent heating film 1000 is formed by applying heat or pressure to the metal nanostructures 1210—the silver nanowires—located on the transparent substrate 1100.

Referring to FIG. 13, the transparent heating film 1000 has a rough surface. The surface roughness of the transparent heating film 1000 may be caused because the metal nanostructures 1210 are located on the transparent substrate 1100. This can be seen through the metal nanostructures 1210 shown brightly in FIG. 13. In particular, the portions at which the intersection points 1220 at which the metal nanostructures 1210 intersect with each other are located are shown brighter than other portions of the conductive network 1200. This may be because height values of portions of the conductive network 1200 in which the intersection points 1220 are located greater than height values of other portions of the conductive network 1200 in which the intersection points 1220 are not located. As described above, the surface roughness of the conductive network 1200, that is, the transparent heating film 1000, may be more influenced by the intersection points 1220 than the metal nanostructures 1210. Meanwhile, the sizes and shapes of the intersection points 1220 may vary depending on heat or pressure applied to the metal nanostructures 1210, by which the transparent heating film 1000 may be improved in terms of surface roughness.

In addition, in the photograph of the measurement result of FIG. 13, the dark portions may be grooves 1111 in the transparent substrate 1100. The grooves 1111 may be located lower than the top surface 1110 of the transparent substrate 1100. The metal nanostructures 1210 may be located at positions corresponding to the grooves 1111, respectively. Although not observed in FIG. 13, the grooves 1111 and the metal nanostructures 1210 may contact each other at the first points p1, respectively. The radius of curvature of the metal nanostructure 1210 in a region adjacent to the first point p1 may be the same as the radius of curvature of the groove 1111 in the region adjacent to the first point p1. In the dark portions around the metal nanostructures 1210 shown brightly in the measurement result of FIG. 13, when the radius of curvature of each metal nanostructure 1210 in the region adjacent to the first point p1 is smaller than the radius of curvature of the corresponding groove 1111, a portion of the groove 1111 may be photographed without being covered by the metal nanostructure 1210 and shown as an analysis result.

Depending on the positions of the metal nanostructures 1210, a height difference between the top surface 1110 of the transparent substrate 1100 and the top surface of the metal nanostructure 1210 may have various values. Referring to the histogram distribution of the measurement result of FIG. 13, it can be seen that the graph has peak values at −5 nm and 10 nm. Through this, −5 nm may be assumed as the relative height value of the top surface 1110 of the transparent substrate 1100, and 10 nm may be assumed as the relative height value of the top surface of the metal nanostructures 1210. In this case, the height difference between the top surface 1110 of the transparent substrate 1100 and the top surface of the metal nanostructures 1210 may be 15 nm. Since the diameter of the silver nanowires used in the transparent heating film 1000 is 25 nm, the metal nanostructures 1210—the silver nanowires—may be partially enclosed in the transparent substrate 1100, and the grooves 1111 may be formed at the positions at which the metal nanostructures 1210 are enclosed. Since the metal nanostructures 1210 are enclosed in the transparent substrates 1100 and the grooves 1111 are formed, the surface roughness of the transparent heating film 1000 may be reduced and the haze value may be reduced. In addition, heat generated in the metal nanostructures 1210 may be rapidly transferred to the outside of the transparent substrate 1100 so that the heating efficiency of the transparent heating film 1000 can be improved. The enclosed degrees of respective metal nanostructures 1210 may be different from each other. Therefore, the height difference between the top surfaces of respective metal nanostructures 1210 and the top surface 1110 of the transparent substrate 1100 may have a value smaller than or greater than 15 nm.

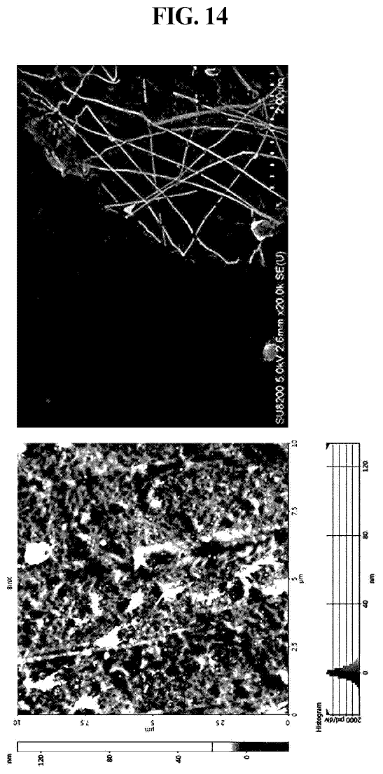

FIG. 14 illustrates an AFM measurement result and a front SEM photograph of the transparent substrate of the transparent heating film according to the first embodiment. Referring to FIG. 14, grooves 1111 are formed on the top surface 1110 of the transparent substrate 1100. The grooves 1111 may be observed by removing the metal nanostructures 1210 from the transparent heating film 1000. The positions and shapes of the grooves 1111 may be determined according to the positions and shapes of the metal nanostructures 1210. The grooves 1111 may be irregularly located and may have irregular shapes. The top surface 1110 of the transparent substrate 1100 may have curved grooves 1111, rather than being flat. The groove 1111 may have a straight shape having a width and a length.

Referring to the measurement result of FIG. 14, the depths of the grooves 1111 may be 20 nm or less. This can be explained through the fact that the histogram distribution of FIG. 14 is concentrated between about −10 nm and 10 nm. Since the diameter of the silver nanowires used for manufacturing the transparent heating film 1000 is 25 nm, the metal nanostructures 1210—the silver nanowires—may be partially enclosed in the transparent substrate 1100. The enclosed degrees of the metal nanostructures 1210 may be different from each other.

Referring to the front SEM photograph of FIG. 14, the grooves 1111 may have a small width and a long length. The grooves 1111 are recessed portions in the transparent substrate 1100, and may be dark portions in the AFM measurement result of FIG. 14. The dark portions of the AFM measurement result may be observed in linear shapes. In addition, the linear shapes observed brightly along the dark portions of the AFM measurement result may be protrusions 1115. Each protrusion 1115 may be located next to a groove 1111 and a metal nanostructure 1210. Since the protrusions 1115 are formed around the metal nanostructures 1210, degradation in performance of the transparent substrate 1100 due to the protrusions 1115 may be minimized, and the changes in surface roughness, haze, and transparency of the transparent heating film 1000 may be minimized.

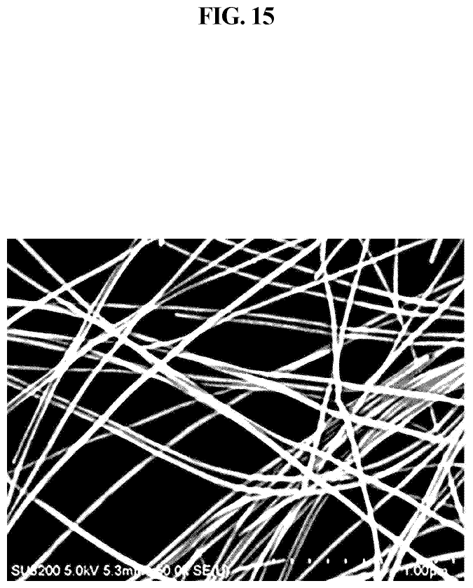

FIG. 15 is a front SEM photograph of a conductive network on a transparent substrate. Referring to FIG. 15, a conductive network 1200 is positioned on a transparent substrate 1100. The conductive network 1200 includes a plurality of metal nanostructures 1210. The metal nanostructures 1210 may be described with reference to the above-described embodiments. The conductive network 1200 may be formed by applying a plurality of metal nanostructures 1210 dispersed in a liquid to a transparent substrate 1100 and evaporating the liquid. The liquid may be volatile. The liquid may include an alcohol such as ethanol or isopropyl alcohol. The liquid may be distilled water, but is not limited thereto.

The conductive network 1200 may be formed by applying at least one of heat, pressure, or electron beams to the plurality of metal nanostructures 1210, or may be formed without applying the same to the plurality of metal nanostructures 1210.

The plurality of metal nanostructures 1210 may have different diameters. The plurality of metal nanostructures 1210 may have different aspect ratios. The average diameter of the plurality of metal nanostructures 1210 used to form the conductive network 1200 may be about 20 nm, but are not necessarily limited thereto. Most of the metal nanostructures 1210 may have a diameter of 10 nm to about 50 nm, the metal nanostructures 1210 may have a diameter of nm or less, and the metal nanostructures 1210 may have a diameter of 50 nm or more.

The height of the conductive network 1200 may be 20 nm. The height of the conductive network 1200 may be between 15 nm and 25 nm. The height of the conductive network 1200 may be between 10 nm and 50 nm. Alternatively, the height of the conductive network 1200 may be about 10 nm or less or about 50 nm or more.

The plurality of metal nanostructures 1210 may intersect with each other to form the conductive network 1200. Two metal nanostructures 1210 may be stacked on each other. Three metal nanostructures 1210 may be stacked on each other. Four metal nanostructures 1210 may be stacked on each other. The metal nanostructures 1210 may be in contact with each other, but the metal nanostructures 1210 may not be in contact with each other.

One to four metal nanostructures 1210 may be located in the cross section of the conductive network 12000. According to some embodiments, four or more metal nanostructures 1210 may be stacked in the cross section of the conductive network 1200. A gap may or may not exist between the stacked metal nanostructures 1210.

The height of the conductive network 1200 may be based on the number of stacked metal nanostructures 1210. When four metal nanostructures 1210 having a diameter of 10 to 50 nm are stacked, the height of the conductive network 1200 may be 40 to 200 nm. When four metal nanostructures 1210 having an average diameter of 20 nm are stacked, the height of the conductive network 1200 may be about 80 nm.

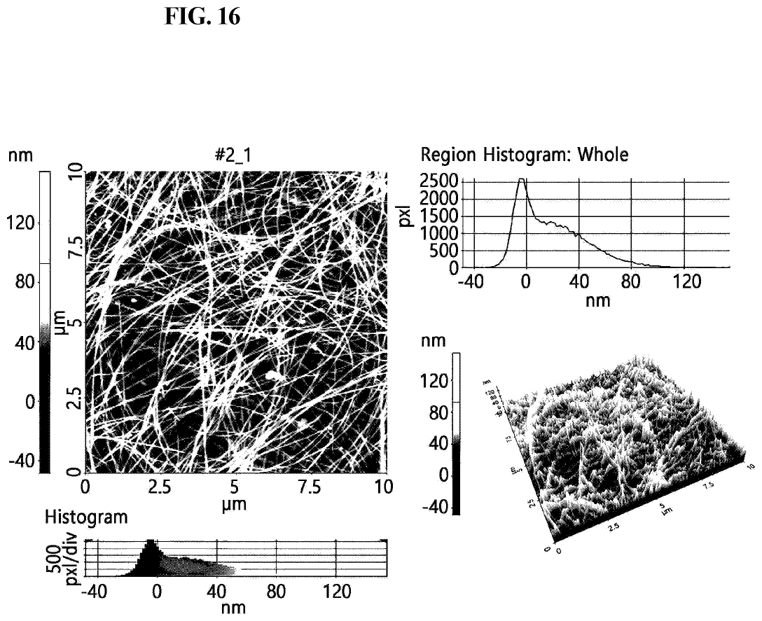

FIG. 16 illustrates an AFM measurement result of a conductive network on a transparent substrate. Referring to FIG. 16, the surface roughness of the conductive network 1200 may have a value between −40 nm and 160 nm. In this case, the height of the conductive network 1200 may be about 200 nm.

In view of the histogram distribution and the AFM photograph, the values between −40 nm and 10 nm in the measurement result may be erroneous ones measured due to the curvature of the transparent substrate 1100. The portion having the surface roughness of 10 nm may be the top surface of the transparent substrate 1100. The values of 100 nm or more in the measurement result may be erroneous ones measured due to light scattering or foreign matter.

In view of the erroneously measured ones, the surface roughness of the conductive network 1200 may be between 10 nm and 100 nm. When the top surface of the transparent substrate 1100 is 10 nm, the actual surface roughness of the conductive network 1200 may be between 0 nm and 90 nm. In view of the histogram distribution, the surface roughness in most regions of the conductive network 1200 may be between 10 nm and 40 nm. When the top surface of the transparent substrate 1100 is 10 nm, the actual surface roughness of the conductive network 1200 may be between 0 nm and 30 nm. Through this, it can be estimated that the height value in most of the regions of the conductive network 1200 is about 30 nm. It can be estimated that most of the regions of the conductive network 1200 have been formed by stacking one or two metal nanostructures 1210. It can be estimated that the height value in a partial region of the conductive network 1200 is about 90 nm. Through this, it can be estimated that a portion of the conductive network 1200 has been formed by two to four metal nanostructures 1210 stacked on each other.

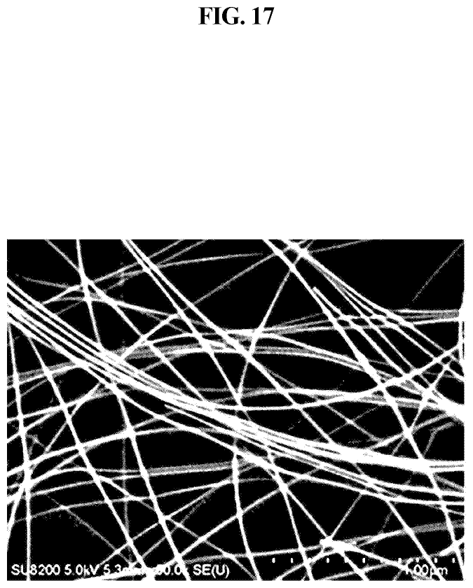

FIG. 17 is a front SEM photograph of the transparent heating film 1000 according to the third embodiment. The transparent heating film 1000 includes a transparent substrate 1100, a conductive network 1200, and an adhesive layer 1500. The conductive network 1200 of FIG. 17 is the same as the conductive network 1200 of FIG. 15. The conductive network 1200 may be buried in the adhesive layer 1500. The conductive network 1200 may be enclosed in the adhesive layer 1500. The conductive network 1200 may be embedded in the adhesive layer 1500. The surface identified through the front SEM photograph may be the surface of the adhesive layer 1500. Some of the metal nanostructures 1210 may protrude on the surface of the adhesive layer 1500. The adhesive layer 1500 may be formed of a resin, but is not limited thereto. The resin may be an epoxy resin or a urethane resin.

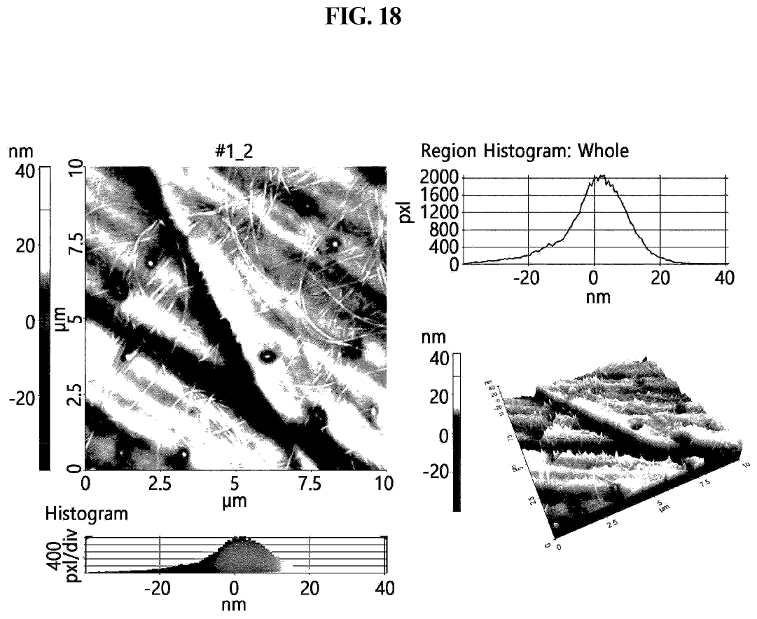

FIG. 18 shows an AFM measurement result of the transparent heating film of the third embodiment. This is a result obtained by measuring the surface of the transparent heating film 1000 of FIG. 17 using an AFM. Referring to FIG. 18, the surface of the adhesive layer 1500 may be rough. The rough surface of the adhesive layer 1500 may have been caused by the conductive network 1200. The rough surface of the adhesive layer 1500 may have been caused by the metal nanostructures 1210 protruding the adhesive layer.

Referring to FIG. 18, the conductive network 1500 may have surface roughness between −40 nm and 40 nm.

In view of the histogram distribution and the AFM photograph, the black-bordered white dots shown in FIG. 18 may have been caused by foreign matter or impurities. The curved portions shown in FIG. 18 may be the curved portions of the adhesive layer 1500. The portion having the surface roughness of 5 nm may be the top surface of the adhesive layer 1500. In the measurement result, the values of 25 nm or more may be erroneous ones measured due to light scattering or the flexure of the adhesive layer.

In view of the erroneously measured ones, the surface roughness of the adhesive layer 500 may be between 5 nm and 25 nm. When the surface roughness of the top surface of the transparent substrate 1100 is 5 nm, the actual surface roughness of the conductive network 1200 may be between 0 nm and 20 nm. In view of the histogram distribution and the fact that the average diameter of the metal nanostructures 1210 is 20 nm, one metal nanostructure 1210 may protrude from the surface of the adhesive layer 1500. A portion of the one metal nanostructure 1210 may protrude from the surface of the adhesive layer 1500.

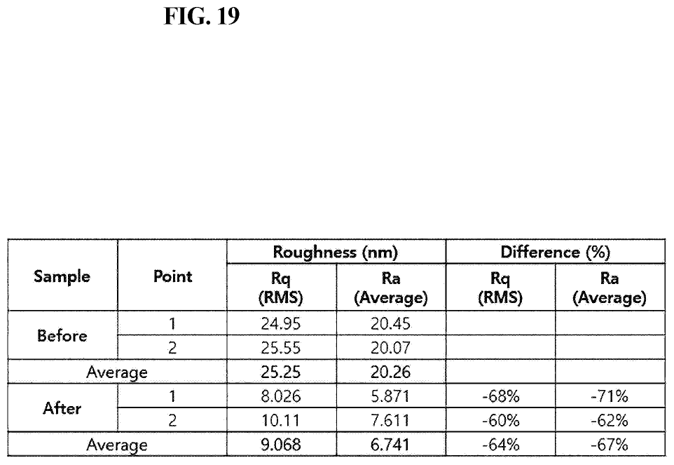

FIG. 19 is a table comparing AFM measurement results before and after formation of an adhesive layer. FIG. 19 is provided for confirming the surface roughness of the transparent heating film 1000 before and after forming the adhesive layer 1500.

The transparent heating film 1000 before forming the adhesive layer 1500 may include a transparent substrate 1100 and a conductive network 1200. The conductive network 1200 may be located on the transparent substrate 1100. The conductive network 1200 may include metal nanostructures 1210. With respect to the properties, materials, and shapes (diameter, etc.) of the metal nanostructure 1210, the foregoing description may be referred to. The transparent heating film 1000 before forming the adhesive layer 1500 may be in the state illustrated in FIGS. 15 and 16.

After forming the adhesive layer 1500, the transparent heating film 1000 may include a transparent substrate 1100, a conductive network 1200, and an adhesive layer 1500. The adhesive layer 1500 may be located on the transparent substrate 1100. The conductive network 1200 may be enclosed in the adhesive layer 1500.

The adhesive layer 1500 may be formed of a resin, but is not limited thereto. After forming the adhesive layer 1500, the transparent heating film 1000 may be in the state illustrated in FIGS. 17 and 18.

The “Before” measurement values in FIG. 19 may include the measurement values of FIG. 16. The “After” measurement values of FIG. 19 may include the measurement values of FIG. 18.

Referring to FIG. 19, the surface roughness, i.e., the height, of the conductive network 1200 before forming the adhesive layer 1500 may be about 20 nm. This is a value calculated based on an arithmetic mean (Ra). The surface roughness, i.e., the height, of the conductive network 1200 before forming the adhesive layer 1500 may be about 25 nm. This is a value calculated based on a root mean square (RMS). Through this, it can be seen that at least one metal nanostructure is located on the cross-section of the conductive network 1200.

Referring to FIG. 19, the surface roughness, i.e., the height, of the conductive network 1200 after forming the adhesive layer 1500 may be about 9 nm. This is a value calculated based on an arithmetic mean (Ra). The surface roughness, i.e., the height, of the conductive network 1200 after forming the adhesive layer 1500 may be about 7 nm. This is a value calculated based on a root mean square (RMS). Through this, it can be estimated that one metal nanostructure 1210 protrudes from the surface of the adhesive layer 1500. Through this, it can be estimated that the one metal nanostructure 1210 protrudes from the surface of the adhesive layer 1500 by half or less. When the average diameter of the metal nanostructures 1210 is 20 nm, the average value of the surface roughness of the adhesive layer 1500 may be 50% or less of the average diameter of the metal nanostructures 1210. When the average diameter of the metal nanostructures 1210 is 20 nm, the average value of the surface roughness of the adhesive layer 1500 may be between 45% and 34% of the average diameter of the metal nanostructures 1210.

When the diameter of the metal nanostructures 1210 is 10 nm, 9% to 33% of the metal nanostructure 1210 may be enclosed in the adhesive layer 1500. 91% to 67% of the metal nanostructures 1210 may be exposed to the outside of the adhesive layer 1500.

When the diameter of the metal nanostructures 1210 is 20 nm, 55% to 66% of the metal nanostructures 1210 may be enclosed in the adhesive layer 1500. 45% to 34% of the metal nanostructures 1210 may be exposed to the outside of the adhesive layer 1500.

When the diameter of the metal nanostructures 1210 is 30 nm, 70% to 78% of the metal nanostructures 1210 may be enclosed in the adhesive layer 1500. 30% to 22% of the metal nanostructures 1210 may be exposed to the outside of the adhesive layer 1500.

When the diameter of the metal nanostructures 1210 is 40 nm, 77% to 83% of the metal nanostructures 1210 may be enclosed in the adhesive layer 1500. 23% to 17% of the metal nanostructures 1210 may be exposed to the outside of the adhesive layer 1500.

When the diameter of the metal nanostructures 1210 is 50 nm, 82% to 87% of the metal nanostructures 1210 may be enclosed in the adhesive layer 1500. 18% to 13% of the metal nanostructures 1210 may be exposed to the outside of the adhesive layer 1500.

Since the conductive network 1200 is enclosed in the adhesive layer 1500, the transparent heating film 1000 may be improved in terms of surface roughness. By forming the adhesive layer 1500, the transparent heating film 1000 may be improved by 60% or more in terms of surface roughness. Through this, the transparent heating film 1000 may be improved in terms of haze. In addition, since most of the conductive network 1200 is enclosed in the adhesive layer 1500, long-term safety of the transparent heating film 1000 may be ensured.

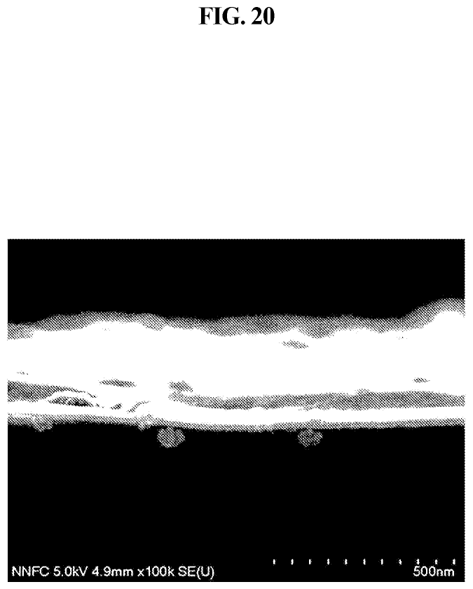

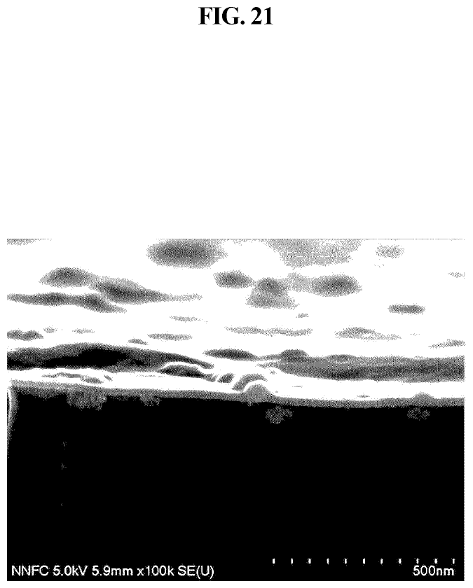

FIG. 20 is a cross-sectional SEM photograph of the transparent heating film of the third embodiment, and FIG. 21 is another cross-sectional SEM photograph of the transparent heating film of the third embodiment. The upper layer seen in the photographs of FIGS. 20 and 21 is a platinum (Pt) coating additionally applied for SEM measurement.

Referring to FIGS. 20 and 21, the transparent heating film 1000 includes a conductive network 1200 and an adhesive layer 1500. The conductive network 1200 may include a plurality of metal nanostructures 1210. With respect to the properties, materials, and shapes (diameter, etc.) of the metal nanostructure 1210, the foregoing description may be referred to. The adhesive layer 1500 may be formed of a resin, but is not limited thereto. The thickness of the adhesive layer 1500 may be between 10 μm and 20 μm.

Referring to the cross-sectional SEM photograph, the metal nanostructures 1210 are enclosed in the upper portion of the adhesive layer 1500. The cross sections of the metal nanostructures 1210 are observed in the cross section of the adhesive layer 1500. Referring to the scale at the lower end of the SEM photograph, the diameter of the metal nanostructure 1210 observed from the center of the cross section of the adhesive layer 1500 may be about 50 nm. The diameter of the metal nanostructure 1210 observed from the left side of the cross section of the adhesive layer 1500 may be about 20 nm. Through this, it can be seen that the diameters of respective metal nanostructures 1210 included in the conductive network 1200 are different from each other.

Referring to the cross-sectional SEM photograph, some of the metal nanostructures 1210 protrude above the adhesive layer 1500. It can be seen that the metal nanostructures 1210 observed from the left side of the cross section of the adhesive layer 1500 are located between the adhesive layer 1500 and the platinum coating. When analyzing the measurement result while ignoring the platinum coating, it can be seen that some of the metal nanostructures 1210 are exposed on the top surface of the adhesive layer 1500.

The top surface of the platinum coating also includes line shapes. The line shapes may correspond to those of metal nanostructures 1210 protruding above the top surface of the adhesive layer 1500. Through this, it can be estimated that some of the metal nanostructures 1210 are exposed on the top surface of the adhesive layer 1500. Alternatively, it can be estimated that the adhesive layer 1500 is partially convex due to the metal nanostructures 1210 enclosed in the adhesive layer 1500.

The metal nanostructures 1210 may have protrusions exposed to the outside of the adhesive layer 1500. The metal nanostructures 1210 may have enclosed portions buried in the adhesive layer 1500.

The metal nanostructures 1210 may come into contact with each other to form intersection points 1220. Some portions of the intersection points 1220 may be included in the protrusions. The other portions of the intersection points 1220 may be included in the enclosed portions.

A conductive member such as a bus bar 1300 may be formed in the upper portion of the adhesive layer 1500. When the metal nanostructures 1210 are exposed on the top surface of the adhesive layer 1500, the top surface of the transparent heating film 1000 may be conductive. The conductive member may come into contact with the protrusions of the metal nanostructures 1210. When the conductive member and the protrusions come into contact each other, electrical properties of the transparent heating film 1000 may be better than when the conductive member and the protrusions do not come into contact with each other.

Referring to the measurement results of FIGS. 15 to 21, it can be seen that the metal nanostructures 1210 are densely concentrated in the upper portion of the adhesive layer 1500 of the third embodiment, and some of the metal nanostructures 1210 are exposed to the top of the adhesive layer 1500.

The adhesive layer 1500 may include three spaces divided by planes parallel to the bottom surface 1120 of the transparent substrate 1100. The adhesive layer 1500 may include a fourth space 1510, a fifth space 1520, and a sixth space 1530. This may be explained with reference to FIGS. 10 and 11.

The fourth space 1510 is defined as a region in which the metal nanostructures 1210 do not exist, the fifth space 1520 is defined as a region in which only one ends of the metal nanostructures 1210 are included, and the sixth space 1530 may be defined as a region in which including both ends of the metal nanostructures 1210 are included.

The sixth space 1530 may be a space ranging from 30 nm to 90 nm from the top surface of the adhesive layer 1500. The fifth space 1520 may be a space excluding the sixth space 1530 in the space from the top surface of the adhesive layer 1500 to 200 nm. The fourth space 1510 may be a space excluding the fifth space 1520 and the sixth space 1530 in the entire adhesive layer 1500. The fourth space 1510 may be most of the space of the adhesive layer 1500.

The sixth space 1530 may be a space from the top surface of the adhesive layer 1500 to 80 nm. The fifth space 1520 may be a space from the top surface of the adhesive layer 1500 to 80 nm to 200 nm. The fourth space 1510 may be a space from a plane spaced apart 200 nm from the top surface 1500 to the bottom surface of the adhesive layer 1500.

The thickness of the sixth space 1530 may be 80 nm. The thickness of the fifth space 1520 may be 120 nm. The thickness of the fourth space 1510 may be similar to the thickness of the adhesive layer 1500.

The ratios occupied by the fourth space 1510, the fifth space 1520, and the sixth space 1530 in the adhesive layer 1500 may vary depending on the thickness of the adhesive layer 1500.

When the thickness of the adhesive layer 1500 is 10 μm, the ratios occupied by the fourth space 1510, the fifth space 1520, and the sixth space 1530 may be 98%, 1.2%, and 0.8%, respectively.

When the thickness of the adhesive layer 1500 is 20 μm, the ratios occupied by the fourth space 1510, the fifth space 1520, and the sixth space 1530 may be 99%, 0.6%, and 0.4%, respectively.

The ratio occupied by the fourth space 1510 in the adhesive layer 1500 may be 0.4% to 0.8%. The ratio occupied by the fifth space 1520 in the adhesive layer 1500 may be 0.6% to 1.2%.

By forming the adhesive layer 1500 to be sufficiently thicker than the diameters of the metal nanostructures 1210, the conductive network 1200 may be protected from external environments such as moisture and air. By forming the fourth space 1510 to be sufficiently thicker than the diameters of the metal nanostructures 1210, the conductive network 1200 may be well fixed to the transparent substrate 1100. Through this, the structural safety of the transparent heating film 1000 can be secured. By forming the sixth space 1530 thinner than the fourth space 1510, the metal nanostructures 1210 may be located close to each other. Through this, a current transferred from the separate conductive member located on the top surface of the sixth space 1530 may quickly flow to the conductive network 1220. Through this, the electrical characteristics of the transparent heating film 1000 can be further improved.

### 5. Fifth Embodiment

5.1 Transparent Heating Film

Meanwhile, conductive heating elements for generating heat by applying a voltage include a metal material. Therefore, conventional conductive heating elements have a problem of interfering with communication inside and outside a target member after the conductive heating elements are attached to the target member. In order to solve this problem, some of the conventional conductive heating elements are also provided with a communication window for receiving electromagnetic waves, wherein the communication window is formed by removing a portion of a conductive network or conductive layer. However, forming the communication window on the conductive layer or the conductive network is not only complicated in design of the heating element. Furthermore, it is difficult for the conductive heating element including the communication window to secure uniform heating characteristics due to the non-uniform shape of the conductive layer or conductive network.

The transparent heating film according to embodiments to be described below may further include an antenna, thereby suppressing fogging or frosting of the target member, while ensuring smooth transmission/reception of electromagnetic waves inside and outside the target member.

Hereinafter, a transparent heating film according to a fifth embodiment will be described.

The transparent heating film according to the fifth embodiment is distinguished from the above-described embodiments in that it includes an antenna 1600 for receiving electromagnetic waves. It may be described that the transparent heating film according to the fifth embodiment are the same as those of the above-described embodiments, except that it further includes an antenna. Accordingly, in the description of the fifth embodiment, the same reference numerals are assigned to the components common to the above-described embodiments, and detailed descriptions thereof are omitted.

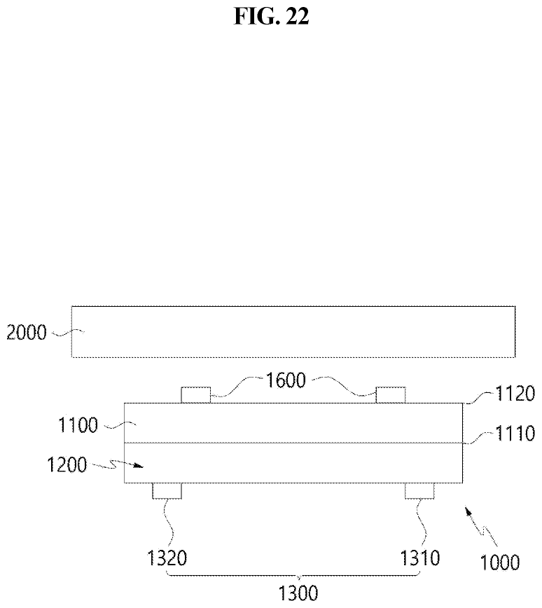

FIG. 22 is a cross-sectional view of a transparent heating film according to a fifth embodiment.

Referring to FIG. 22, the transparent heating film 1000 according to the fifth embodiment may be installed on a target member 2000. It may be described that the target member 2000 is the same as the target members of the above-described embodiments.

The transparent heating film 1000 according to the fifth embodiment includes a transparent substrate 1100, a conductive network 1200, a bus bar 1300, and an antenna 1600. The transparent heating film 1000 may be installed on a target member 2000. The transparent heating film 1000 may be installed in an enclosed space. When the target member 2000 is a window of a vehicle, the transparent heating film 1000 may be installed inside the vehicle with respect to the target member 2000.

The conductive network 1200, the bus bar 1300, and the antenna 1600 may be installed on the transparent substrate 1100. The transparent substrate 1100 may serve as a substrate for maintaining the positions of the conductive network 1200, the bus bar 1300, and the antenna 1600. The transparent substrate 1100 includes a first surface 1110 and a second surface 1120 located in a direction opposite to the first surface. The second surface 1120 may be located closer to the target member 2000 than the first surface 1110, and the first surface 1110 may be located farther away from the target member 2000 than the second surface 1120. That is, the distance between the target member 2000 and the first surface 1110 may be equal to the sum of the distance between the target member 2000 and the second surface 1100 and the distance between the first surface 1110 and the second surface 1120.

When the target member 2000 is located between an enclosed space and the external space, the first surface 1110 may be located to face the enclosed space with reference to the transparent substrate 1100, and the second surface 1120 may be located to face the external space with reference to the transparent substrate 1100. Accordingly, when the target member 2000 is a window of a vehicle, the first surface 1110 may be located inside the vehicle with reference to the transparent substrate 1100, and the second surface 1120 may be located outside the vehicle with reference to the transparent substrate 1100.

The conductive network 1200 may be located on the first surface 1110 of the transparent substrate 1100. The conductive network 1200 may be located farther away from the target member 2000 than the transparent substrate 1100. When the target member 2000 is located between the enclosed space and the external space, the conductive network 1200 may be located to face the enclosed space with reference to the transparent substrate 1100. When the target member 2000 is a window of a vehicle, the conductive network 1200 may be located inside the vehicle with reference to the transparent substrate 1100.

When electromagnetic waves are incident toward the conductive network 1200, the conductive network 1200 may block signals in a specific frequency region. The intensity of electromagnetic waves passing through the conductive network 1200 may be smaller than that before passing through the conductive network 1200.

The bus bar 1300 may be located on the conductive network 1200. The bus bar 1300 may be located closer to the first surface 1110 than the second surface 1120 of the transparent substrate 1100. The bus bar 1300 may be located farther away from the target member 2000 than the transparent substrate 1100 and the conductive network 1200. When the target member 2000 is located between the enclosed space and the external space, the bus bar 1200 may be located to face the enclosed space with reference to the transparent substrate 1100. When the target member 2000 is a window of a vehicle, the bus bar 1300 may be located inside the vehicle with reference to the transparent substrate 1100.

There may be a plurality of bus bars 1300. The bus bars 1300 may include a first bus bar 1310 and a second bus bar 1320. The first bus bar 1310 and the second bus bar 1320 may be formed to be spaced apart from each other. The first bus bar 1310 and the second bus bar 1320 may be located at different edges. That is, the first bus bar 1310 may be located along one of the edges of the conductive network 1200, and the second bus bar 1320 may be located along another one of the edges of the conductive network 1200. The first bus bar 1310 and the second bus bar 1320 may face each other or may be parallel to each other.

The antenna 1600 may be installed on the transparent substrate 1100. The antenna 1600 may be located on one surface of the transparent substrate 1100. The antenna 1600 may be located on the second surface 1120 of the transparent substrate 1100. The antenna 1600 may be located in a direction opposite to the conductive network 1200 with reference to the transparent substrate 1100. The antenna 1600 may be located closer to the target member 2000 than the transparent substrate 1100 and the conductive network 1200. When the target member 2000 is located between the enclosed space and the external space, the antenna 1600 may be located to face the external space with reference to the transparent substrate 1100. When the target member 2000 is a window of a vehicle, the antenna 1600 may be located outside the vehicle with reference to the transparent substrate 1100. That is, the conductive network 1200 and the bus bar 1300 may be located on the first surface 1110 of the transparent substrate 1100, and the antenna 1600 may be located on the second surface 1120 of the transparent substrate 1100. When the antenna 1600 is located to face the external space, it is possible for the antenna 1600 to receive electromagnetic waves incident from the outside earlier than the conductive network 1200, and it is possible for the antenna 1600 to receive electromagnetic waves incident from the outside before electromagnetic waves are blocked by the conductive network 1200.

In addition, when the antenna 1600 is formed in a direction opposite to the conductive network 1200, the conductive network 1200 may not need to include the communication window. Accordingly, in the transparent heating film 1000 of the fifth embodiment, the shape of the conductive network 1200 may be freely formed, and there is no need to separately provide an opening for communication. Therefore, the manufacturing process can be simplified. When the transparent heating film 1000 is manufactured as a heating element, by simplifying the shape of the conductive network 1200, the transparent heating film 1000 can be heated more uniformly than the conventional heating element. In addition, by preventing local heating, the occurrence of so-called hot spots can be prevented.

The antenna 1600 may be located on at least a partial region of the second surface 1120 of the transparent substrate 1100. The antenna 1600 may correspond to a portion of the conductive network 1200. The antenna 1600 may or may not correspond to the bus bar 1300.

The antenna 1600 may be used for efficiently emitting electromagnetic waves in a space or for receiving electromagnetic waves from a space in order to achieve the purpose of communication in wireless communication. The antenna 1600 may be used for receiving a signal in a specific frequency region.

The antenna 1600 may have various shapes such as a square pillar, a cylinder, and a cone, and may be flat or elongated. When the thickness or width of the antenna 1600 is small, the antenna 1600 may be in the form of a line, and when the length of the antenna 1600 is long, a pattern may be formed. Alternatively, the antenna 1600 may be a group connected by a plurality of metal nanostructures. The antenna 1600 may further have various other shapes and structures.

There may be a plurality of antennas 1600. When there are a plurality of antennas 1600, each of the antennas 1600 may absorb and receive signals of different frequency regions. The length and shape of the antenna 1600 may vary depending on the frequency. The length of the antenna 1600 may be inversely proportional to the frequency. That is, the length of an antenna that absorbs a signal in a high frequency region may be shorter than the length of an antenna that absorbs a signal in a low frequency region.

The antenna 1600 may be formed to be transparent or may be formed to be opaque. When the antenna 1600 is formed to be transparent, the antenna 1600 may include the same material as the conductive network 1200. When the antenna 1600 is formed to be opaque, the antenna 1600 may include the same material as the bus bar 1300. When the antenna 1600 is formed to be transparent, the light transmittance of the antenna 1600 may be lower than that of the conductive network 1200.

The antenna 1600 may include a conductive material such as metal. Accordingly, the antenna 1600 may have electrical conductivity, and the antenna 1600 may provide a passage for electrons to move. The sheet resistance value of the antenna 1600 may be smaller than the sheet resistance value of the conductive network 1200.

The antenna 1600 may not be in contact with the conductive network 1200 and the bus bar 1300. The antenna 1600 may be electrically insulated from the conductive network 1200. The antenna 1600 may be electrically insulated from the conductive network 1200 by the transparent substrate 1100. That is, the antenna 1600 and the conductive network 1200 may be electrically insulated by being located on different layers. When the antenna 1600 is located on a different layer from the conductive network 1200, the electrical connection between the antenna 1600 and the conductive network 1200 may be simplified compared to the case in which the antenna 1600 and the conductive network 1200 are located on the same layer. In addition, the antenna 1600 may receive a signal of a specific frequency region earlier than the conductive network 1200, and the antenna 1600 may receive and absorb a signal of a specific frequency region while minimizing the influence of the conductive network 1200.

When electromagnetic waves are incident toward the antenna 1600, the antenna 1600 may absorb and receive a signal in a specific frequency region, and the intensity of the electromagnetic waves passing through the antenna 1600 may decrease. When electromagnetic waves are incident toward the conductive network 1200, the conductive network 1200 may block signals in a specific frequency region. Accordingly, the antenna 1600 may absorb and receive a signal in a specific frequency region better than the conductive network 1200.

A signal of a specific frequency region absorbed and received by the antenna 1600 may not be transmitted to the transparent substrate 1100, the conductive network 1200, and the bus bar 1300. A signal of a specific frequency region absorbed and received by the antenna 1600 may be transmitted to a separate device and radiated to the space. The separate device may amplify a signal in a specific frequency region. When there is an electronic device capable of receiving electromagnetic waves in the space, the electronic device may receive an amplified electromagnetic wave signal.

When there is a conductor other than the antenna 1600 in the path through which electromagnetic waves are incident to the antenna 1600 while the electromagnetic waves are incident toward the antenna 1600, the antenna 1600 may not be able to receive a signal of a specific frequency region included in the electromagnetic waves.

The antenna 1600 may conduct heat.

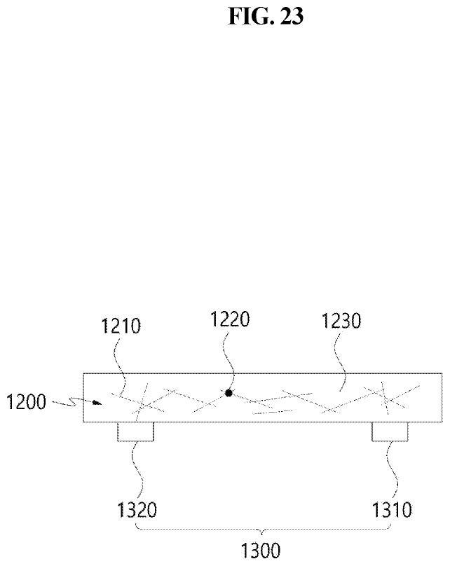

FIG. 23 is a view illustrating the conductive layer of the transparent heating film according to the fifth embodiment in detail. Here, the conductive layer (not illustrated) refers to a layer of the transparent heating film including the conductive network 1200, and may include only the conductive network 1200 or may include the conductive network 1200 and a matrix 1230 to be described later. In this case, the matrix 1230 may be at least a portion of the coating layer 1400 or the adhesive layer 1500 of the first to fourth embodiments.

As illustrated in FIG. 23, the conductive layer may include a conductive network 1200 and a matrix 1230. The conductive network 1200 includes a metal nanostructure 1210 and an intersection point 1220, and the bus bar 1300 may be located adjacent to the conductive network 1200.

The metal nanostructures 1210 may be located inside the conductive layer. The metal nanostructures 1210 may be non-uniformly or irregularly located inside the conductive layer. The metal nanostructures 1210 may be located at irregular intervals within the conductive layer. Another material may be filled between the metal nanostructures 1210 located at intervals. The matrix 1230 may be filled between the metal nanostructures 1210 located at intervals. The metal nanostructures 1210 may be sparsely located inside the conductive layer, and the metal nanostructures 1210 may partially occupy the inside of the conductive layer.

The metal nanostructures 1210 may be densely concentrated inside the conductive layer at a position close to the transparent substrate 1100, or may be densely concentrated inside the conductive layer at a position far from the transparent substrate 1100. Some of the metal nanostructures 1210 may be located on the surface of the conductive layer or may protrude to the outside of the conductive layer. One surface of the conductive layer including the metal nanostructures 1210 may be flat or curved.

The intersection points 1220 may be formed by the metal nanostructures 1210 that intersect with each other. Some of the metal nanostructures 1210 or the matrix 1230 may be located between the intersection points 1220 located at intervals.

The intersection points 1220 may be densely concentrated inside the conductive layer at a position close to the transparent substrate 1100, or may be densely concentrated inside the conductive layer at a position far from the transparent substrate 1100. Some of the intersection points 1220 may be located on the surface of the conductive layer or may protrude to the outside of the conductive layer. One surface of the conductive layer including the intersection points 1220 may be flat or curved.

The intersection points 1220 may be located on the metal nanostructures 1210. The intersection points 1220 may be located at opposite ends of the metal nanostructures 1210, or may be located at positions other than the opposite ends. The intersection points 1220 may be portions of the metal nanostructures 1210.

The matrix 1230 may be a material filling the conductive network 1200. The matrix 1230 may be in contact with the metal nanostructures 1210. The matrix 1230 may be in contact with the intersection points 1220. The matrix 1230 may be located between the metal nanostructures 1210. The matrix 1230 may be located between the intersection points 1220. The matrix 1230 may be located between the metal nanostructures 1210 and the intersection points 1220.

The sum of the spaces occupied by the matrix 1230 and the spaces occupied by the metal nanostructures 1210 may be the space of the conductive layer. In the conductive layer, the space occupied by the matrix 1230 may be greater than the space occupied by the metal nanostructures 1210. The matrix 1230 may take up or occupy most of the conductive layer.

The bus bar 1300 may be electrically connected to at least one metal nanostructure 1210. When a voltage is applied to the bus bar 1300, electrons may be transferred from the bus bar 1300 to the metal nanostructures 1210 connected to the bus bar 1300, and the transferred electrons may move to other metal nanostructures 1210 via one or more intersection points 1220. The electrons may move in a direction away from the bus bar 1300.

The first bus bar 1310 may be electrically connected to at least one metal nanostructure 1210, and the second bus bar 1320 may be electrically connected to at least one metal nanostructure 1210. Between the first bus bar 1310 and the second bus bar 1320, there may be a plurality of metal nanostructures 1210 and a plurality of intersection points 1220 formed by the plurality of metal nanostructures 1210 which intersect with each other.

When a voltage is applied to the first bus bar 1310, electrons may be transferred from the first bus bar 1310 to the metal nanostructures 1210 connected to the first bus bar 1310. The transferred electrons may move to the second bus bar 1320 through the metal nanostructures 1210 connected to the second bar 1320 via at least one intersection point 1220 located between the first bus bar 1310 and the second bus bar 1320.

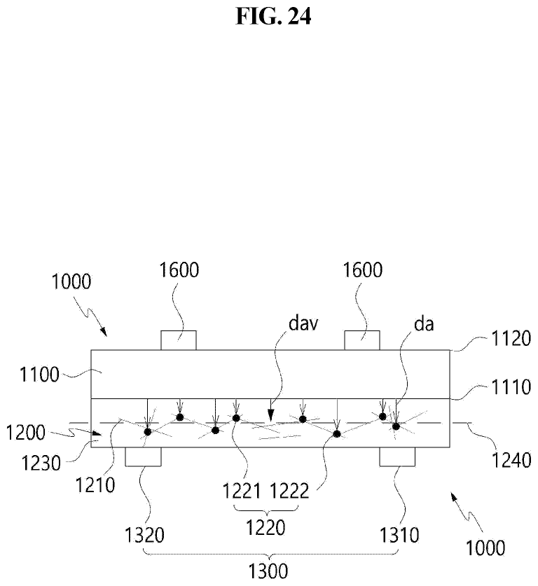

FIG. 24 is another view illustrating the conductive layer of the transparent heating film according to the fifth embodiment in detail. Referring to FIG. 24, the conductive network 1200 includes intersection points 1220 and an electron movement plane 1240. The intersection points 1220 may include upper intersection points 1221 and lower intersection points 1222.

The intersection points 1220 may have a distance from the transparent substrate 1100. The intersection points 1220 may have a distance from the first surface 1110 of the transparent substrate 1100. The distance between each of the intersection points 1220 and the first surface 1110 of the transparent substrate 1100 may be defined as da. The distances da between respective intersection points 1220 and the first surface 1110 may be different from each other. The average value of the distances da between respective intersection points 1220 and the first surface 1100 may be defined as day.

The electron movement plane 1240 may be located inside a space defined from the conductive layer or conductive network 1200 (hereinafter, referred to as the “space of the conductive network 1200”). The electron movement plane 1240 may be a plane parallel to the transparent substrate 1100. The electron movement plane 1240 may be a plane having a predetermined distance from one surface of the transparent substrate 1100. The electron movement plane 1240 may be a plane having a predetermined distance from the first surface 1110 of the transparent substrate 1100. The distance between the electron movement plane 1240 and the first surface 1110 of the transparent substrate 1100 may be defined as the average distance dav between respective intersection points 1220 and the first surface 1100.

The electron movement plane 1240 may be one of planes located inside space of the conductive layer or the conductive network 1200. Respective intersection points 1220 may have different distances to an arbitrary plane located inside the space defined from the conductive layer or conductive network 1200.

The electron movement plane 1240 may be a plane in which the sum of distances to respective intersection points 1220 is the smallest among the planes located inside the space of the conductive network 1200. The electron movement plane 1240 may be a plane in which the average value of distances to respective intersection points 1220 is the smallest among the planes located inside the space of the conductive network 1200. The electron movement plane 1240 may be a plane in which the standard deviation of distances to respective intersection points 1220 is the smallest among the planes located inside the space of the conductive network 1200. The electron movement plane 1240 may be located in the space in which the intersection points 1220 are most densely concentrated in the space of the conductive network 1200.

The electron movement plane 1240 may be a plane through which the metal nanowires 1210 pass. The electron movement plane 1240 may be a plane on which the intersection points 1220 are located. A path through which electrons transferred to the conductive network 1200 move inside the conductive network 1200 may intersect with the electron movement plane 1240. Among the planes located inside the conductive network 1200, the electron movement plane 1240 may be a plane that most frequently intersects with paths through which electrons transferred to the conductive network 1200 move inside the conductive network 1200. The electron movement plane 1240 may provide a passage for electrons to move. The electron movement plane 1240 may be a passage for electrons to move most frequently. The electron movement plane 1240 may be a main passage for electrons to move. Electrons transferred to the metal nanostructures 1210 connected to the bus bar 1300 when a voltage is applied to the bus bar 1300 may move away from the bus bar 1300 via the electron movement plane 1240. The electrons transferred to the metal nanostructures 1210 connected to the first bus bar 1310 when a voltage is applied to the first bus bar 1310 may move to the second bus bar 1320 through the metal nanostructures 1210 connected to the second bar 1320 via the electron movement plane 1240.

The upper intersection points 1221 may be located between the electron movement plane 1240 and the transparent substrate 1100. The upper intersection points 1221 may be located between the electron movement plane 1240 and the first surface 1110 of the transparent substrate 1100. The distance da between the upper intersection points 1221 and the first surface 1100 may be smaller than the average distance dav between respective intersection points 1220 and the first surface 1100. The distance da between the upper intersection points 1221 and the first surface 1100 may have a negative deviation with respect to the average distance dav between respective intersection points 1220 and the first surface 1100. When the distance da between the upper intersections 1221 and the first surface 1100 is defined as da1, the expressions, such as da1<dav and da1−dav<0, are satisfied.

The lower intersection points 1222 may be located between the electron movement plane 1240 and the bus bar 1300. The distance da between the lower intersection points 1221 and the first surface 1100 may be greater than the average distance dav between respective intersection points 1220 and the first surface 1100. The distance da between the lower intersection points 1221 and the first surface 1100 may have a positive deviation with respect to the average distance dav between respective intersection points 1220 and the first surface 1100. When the distance da between the lower intersection points 1222 and the first surface 1100 is defined as da2, expressions such as da2>dav and da2−dav>0 are satisfied.

The upper intersection points 1221 and the lower intersection points 1222 may provide a passage for electrons to move. Electrons transferred to the metal nanostructures 1210 connected to the bus bar 1300 when a voltage is applied to the bus bar 1300 may move to the upper intersection points 1221 through the electron movement plane 1240 via the lower intersection points 1222.

The average value of the distances da between the upper intersection points 1221 and the lower intersection points 1222 and the first surface 1100 may be the same as the average distance dav between respective intersections 1220 and the first surface 1100. The distance value of the upper intersection points 1221 with respect to the electron movement plane 1240 may be equal to da1−dav, and the distance value of the lower intersection points 1222 with respect to the electron movement plane 1240 may be equal to da2−dav. Accordingly, the sum of the distance value da1−dav of all the upper intersection points 1221 with respect to the electron movement plane 1240 and the distance value da2−dav of all the lower intersection points 1222 with respect to the electron movement plane 1240 is 0.

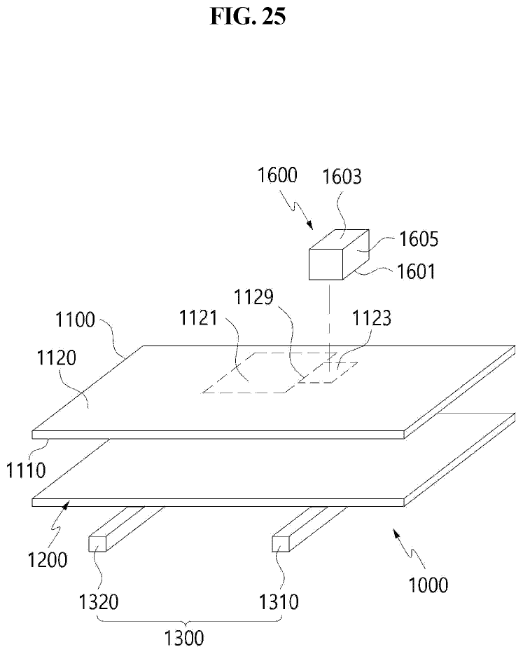

FIG. 25 is an exploded perspective view of the transparent heating film according to the fifth embodiment. Referring to FIG. 25, the antenna 1600 includes a third surface 1601, a fourth surface 1603, and an antenna side-surface 1605. The second surface 1120 of the transparent substrate 1100 includes a first surface portion 1121, a second surface portion 1123, and a boundary line 1129.

The third surface 1601 may be one surface of the antenna 1600. The third surface 1601 may be located adjacent to the transparent substrate 1100. The third surface 1601 may be located adjacent to the second surface 1120 of the transparent substrate 1100. The third surface 1601 may be parallel to the transparent substrate 1100. The third surface 1601 may be parallel to the first surface 1110 and the second surface 1120. The third surface 1601 may be a contact surface between the second surface 1120 of the transparent substrate 1100 and the antenna 1600.

The fourth surface 1603 may be one surface of the antenna 1600. The fourth surface 1603 may be located in a direction opposite to the third surface 1601. The fourth surface 1603 may face the third surface 1601. The fourth surface 1603 may be parallel to the transparent substrate 1100. The fourth surface 1603 may be parallel to the first surface 1110 and the second surface 1120. The fourth surface 1603 may be a surface located farthest from the transparent substrate 1100 among the plurality of surfaces of the antenna 1600. The fourth surface 1603 may be a surface located closest to the target member 2000 among the plurality of surfaces of the antenna 1600. The fourth surface 1603 may be a surface that absorbs and receives an electromagnetic wave signal.

The antenna side-surface 1605 may be a surface interconnecting the third surface 1601 and the fourth surface 1603 of the antenna 1600. The antenna side-surface 1605 may share an edge with the third surface 1601 and the fourth surface 1603 of the antenna 1600. The antenna side-surface 1605 may not be parallel to, but orthogonal to the third surface 1601 and the fourth surface 1603 of the antenna 1600. The side surface of the antenna 1605 may not be parallel to, but orthogonal to the transparent substrate 1100. The antenna side-surface 1605 may not be parallel to, but orthogonal to the first surface 1110 and the second surface 1120. The side surface of the antenna 1605 may be a surface that absorbs and receives an electromagnetic wave signal.

Meanwhile, as illustrated in FIG. 25, the shape of the antenna 1600 may have a polyhedral shape, or may have a shape different from the polyhedral shape. When the antenna 1600 does not have a polyhedral shape, the third surface 1601, the fourth surface 1603, and the antenna side-surface 1605 may be described based on an imaginary polyhedral shape defined from the three-dimensional shape of the antenna 1600.

The first surface portion 1121 may be a portion of the second surface 1120 of the transparent substrate 1100. The first surface portion 1121 may be located at the center or an edge of the second surface 1120. The first surface portion 1121 may be located on the transparent substrate 1100 in the direction toward the target member 2000. The first surface portion 1121 may be a surface that does not correspond to the antenna 1600.

The first surface portion 1121 may be located to be spaced apart from the antenna 1600. The first surface portion 1121 may be spaced apart from the third surface 1601 of the antenna 1600. The first surface portion 1121 may correspond to a portion of the conductive network 1200. The first surface portion 1121 may correspond to a portion of the electron movement plane 1240.

The size of the area of the first surface portion 1121 may vary. The first surface portion 1121 may transmit light and electromagnetic waves and transfer heat. The first surface portion 1121 may be flat. The first surface portion 1121 may be curved along a target member 2000.

The first surface portion 1121 may be a surface that provides a field of view to the user. The first surface portion 1121 may be a surface on which the user's gaze stays most frequently. The first surface portion 1121 may be a surface on which the user's gaze is concentrated. The user may identify an object beyond the target member 2000 through the first surface portion 1121. When the target member 2000 is a window of a vehicle, the first surface portion 1121 may be a surface that provides a field of view outside the vehicle to the driver inside the vehicle. The driver inside the vehicle may identify an external object beyond the target member 2000 through the first surface portion 1121.

The second surface portion 1123 may be a portion of the second surface 1120 of the transparent substrate 1100. The second surface portion 1123 may be located to correspond to the antenna 1600. The second surface portion 1123 may be located adjacent to the third surface 1601 of the antenna 1600, and the second surface portion 1123 may be parallel to the third surface 1601. The second surface portion 1123 may be located adjacent to the fourth surface 1603 of the antenna 1600, and the second surface portion 1123 may be parallel to the fourth surface 1603. The second surface portion 1123 may correspond to a portion of the conductive network 1200. The second surface portion 1123 may correspond to a portion of the electron movement plane 1240.

The second surface portion 1123 may be a surface other than the first surface portion 1121. The second surface portion 1123 may not overlap the first surface portion 1121. The second surface portion 1123 may or may not be in contact with the first surface portion 1121. When the first surface portion 1121 and the second surface portion 1123 are in contact with each other, the first surface portion 1121 and the second surface portion 1123 may share an edge.

The shape and size of the second surface portion 1123 may vary, but the area of the second surface portion 1123 may be the same as or smaller than the area of the third surface 1601 of the antenna 1600.

The second surface portion 1123 may transmit light and electromagnetic waves and transfer heat. A signal of a specific frequency may not be transmitted through the second surface portion 1123. A signal of a specific frequency region absorbed and received by the antenna 1600 may not be transmitted through the second surface portion 1123.

The boundary line 1129 may be defined as a line shared by the first surface portion 1121 and the second surface portion 1123 when the first and second surfaces are in contact with each other. The shape or length of the boundary line 1129 may be determined according to the first surface portion 1121 and the second surface portion 1123. The boundary line 1129 may have a straight shape, a bent shape, a closed shape, and other various shapes.

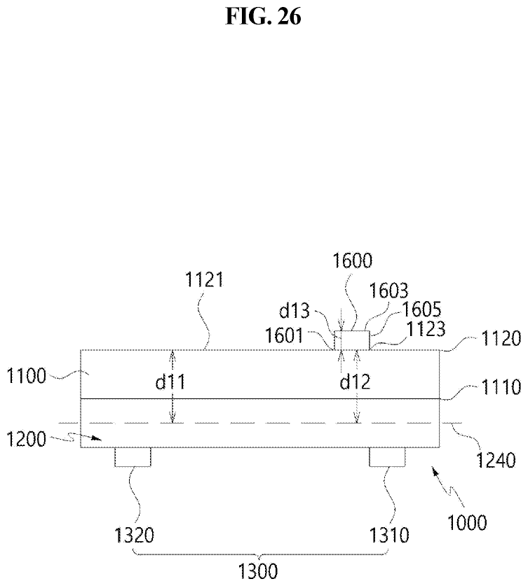

FIG. 26 is another cross-sectional view of the transparent heating film according to the fifth embodiment. Referring to FIG. 26, a first linear distance d11, a second linear distance d12, and a third linear distance d13 are indicated.

The first linear distance d11 may be defined as a distance between the electron movement plane 1240 and the first surface portion 1121, and the second linear distance d12 may be defined as the distance between the electron movement plane 1240 and the first surface portion 1121. The third linear distance d13 may be defined as a distance between the third surface 1601 and the fourth surface 1603 of the antenna 1600.

The first linear distance d11 may be the same as the second linear distance d12. In this case, the antenna 1600 may not be partially buried, enclosed, nor embedded in the transparent substrate 1100. When the first linear distance d11 is equal to the second linear distance d12, the first surface portion 1121 and the second surface portion 1123 may be located on the same plane. The second surface 1120 of the transparent substrate 1100 may be flat. The first surface portion 1121 and the third surface 1601 of the antenna 1600 may be parallel to each other and may be located above and below the same plane. The first surface portion 1121 and the fourth surface 1603 of the antenna 1600 may be parallel to each other.

When the first linear distance d11 is equal to the second linear distance d12, the first surface portion 1121 and the second surface portion 1123 may be located at the same distance from the electron movement plane 1240. The first surface portion 1121 and the second surface portion 1123 may be located at the same distance from the first surface 1110 of the transparent substrate 1100. The first surface portion 1121 and the second surface portion 1123 may be located at the same distance from the target member 2000. The distances of the first surface portion 1121 and the second surface portion 1123 from the target member 2000 may be different from each other depending on an installation type. In this case, the first linear distance d11 may be smaller than the sum of the second linear distance d12 and the third linear distance d13.

The antenna 1600 may be formed on or attached to the transparent substrate 1100 using a separate member providing an adhesive force, or may be formed on or attached to the transparent substrate 1100 by applying heat or pressure. The antenna 1600 may be formed on or attached to the transparent substrate 1100 using a method different from the above-described methods. In the process in which the antenna 1600 is formed on or attached to the transparent substrate 1100, the antenna 1600 and the transparent substrate 1100 may be heated or pressed. The heat or pressure applied to the transparent substrate 1100 may be transmitted from the antenna 1600. The antenna 1600 may not deform nor dent the transparent substrate 1100. The antenna 1600 may not deform nor dent the second surface 1120 of the transparent substrate 1100. The antenna 1600 may not deform nor dent a portion adjacent to the transparent substrate 1100. The antenna 1600 may not deform nor dent the second surface 1120 and the periphery of the second surface 1120. When the antenna 1600 does not deform nor dent the transparent substrate 1100, the first linear distance d11 may be the same as the second linear distance d12.

The first linear distance d11 may be greater than the second linear distance d12. At this time, the antenna 1600 may not be completely buried, enclosed, nor embedded in the transparent substrate 1100, and the antenna 1600 may be partially buried, enclosed, or embedded in the transparent substrate 1100. When the first linear distance d11 is greater than the second linear distance d12, the first surface portion 1121 and the second surface portion 1123 may not be located on the same plane. The second surface 1120 of the transparent substrate 1100 may not be flat. The first surface portion 1121 and the third surface 1601 and the fourth surface 1603 of the antenna 1600 may be parallel to each other, but may not share the same plane. When the first linear distance d11 is greater than the second linear distance d12, the first surface portion 1121 may be located farther from the electron movement plane 1240 than the second surface portion 1123. The first surface portion 1121 may be located farther from the first surface 1110 of the transparent substrate 1100 than the second surface portion 1123. The first surface portion 1121 may be located closer to the target member 2000 than the second surface portion 1123. That is, the distance between the first surface portion 1121 and the target member 2000 may be smaller than the distance between the second surface portion 1123 and the target member 2000. In this case, the first linear distance d11 may be smaller than the sum of the second linear distance d12 and the third linear distance d13.

In the process in which the antenna 1600 is formed on or attached to the transparent substrate 1100, the antenna 1600 may partially deform or dent the transparent substrate 1100. The antenna 1600 may deform or dent the second surface 1120 of the transparent substrate 1100. The antenna 1600 may deform or dent a portion adjacent to the transparent substrate 1100. The antenna 1600 may deform or dent the second surface 1120 and the periphery of the second surface 1120. When the antenna 1600 deforms or dents the transparent substrate 1100, the first linear distance d11 may be greater than the second linear distance d12.

As described above, the first linear distance d11 may be smaller than the sum of the second linear distance d12 and the third linear distance d13. At this time, the antenna 1600 may not be completely buried, enclosed, nor embedded in the transparent substrate 1100, and the antenna 1600 may be partially buried, enclosed, or embedded in the transparent substrate 1100. In addition, the antenna 1600 may not be partially buried, enclosed, nor embedded in the transparent substrate 1100.

The first linear distance d11 may not be equal to nor greater than the sum of the second linear distance d12 and the third linear distance d13. Accordingly, the antenna 1600 may not be completely buried, enclosed, nor enclosed in the transparent substrate 1100.

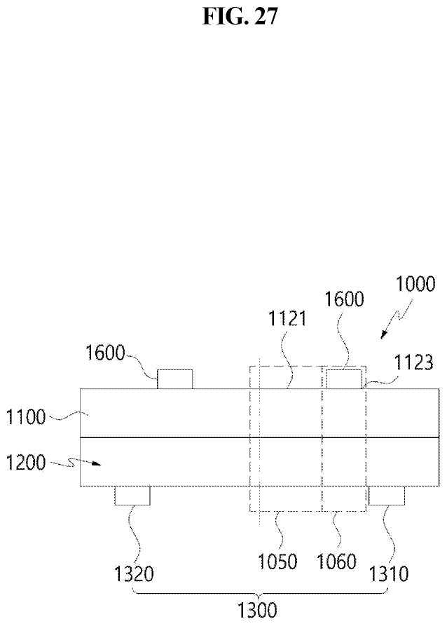

FIG. 27 is still another cross-sectional view of the transparent heating film according to the fifth embodiment. Referring to FIG. 27, the transparent heating film 1000 includes a fifth region 1050 and a sixth region 1060.

The fifth region 1050 may be defined as a central region of the transparent heating film 1000, and the sixth region 1060 may be defined as a peripheral region of the transparent heating film 1000.

The fifth region 1050 may be a portion of the transparent heating film 1000. The first region 1010 may include a center of the transparent heating film 1000. The first region 1010 may not include the center of the transparent heating film 1000.

The fifth region 1050 may be formed in a structure in which a plurality of layers are stacked. The fifth region 1050 may include a portion of the transparent substrate 1100 and a portion of the conductive network 1200. The fifth region 1050 may not include the antenna 1600. The fifth region 1050 may be located to be spaced apart from the antenna 1600. The fifth region 1050 may not include the bus bar 1300. The fifth region 1050 may correspond to the first surface portion 1121 of the second surface 1120 of the transparent substrate 1100. The fifth region 1050 may include the first surface portion 1121 of the second surface 1120 of the transparent substrate 1100. The fifth region 1050 may not correspond to the second surface portion 1123 of the second surface 1120 of the transparent substrate 1100. The fifth region 1050 may be a surface that provides a field of view to the user. The fifth region 1050 may be a surface in which the user's gaze stays most frequently. The fifth region 1050 may be a surface on which the user's gaze is concentrated. The user may identify an object beyond the target member 2000 through the fifth region 1050. When the target member 2000 is a window of a vehicle, the fifth area 1050 may be a surface that provides a field of view to the driver inside the vehicle. The driver inside the vehicle may identify an external object beyond the target member 2000 through the fifth region 1050.

The fifth region 1050 may be optically transparent. The fifth region 1050 may be a region optically more transparent than other regions of the transparent heating film 1000. The fifth region 1050 may be a region optically more transparent region than a sixth region 1060 to be described later. The light transmittance value of the fifth region 1050 may be smaller than the light transmittance value of the transparent substrate 1100.

When a voltage applied from the outside is transmitted to the conductive network 1200 included in the fifth region 1050 via the bus bar 1300, electrons move in the conductive network 1200 so that heat can be generated in the fifth region 1050 of the transparent heating film 1000.

When electromagnetic waves are incident toward the fifth region 1050, the fifth region 1050 may block a signal of a specific frequency region. The intensity of the electromagnetic waves passing through the fifth region 1050 may be reduced. The intensity of a signal in a specific frequency region that has passed through the fifth region 1050 may be reduced. The wavelength of the electromagnetic waves passing through the fifth region 1050 may be increased.

The second region 1020 may be a portion of the transparent heating film 1000. The sixth region 1060 may be a region other than the fifth region 1050. The sixth region 1060 may not overlap the fifth region 1050. The sixth region 1060 may or may not be in contact with the fifth region 1050. The distance between the sixth region 1060 and the center of the transparent heating film 1000 may be greater than the distance between the fifth region 1050 and the center of the transparent heating film 1000. The sixth region 1060 may be located closer to the edge of the transparent heating film 1000 than the fifth region 1050.

The sixth region 1060 may be formed in a structure in which a plurality of layers are stacked. The sixth region 1060 may include more layers or components than the fifth region 1050. The thickness of the sixth region 1060 may be greater than the thickness of the fifth region 1050. The sixth region 1060 may include a portion of the transparent substrate 1100 and a portion of the conductive network 1200. The sixth region 1060 may include the antenna 1600. The sixth region 1060 may or may not include the bus bar 1300.

The second region 1020 may not correspond to the first surface portion 1121 of the second surface 1120 of the transparent substrate 1100. The second region 1010 may not correspond to the second surface portion 1123 of the second surface 1120 of the transparent substrate 1100. The sixth region 1060 may include a second surface portion 1123 of the second surface 1120 of the transparent substrate 1100.

The sixth region 1060 may be optically transparent or opaque. When the sixth region 1060 is optically transparent, the light transmittance value of the sixth region 1060 may be smaller than the light transmittance value of the fifth region 1050.

The amount of the conductive material per unit area of the sixth region 1060 may be greater than the amount of the conductive material per unit area of the fifth region 1050. When a voltage applied from the outside is transmitted to the conductive network 1200 included in the sixth region 1060 via the bus bar 1300, electrons move in the conductive network 1200 included in the sixth region 1060 so that heat can be generated in the sixth region 1060 of the transparent heating film 1000. Electrons transferred to the conductive network 1200 included in the sixth region 1060 may be transferred to the conductive network 1200 included in the fifth region 1050.

When electromagnetic waves are incident toward the sixth region 1060, the sixth region 1060 may absorb and receive a signal in a specific frequency region, and the intensity of the electromagnetic waves passing through the sixth region 1060 may be decreased. The electromagnetic waves passing through the sixth region 1060 may not include a signal of a specific frequency region. The sixth region 1060 may absorb and receive a signal of a specific frequency region better than the fifth region 1050. The radio wave transmittance value of the sixth region 1060 for a specific frequency may be smaller than the radio wave transmittance value of the fifth region 1050. The wavelength of electromagnetic waves passing through the sixth region 1060 may be increased.

Electromagnetic waves including light in the visible light region may be scattered, reflected, refracted, diffracted, or dispersed. The above-described scattered, reflected, refracted, diffracted, or dispersed property of electromagnetic waves may occur when the electromagnetic waves pass through a medium or collide with an obstacle. The transparent substrate 1100 may be a medium or an obstacle with respect to electromagnetic waves including light. When the transparent substrate 1100 is not flat, the scattered, reflected, refracted, diffracted, or dispersed property of electromagnetic waves including light may be increased. When the transparent substrate 1100 is not flat, an object image seen through the transparent substrate 1100 may be distorted.

When the transparent substrate 1100 is deformed or dented while the antenna 1600 is formed on or attached to the transparent substrate 1100, the transparent substrate 1100 may not be flat. In this case, the first surface 1110 of the transparent substrate 1100 may be flat. The second surface 1120 of the transparent substrate 1100 and the periphery of the second surface 1120 may or may not be flat. An object image seen through the first surface 1110 of the transparent substrate 1100 may be less distorted than an object image seen through the second surface 1120. Accordingly, the fifth region 1050 including the first surface 1110 may provide a less distorted field of view than the sixth region 1060 including the second surface 1120. An object image seen through the fifth region 1050 may be less distorted than an object image seen through the sixth region 1060.

5.2 Electromagnetic Wave Reception

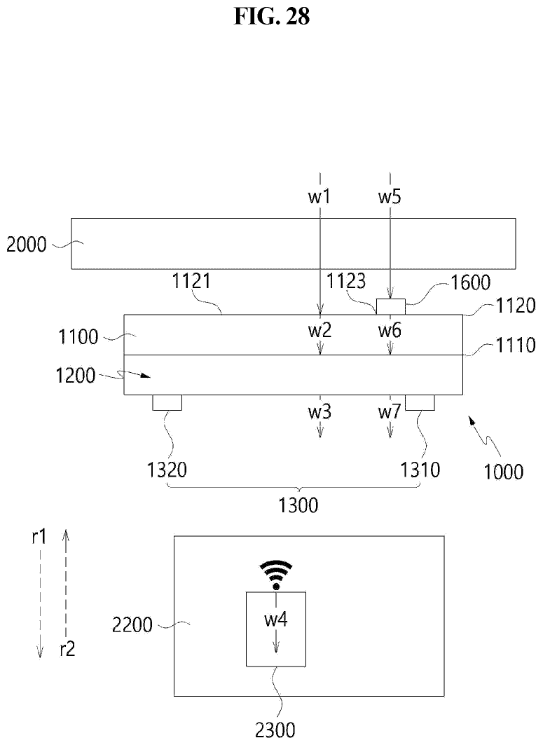

FIG. 28 is a view illustrating electromagnetic wave signal reception of the transparent heating film according to the fifth embodiment. Referring to FIG. 28, a reception space 2200 may be provided in relation to the transparent heating film 1000. An electronic device 2300 may be located inside the reception space 2200.

A direction from the second surface 1120 to the first surface 1110 of the transparent substrate 1100 may be defined as a first direction r1. That is, the first direction r1 may be a direction from the second surface 1120 of the transparent substrate 1100 to the first surface 1110 and from the first surface 1110 to the conductive network 1200. The transparent heating film 1000 may be located in the first direction r1 from the target member 2000, and the reception space 2200 may be located in the first direction r1 from the transparent heating film 1000. The electronic device 2300 may be located inside the reception space 2200.

A direction from the first surface 1110 to the second surface 1120 of the transparent substrate 1100 may be defined as a second direction r2. That is, the second direction r2 may a direction from the conductive network 1200 to the first surface 1110 of the transparent substrate 1100 and from the first surface to the second surface 1120. The transparent heating film 1000 may be located in the second direction r2 from the electronic device 2300 located inside the reception space 2200. The target member 2000 may be located in the second direction r2 from the transparent heating film 1000. An external space may be located in the second direction r2 from the target member 2000.

Electromagnetic waves may be incident on the transparent heating film 1000 along the first direction r1 and the second direction r2. When the target member 2000 is a window of a vehicle, the first direction r1 may be a direction toward the inside of the vehicle, and the second direction r2 may be a direction toward the outside of the vehicle. When the target member 2000 is positioned between the enclosed space and the external space, the first direction r1 may be a direction toward the enclosed space, and the second direction r2 may be a direction toward the external space.

The reception space 2200 may be located outside the transparent heating film 1000. The reception space 2200 may be located in the first direction r1 from the transparent heating film 1000. The reception space 2200 may be located outside the target member 2000. The reception space 2200 may be located in the first direction r1 from the target member 2000. The reception space 2200 may be located closer to the conductive network 1200 than the antenna 1600. When the target member 2000 is a window of a vehicle, the reception space 2200 may be located inside the vehicle.

The reception space 2200 may be a space for receiving electromagnetic waves required for wireless communication. Electromagnetic waves may be radiated to the reception space 2200. The reception space 2200 may be an enclosed space.

The electronic device 2300 may be located in the reception space 2200. The electronic device 2300 may be located outside the transparent heating film 1000. The electronic device 2300 may be located in the first direction r1 from the transparent heating film 1000. The electronic device 2300 may be located outside the target member 2000. The electronic device 2300 may be located in the first direction r1 from the target member 2000. The electronic device 2300 may be located closer to the conductive network 1200 than the antenna 1600. When the target member 2000 is a window of a vehicle, the electronic device 2300 may be located inside the vehicle.

The electronic device 2300 may be a device for wireless communication. When the target member 2000 is a window of a vehicle, the electronic device 2300 may be a device for wireless communication of a user located inside the vehicle. The electronic device 2300 may be a device that absorbs and receives electromagnetic waves. The electronic device 2300 may be a device that absorbs and receives a specific frequency. The electronic device 2300 may be a device that absorbs and receives a first frequency.

The first electromagnetic wave w1 may be incident toward the first surface portion 1121 of the transparent substrate 1100 from the target member 2000 in the first direction r1. The first electromagnetic wave w1 may include a signal of a specific frequency region. The first electromagnetic wave w1 may include a signal of a first frequency region received by the electronic device 2300.

The second electromagnetic wave w2 may be incident toward the conductive network 1200 from the first surface portion 1121 in the first direction r1. The second electromagnetic wave w2 may be that obtained when the first electromagnetic wave w1 transferred toward the first surface portion 1121 of the transparent substrate 1100 via the first object member 2000 in the first direction r1 is incident toward the conductive network 1200 from the first surface portion 1121. The second electromagnetic wave w2 may include a signal in a specific frequency region. The second electromagnetic wave w2 may include a signal of a first frequency region received by the electronic device 2300.

The first surface portion 1121 of the second surface 1120 of the transparent substrate 1100 may receive the first electromagnetic wave w1 passing through the target member 2000 and may output it in the form of the second electromagnetic wave w2. The first surface portion 1121 may transmit the output second electromagnetic wave w2 toward the conductive network 1200.

The third electromagnetic wave w3 may incident from the conductive network 1200 toward the reception space 2200 in the first direction r1. The third electromagnetic wave w3 may be that obtained when the first electromagnetic wave w1 transmitted toward the first surface portion 1121 of the transparent substrate 1100 through the target member 2000 in the first direction r1 is transmitted toward the conductive network 1200 from the first surface portion 1121 as the second electromagnetic wave w2, and the second electromagnetic wave w2 is incident toward the reception space 2200 via the conductive network 1200. The third electromagnetic wave w3 may include a signal in a specific frequency region. The third electromagnetic wave w3 may include a signal in the first frequency region received by the electronic device 2300.

The conductive network 1200 may receive the second electromagnetic wave w2 from the transparent substrate 1100 and output it in the form of the third electromagnetic wave w3. The conductive network 1200 may transmit the output third electromagnetic wave w3 to the reception space 2300.

The intensity of the signal of the third electromagnetic wave w3 may be smaller than the intensity of the signal of each of the first electromagnetic wave w1 and the second electromagnetic wave w2. The intensity of the signal in the first frequency region of the third electromagnetic wave w3 may be smaller than the intensity of the signal in the first frequency region of each of the first electromagnetic wave w1 and the second electromagnetic wave w2. The wavelength of a signal included in the third electromagnetic wave w3 may be longer than the wavelength of a signal included in each of the first electromagnetic wave w1 and the second electromagnetic wave w2. The difference between the third electromagnetic wave w3 and the difference between the first electromagnetic wave w1 and the third electromagnetic wave w3 and the second electromagnetic wave w2 may be caused due to the conductive network 1200.

The fourth electromagnetic wave w4 may be that received and absorbed by the electronic device 2300 located in the reception space 2200. The fourth electromagnetic wave w4 may include a signal in a specific frequency region. The fourth electromagnetic wave w4 may include a signal in the first frequency region received by the electronic device 2300.

The intensity of the signal of the fourth electromagnetic wave w4 may be greater than the intensity of the signal of the third electromagnetic wave w3. The intensity of the signal in the first frequency region of the fourth electromagnetic wave w4 may be greater than the intensity of the signal in the first frequency region of the third electromagnetic wave w3.

The fifth electromagnetic wave w5 may be from the target member 2000 toward the second surface portion 1123 of the transparent substrate 1100 in the first direction r1. The fifth electromagnetic wave w5 may include a signal in a specific frequency region. The fifth electromagnetic wave w5 may include a signal in the first frequency region received by the electronic device 2300. The fifth electromagnetic wave w5 may correspond to the first electromagnetic wave w1. The fifth electromagnetic wave w5 may be the same electromagnetic wave as the first electromagnetic wave w1.

The antenna 1600 may absorb and receive the signal in the first frequency region received by the electronic device 2300. The antenna 1600 may not transmit the signal in the first frequency region to the second surface portion 1123. The antenna 1600 may receive the fifth electromagnetic wave w5 passing through the target member 2000 and output it toward the second surface portion 1123.

The second surface portion 1123 may receive the electromagnetic wave output from the antenna 1600. The second surface portion 1123 may transmit an electromagnetic wave output after the fifth electromagnetic wave w5 passes through the antenna 1600 to the conductive network 1200 in the form of a sixth electromagnetic wave w6.

The sixth electromagnetic wave w6 may be incident toward the conductive network 1200 from the second surface portion 1123 along the first direction r1. The sixth electromagnetic wave w6 may be that obtained when the fifth electromagnetic wave w5 transmitted toward the second surface portion 1123 of the transparent substrate 1100 through the target member 2000 in the first direction r1 is incident on the conductive network 1200 from the second surface portion 1123 via the antenna 1600.

The sixth electromagnetic wave w6 may not include a signal in a specific frequency region. The sixth electromagnetic wave w6 may not include the signal in the first frequency region received by the electronic device 2300.

The intensity of the signal of the sixth electromagnetic wave w6 may be smaller than the intensity of the signal of the fifth electromagnetic wave w5. The intensity of the signal in the first frequency region of the sixth electromagnetic wave w6 may be smaller than the intensity of the signal in the first frequency region of the fifth electromagnetic wave w5.

The intensity of the signal of the sixth electromagnetic wave w6 may be smaller than the intensity of the signal of each of the first electromagnetic wave w1 and the second electromagnetic wave w2. The intensity of the signal in the first frequency region of the sixth electromagnetic wave w6 may be smaller than the intensity of the signal of each of the first electromagnetic wave w1 and the second electromagnetic wave w2. The difference between the sixth electromagnetic wave w6 and the first electromagnetic wave w1 and the difference between the second electromagnetic wave w2 and the fifth electromagnetic wave w5 may be caused due to the antenna 1600.

The seventh electromagnetic wave w7 may incident from the conductive network 1200 toward the reception space 2200 in the first direction r1. The seventh electromagnetic wave w7 may be that obtained when the fifth electromagnetic wave w5 transmitted toward the second surface portion 1123 of the transparent substrate 1100 through the target member 2000 in the first direction r1 passes through the antenna 1600 and is then transmitted toward the conductive network 1200 from the second surface portion 1123 as the sixth electromagnetic wave w6, and the sixth electromagnetic wave w6 is incident toward the reception space 2200 via the conductive network 1200. The seventh electromagnetic wave w7 may not include a signal in a specific frequency region. The seventh electromagnetic wave w7 may not include the signal in the first frequency region received by the electronic device 2300.

The conductive network 1200 may receive the sixth electromagnetic wave w6 from the transparent substrate 1100 and output it in the form of the seventh electromagnetic wave w7. The conductive network 1200 may transmit the output seventh electromagnetic wave w7 to the reception space 2300.

The intensity of the signal of the seventh electromagnetic wave w7 may be smaller than the intensity of the signal of each of the fifth electromagnetic wave w5 and the sixth electromagnetic wave w6. The intensity of the signal in the first frequency region of the seventh electromagnetic wave w7 may be smaller than the intensity of the signal in the first frequency region of the fifth electromagnetic wave w5. The wavelength of a signal included in the seventh electromagnetic wave w7 may be longer than the wavelength of a signal included in each of the fifth electromagnetic wave w5 and the sixth electromagnetic wave w6. The difference between the seventh electromagnetic wave w7 and the fifth electromagnetic wave w5 and the sixth electromagnetic wave w6 may be caused due to the conductive network 1200 or the antenna 1600.

The intensity of the signal of the seventh electromagnetic wave w7 may be smaller than the intensity of the signal of each of the first electromagnetic wave w1 and the second electromagnetic wave w2. The intensity of the signal in the first frequency region of the seventh electromagnetic wave w7 may be smaller than the intensity of the signal in the first frequency region of each of the first electromagnetic wave w1 and the second electromagnetic wave w2. The wavelength of a signal included in the seventh electromagnetic wave w7 may be longer than the wavelength of a signal of each of the first electromagnetic wave w1 and the second electromagnetic wave w2. The difference between the seventh electromagnetic wave w7 and the first electromagnetic wave w1 and the second electromagnetic wave w2 may be caused due to the conductive network 1200 or the antenna 1600.

The intensity of the signal of the seventh electromagnetic wave w7 may be smaller than the intensity of the signal of the third electromagnetic wave w3. The intensity of the signal in the first frequency region of the seventh electromagnetic wave w7 may be smaller than the intensity of the signal in the first frequency region of the third electromagnetic wave w3. The difference between the seventh electromagnetic wave w7 and the third electromagnetic wave w3 may be caused due to the antenna 1600.

The fourth electromagnetic wave w4 received and absorbed by the electronic device 2300 may originate from the reception space 2200. The third electromagnetic wave w3 and the seventh electromagnetic wave w7 may be radiated to the reception space 2200. An eighth electromagnetic wave w8 (not illustrated) that did not pass through the conductive network 1200 may be radiated to the reception space 2200.

The signal in the first frequency region included in the fourth electromagnetic wave w4 may originate from the reception space 2200. The signal in the first frequency region included in the fourth electromagnetic wave w4 may be more influenced by the eighth electromagnetic wave w8 than the third electromagnetic wave w3 and the seventh electromagnetic wave w7.

The eighth electromagnetic wave w8 may include a signal in the first frequency region. The eighth electromagnetic wave w8 may include a signal in the first frequency region absorbed and received by the antenna 1600. A signal in the first frequency region absorbed and received by the antenna 1600 may be transmitted to a separate device and radiated to the space. The separate device may amplify a signal. The eighth electromagnetic wave w8 may include a signal in the first frequency region absorbed and received by the antenna 1600 and radiated to the reception space 2200 through the separate device.

The signal in the first frequency region included in the fourth electromagnetic wave w4 may be influenced by the signal in the first frequency region received by the antenna 1600. The signal in the first frequency region included in the fourth electromagnetic wave w4 may be influenced by the signal in the first frequency region received by the antenna 1600 and radiated to the reception space 2200 through the separate device. The signal in the first frequency region included in the fourth electromagnetic wave w4 may be more influenced by the signal in the first frequency region received by the antenna 1600 than the third electromagnetic wave w3 and the seventh electromagnetic wave w7.

The electronic device 2300 may operate by electromagnetic waves absorbed and radiated by the antenna 1600. The electronic device 2300 may operate according to a signal in the first frequency region of the electromagnetic waves absorbed and radiated by the antenna 1600. The electronic device 2300 may not operate by the third electromagnetic wave w3 and the seventh electromagnetic wave w7. That is, the third electromagnetic wave w3 and the seventh electromagnetic wave w7 are incident on the electronic device 2300, but may not be incident with sufficient intensity to enable the electronic device 2300 to operate. A signal in the first frequency region included in the third electromagnetic wave w3 and the seventh electromagnetic wave w7 is incident on the electronic device 2300, but may not be incident with sufficient intensity to enable the electronic device 2300 to operate.

As described above, the transparent heating film 1000 may receive a signal in a specific frequency region of electromagnetic waves by including the antenna 1600. The transparent heating film 1000 may not block a signal in the first frequency region received by the electronic device 2300. The transparent heating film 1000 may transmit electromagnetic waves to the electronic device 2300. The transparent heating film 1000 may transmit a signal in the first frequency region received by the electronic device 2300. The transparent heating film 1000 may transmit a signal with sufficient intensity in the first frequency region to the electronic device 2300. Accordingly, the electronic device 2300 located in one direction of the transparent heating film 1000 may operate by receiving electromagnetic waves radiated from a space opposite to the one direction of the transparent heating film 1000. An enclosed space may be located in one direction of the transparent heating film 1000, and an external space may be located in a direction opposite to the one direction of the transparent heating film 1000. The electronic device 2300 located in the enclosed space may operate by receiving electromagnetic waves radiated to the external space. Communication failure may not occur in the electronic device 2300 located in the enclosed space. A user located in the enclosed space may not have any inconvenience in using the electronic device 2300.

5.3 Light Blocking Member

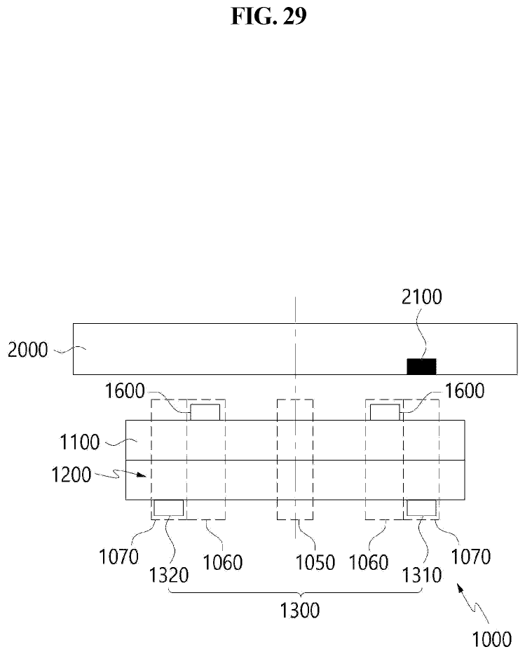

FIG. 29 is a cross-sectional view of the transparent heating film according to the fifth embodiment and a light blocking member. Referring to FIG. 29, the transparent heating film 1000 includes a seventh region 1070, and the target member 2000 includes a light blocking member 2100.

The seventh region 1070 may be defined as an outer peripheral region of the transparent heating film 1000. The light blocking member 2100 may be located on the target member 2000.

The seventh region 1070 may be a portion of the transparent heating film 1000. The seventh region 1070 may be a region other than the sixth region 1060. The seventh region 1070 may not overlap the sixth region 1060. The seventh region 1070 may or may not be in contact with the sixth area 1060. The distance between the seventh region 1070 and the center of the transparent heating film 1000 may be greater than the distance between the fifth region 1050 and the sixth region 1060 and the center of the transparent heating film 1000. The seventh region 1070 may be located closer to an edge of the transparent heating film 1000 than the fifth area 1050 and the sixth area 1060.

The seventh region 1070 may be formed in a structure in which a plurality of layers are stacked. The seventh region 1070 may include more layers or components than the fifth region 1050. Alternatively, the seventh region 1070 may include the same number of layers or components as the fifth region 1050. The seventh region 1070 may include the same number of layers or components as the sixth region 1060. Alternatively, the seventh region 1070 may include fewer layers or components than the sixth region 1060. The above-described differences may vary depending on whether the seventh region 1070 includes the bus bar 1300. The seventh region 1070 may include a portion of the transparent substrate 1100 and a portion of the conductive network 1200. The seventh region 1070 may not include the antenna 1600. The seventh region 1070 may be located to be spaced apart from the antenna 1600. The seventh region 1070 may not be a region for receiving electromagnetic waves. The seventh region 1070 may or may not include the bus bar 1300.

The seventh region 1070 may not correspond to the second surface portion 1123 of the second surface 1120 of the transparent substrate 1100.

The seventh region 1070 may be optically transparent or opaque. When the seventh region 1070 is optically transparent, the light transmittance value of the seventh region 1070 may be equal to or smaller than the light transmittance value of the fifth region 1050. The seventh region 1070 may not be a region for providing a field of view. The seventh region 1070 may be a region that the user cannot see. The seventh region 1070 may be located at an edge of the transparent heating film 1000 to improve aesthetics of the transparent heating film 1000 and the target member 2000. The seventh region 1070 may be a covered region.

The amount of a conductive material per unit area of the seventh region 1070 may be equal to or greater than the amount of a conductive material per unit area of the fifth region 1050. The amount of a conductive material per unit area of the seventh region 1070 may be less than or equal to or greater than the amount of a conductive material per unit area of the sixth region 1060. The above-described differences may vary depending on whether the seventh region 1070 includes the bus bar 1300. In addition, the above-described differences may also vary depending on the sizes of the bus bar 1300 and the antenna 1600 or materials included therein. When the seventh region 1070 includes the bus bar 1300, the amount of a conductive material per unit area in the seventh region 1070 may be greater than the amount of a conductive material per unit area in the fifth region 1050.

When a voltage applied from the outside is transmitted to the conductive network 1200 included in the seventh region 1070 via the bus bar 1300, electrons move from the conductive network 1200 included in the seventh region 1070, so that heat can be generated in the seventh region 1070 of the transparent heating film 1000. The electrons transferred to the conductive network 1200 included in the seventh region 1070 may be transferred to the conductive network 1200 included in the sixth region 1060. When the electrons moves in the conductive network 1200 included in the sixth region 1060, heat can be generated in the sixth region 1060 of the transparent heating film 1000.

The light blocking member 2100 is located on the target member 2000. The light blocking member 2100 may be located at a position close to or far from the transparent heating film 1000 in the target member 2000. The light blocking member 2100 may correspond to a portion of the transparent heating film 1000. The light blocking member 2100 may be located close to an edge of the transparent heating film 1000. The light blocking member 2100 may correspond to the seventh region 1070 of the transparent heating film 1000. The light blocking member 2100 may correspond to a portion of the transparent substrate 1100 and a portion of the conductive network 1200. The light blocking member 2100 may or may not correspond to the bus bar 1300. There may be a plurality of light blocking members 2100. The positions and number of light blocking members 2100 may or may not be limited according to the present embodiment or drawings.

The light blocking member 2100 may be opaque. The light blocking member 2100 may include, but is not limited to, ceramic or enamel. The light blocking member 2100 may include a conductive material. The light transmittance value of the light blocking member 2100 may be smaller than that of the transparent heating film 1000.

The light blocking member 2100 may block light. The light blocking member 2100 may be used for protecting a material in a direction in which light is incident.

The light blocking member 2100 may be formed to be opaque to cover a portion of the target member 2000 or a portion of an object installed on the target member 2000. The object covered by the light blocking member 2100 may be transparent or opaque. The light blocking member 2100 may cover a portion of the transparent heating film 1000 corresponding to the light blocking member 2100. A portion of the transparent heating film 1000 covered by the light blocking member 2100 may be transparent or opaque. The light blocking member 2100 may cover a relatively opaque portion of the transparent heating film 1000. The light blocking member 2100 may cover an edge of the transparent heating film 1000. The light blocking member 2100 may cover the seventh region 1070 of the transparent heating film 1000. The light blocking member 2100 may cover a layer or a structure located in the third region 1030 configured by stacking layers. The light blocking member 2100 may cover a portion of the transparent substrate 1100 and a portion of the conductive network 1200. When the target member 2000 is a window of a vehicle, the light blocking member 2100 may block a portion of the transparent heating film 1000 from being seen by the driver and a pedestrian inside and outside the vehicle.

The light blocking member 2100 may or may not cover the bus bar 1300. When the seventh area 1070 includes the bus bar 1300, and the light blocking member 2100 corresponds to the bus bar 1300, the light blocking member 2100 may cover the bus bar 1300. A user may not be able to see the bus bar 1300 covered by the light blocking member 2100. In this case, the light blocking member 2100 may be used for covering the bus bar 1300 in order to improve aesthetics.

When the light blocking member 2100 includes a conductive material, the light blocking member 2100 may block electromagnetic waves. The light blocking member 2100 including a conductive material may block a signal in a specific frequency region. A portion of the transparent heating film 1000 corresponding to the light blocking member 2100 including a conductive material may not receive a signal in a specific frequency region. The seventh region 1070 corresponding to the light blocking member 2100 including a conductive material may not receive a signal in a specific frequency region. In this case, the seventh region 1070 may not be a space for receiving electromagnetic waves. In this case, the seventh region 1070 may not include the antenna 1600. The light blocking member 2100 may be formed not to cover the antenna 1600.

The light blocking member 2100 may provide an uneven surface to the target member 1000. The light blocking member 2100 may be used for increasing the adhesive force between the target member 1000 and a separate member, or sealing a space between the target member 1000 and the separate member. The light blocking member 2100 may be a frit.

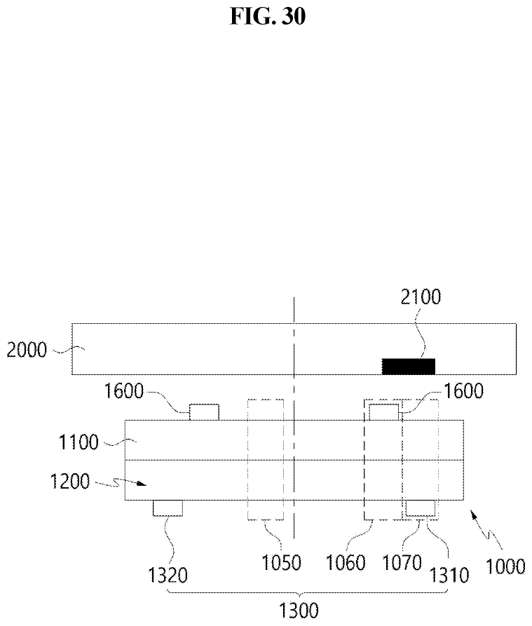

FIG. 30 is another cross-sectional view of the transparent heating film according to the fifth embodiment and a light blocking member. Referring to FIG. 30, the light blocking member 2100 is located on the target member 1000. The light blocking member 2100 may correspond to the seventh region 1070 of the transparent heating film 1000, and may correspond to all or a portion of the sixth region 1060. That is, the light blocking member 2100 may be located to extend not only to the seventh region 1070 but also to the sixth region 1060 of the conductive film 1000. The light blocking member 2100 may correspond to a portion of the transparent substrate 1100 and a portion of the conductive network 1200. The light blocking member 2100 may or may not correspond to the bus bar 1300. The light blocking member 2100 may correspond to or partially correspond to the antenna 1600.

When the light blocking member 2100 does not include a conductive material, the light blocking member 2100 may correspond to the antenna 1600. The light blocking member 2100 may cover the antenna 1600. A user may not be able to see the antenna 1600 covered by the light blocking member 2100. When the target member 2000 is a window of a vehicle, the light blocking member 2100 may block the antenna 1600 from being seen by the driver and a pedestrian inside and outside the vehicle. The light blocking member 2100 may be used for covering the antenna 1600. The light blocking member 2100 may improve the aesthetics of the target member 2000 on which the transparent heating film 1000 is installed by covering the antenna 1600. In this case, the antenna 1600 may be opaque or have a relatively low light transmittance compared to other portions of the transparent heating film 1000.

The light blocking member 2100 may partially correspond to the antenna 1600. The light blocking member 2100 may partially cover the antenna 1600. A user positioned in a diagonal direction of the target member 2000 may not see the antenna 1600 covered by the light blocking member 2100 better than a user positioned in front of the target member 2000. When the light blocking member 2100 covers a portion of the antenna 1600, it is possible to further improve the aesthetics of the target member 2000 on which the transparent heating film 1000 compared to the case in which the light blocking member 2100 does not cover the antenna 1600. In this case, the antenna 1600 may be opaque, and may have a relatively low light transmittance compared to other portions of the transparent heating film 1000. The antenna 1600 may be transparent.

The light blocking member 2100 may partially correspond to the antenna 1600. When the light blocking member 2100 covers a portion of the antenna 1600, it is possible to further improve the aesthetics of the target member 2000 on which the transparent heating film 1000 compared to the case in which the light blocking member 2100 does not cover the antenna 1600. A portion of the antenna 1600 that is spaced apart from the light blocking member 2100 may absorb and receive electromagnetic waves. Accordingly, even when the light blocking member 2100 includes a conductive material, the antenna 1600 may receive electromagnetic waves. In this case, the antenna 1600 may be opaque, and may have a relatively low light transmittance compared to other portions of the transparent heating film 1000. The antenna 1600 may be transparent.

When the light blocking member 2100 partially corresponds to the antenna 1600, there is an advantage in that the antenna 1600 is able to receive electromagnetic waves while improving aesthetics through the light blocking member 2100.

### 6. Sixth Embodiment

The transparent heating film according to the sixth embodiment is the same as the fifth embodiment except that the shape thereof differs from the transparent heating film according to the fifth embodiment. Accordingly, in the description of the sixth embodiment, the same reference numerals are assigned to the components common to the above-described embodiments, and detailed descriptions thereof are omitted.

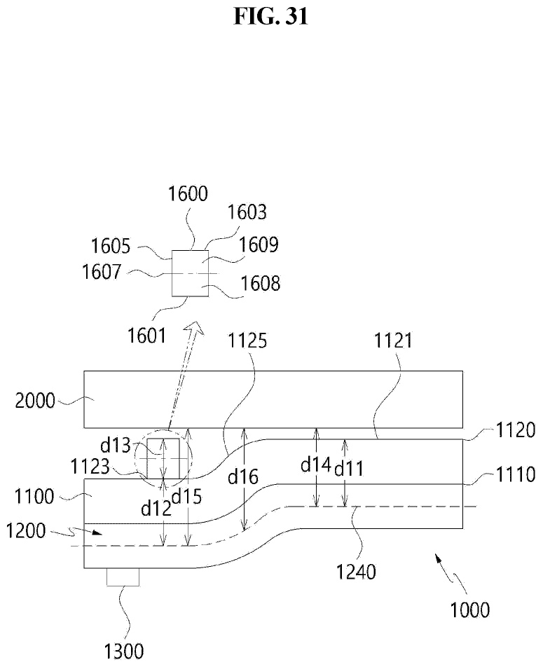

FIG. 31 is a cross-sectional view of a transparent heating film according to a sixth embodiment.

Referring to FIG. 31, the transparent heating film 1000 according to the sixth embodiment may be installed on one target member 2000. The transparent heating film 1000 includes a transparent substrate 1100, a conductive network 1200, a bus bar 1300, and an antenna 1600.

The second surface 1120 of the transparent substrate 1100 includes a first surface portion 1121, a second surface portion 1123, and a third surface portion 1125.

The antenna 1600 includes a third surface 1601, a fourth surface 1603, and an antenna side-surface 1605. The antenna 1600 includes a first portion 1608 and a second portion 1609. The first portion 1608 and the second portion 1609 may be regions divided by an imaginary central plane 1607.

The third surface portion 1125 may be a portion of the second surface 1120 of the transparent substrate 1100. The third surface portion 1125 may be located between the first surface portion 1121 and the second surface portion 1123. The third surface portion 1125 may be a surface interconnecting the first surface portion 1121 and the second surface portion 1123. The third surface portion 1125 may be located on the transparent substrate 1100 in a direction facing the target member 2000. The third surface portion 1125 may be a surface that does not correspond to the antenna 1600.

The third surface portion 1125 may correspond to a portion of the conductive network 1200. The third surface portion 1125 may correspond to a portion of the electron movement plane 1240. The third surface portion 1125 may be spaced apart from the third surface 1601 of the antenna 1600.

The size of the area of the third surface portion 1125 may vary.

The third surface portion 1125 may not be flat. The third surface portion 1125 may be located at a distance from the target member 2000. The distance between the third surface portion 1125 and the target member 2000 may be caused due to a connection between the antenna 1600 and the transparent substrate 1100 and a connection between the transparent heating film 1000 and the target member 2000. The distance between the third surface portion 1125 and the target member 2000 may not be constant, but may change continuously. The third surface portion 1125 may form an acute angle with the target member 2000. In the third surface portion 1125, a distance between a surface portion located close to the first surface portion 1121 and the target member 2000 may be smaller than the distance between the surface portion close to the second surface portion 1123 and the target member 2000. The distance between the third surface portion 1125 and the target member 2000 may decrease from a region adjacent to the second surface portion 1123 to a region adjacent to the first surface portion 1121.

The distance between the third surface portion 1125 and the target member 2000 may be greater than a distance between the first surface portion 1121 and the target member 2000. The distance between the third surface portion 1125 and the target member 2000 may be smaller than the distance between the second surface portion 1123 and the target member 2000. That is, the distance between the third surface portion 1125 and the target member 2000 may have a value between the distance value between the first surface portion 1121 and the target member 2000 and the distance value between the second surface portion 1123 and the target member 2000.

The third surface portion 1125 may transmit light and electromagnetic waves and transfer heat.

The third surface portion 1125 may be a surface formed in the process of installing the transparent heating film 1000 on the target member 2000. As described in the fifth embodiment, the first linear distance d11 of the transparent heating film 1000 may be smaller than the sum of the second linear distance d12 and the third linear distance d13. That is, the antenna 1600 may be completely buried, enclosed, nor embedded in the transparent substrate 1100. Accordingly, one surface of the transparent heating film 1000 on which the antenna 1600 is formed may or may not be flat. One surface of the transparent heating film 1000 on which the antenna 1600 is formed may have a height difference smaller than the third linear distance d13 or the third linear distance d13.

As described in the fifth embodiment, when the transparent heating film 1000 or the transparent substrate 1100 is flat, scattering, reflection, refraction, diffraction, and dispersion of electromagnetic waves including light can be minimized. When the transparent heating film 1000 or the transparent substrate 1100 is flat, the user' field of view may not be distorted. The first surface portion 1121 may be a surface that provides a field of view to the user. When the first surface portion 1121 is flat, the transparent heating film 1000 may not provide a distorted field of view to the user. The first surface portion 1121 may be the flattest surface in the transparent substrate 1100. The first surface portion 1121 may be the closest surface to the target member 2000. The first surface portion 1121 may be in close contact with the target member 2000 without an empty space.

Although not illustrated, the transparent heating film 1000 may be installed in close contact with the target member 2000 without a separate layer. The transparent heating film 1000 may be installed on the target member 2000 using a separate layer or adhesive member, but the separate layer or adhesive member may not have a thickness greater than the step difference. Accordingly, when the first surface portion 1121 is in close contact with the target member 2000, the first surface portion 1121 and the second surface portion 1123 may not be located on the same plane. The second surface portion 1123 may not be in close contact with the target member 2000. The antenna 1600 may be located between the target member 2000 and the second surface portion 1123. The fourth surface 1603 may be in close contact with the target member 2000.

The third surface portion 1125 may be a surface interconnecting the first surface portion 1121 and the second surface portion 1123 that do not share the same plane. The third surface portion 1125 may not be flat. The third surface portion 1125 may be the most convex, curved, distorted, or curved surface in the transparent substrate 1100. The third surface portion 1125 may be a surface having the greatest scattering, reflection, refraction, diffraction, and dispersion of electromagnetic waves including light in the transparent substrate 1100. An object image seen through the third surface portion 1125 may be distorted more than an object image seen through the first surface portion 1121. An object image seen through the region of the transparent heating film 1000 including the third surface portion 1125 may be distorted more than an object image seen through the region of the transparent heating film 1000 including the first surface portion 1121. The light transmittance value of the third surface portion 1125 may be smaller than the light transmittance value of the first surface portion 1121. The light transmittance value of the transparent heating film 1000 including the third surface portion 1125 may be smaller than the light transmittance value of the transparent heating film 1000 including the first surface portion 1121.

Although not illustrated, the third surface portion 1125 may correspond to the light blocking member 2100. The light blocking member 2100 may cover the third surface portion 1125. In this case, the light blocking member 2100 may correspond not only to the seventh region 1070 and the sixth region 1060, but also to a region beyond the sixth region 1060. That is, the light blocking member 2100 may extend to a region beyond the sixth region 1060. A user may not be able to see the third surface portion 1125 covered by the light blocking member 2100. In this case, the light blocking member 2100 may be used for covering the third surface portion 1125 for aesthetics. In this case, the light blocking member 2100 may not include a conductive material.

The fourth linear distance d14 may be defined as a linear distance between the electron movement plane 1240 corresponding to the first surface portion 1121 and the target member 2000. Although not illustrated, the transparent heating film 1000 may be in close contact with the target member 2000 or may be installed on the target member 2000 using a separate layer or adhesive member. The separate layer or adhesive member may not have a thickness equal to or greater than the step difference. The value of the fourth linear distance d14 may vary depending on the shape of the antenna 1600 and the connection between the transparent heating film 1000 and the target member 2000.

The fourth linear distance d14 may be the same as the first linear distance d11. In this case, the transparent heating film 1000 may be in close contact with the target member 2000.

The fourth linear distance d14 may be greater than the first linear distance d11. In this case, the transparent heating film 1000 may be installed on the target member 2000 using a separate layer or adhesive member. The separate layer or adhesive member may not have a thickness equal to or greater than the step difference.

The fourth linear distance d14 may be the same as the second linear distance d12. In this case, the transparent heating film 1000 may be in close contact with the target member 2000. In addition, the antenna 1600 may not be partially buried, enclosed, nor embedded in the transparent substrate 1100. In this case, the fourth linear distance d14 may be smaller than the sum of the second linear distance d12 and the third linear distance d13.

When the fourth linear distance d14 is the same as the second linear distance d12 and the transparent heating film 1000 is in close contact with the target member 2000, the relationships of the first surface portion 1121, the second surface portion 1123, the electron movement plane 1240, the transparent substrate 1100, and the target member 2000 are as follows. The first surface portion 1121 and the second surface portion 1123 may not be located on the same plane. The second surface 1120 of the transparent substrate 1100 may not be flat. The first surface portion 1121 and the second surface portion 1123 may be located at the same distance from the electron movement plane 1240. The first surface portion 1121 and the second surface portion 1123 may be located at the same distance from the first surface 1110 of the transparent substrate 1100. The first surface portion 1121 may be located closer to the target member 2000 than the second surface portion 1123. That is, the distance between the first surface portion 1121 and the target member 2000 may be smaller than the distance between the second surface portion 1123 and the target member 2000, and the difference in distance may be caused due to the installed shape of the transparent heating film 1000, the shape of the antenna 1600, and the connection between the antenna 1600 and the transparent substrate 1100.

The fourth linear distance d14 may be greater than the second linear distance d12. The transparent heating film 1000 may be in close contact with the target member 2000 or may be installed on the target member 2000 using a separate layer or adhesive member. The separate layer or adhesive member may not have a thickness equal to or greater than the step difference. When the transparent heating film 1000 is in close contact with the target member 2000, the antenna 1600 may not be completely buried, enclosed, nor embedded in the transparent substrate 1100, or the antenna 1600 may be partially buried, enclosed, or embedded in the transparent substrate 1100. In this case, the fourth linear distance d14 may be smaller than the sum of the second linear distance d12 and the third linear distance d13.

When the fourth linear distance d14 is greater than the second linear distance d12 and the transparent heating film 1000 is in close contact with the target member 2000, the relationships of the first surface portion 1121, the second surface portion 1123, the electron movement plane 1240, the transparent substrate 1100, and the target member 2000 are as follows. The first surface portion 1121 and the second surface portion 1123 may not be located on the same plane. The second surface 1120 of the transparent substrate 1100 may not be flat. The first surface portion 1121 may be located farther from the electron movement plane 1240 than the second surface portion 1123. The first surface portion 1121 may be located farther from the first surface 1110 of the transparent substrate 1100 than the second surface portion 1123. The first surface portion 1121 may be located closer to the target member 2000 than the second surface portion 1123. That is, the distance between the first surface portion 1121 and the target member 2000 may be smaller than the distance between the second surface portion 1123 and the target member 2000, and the difference in distance may be caused due to the installed shape of the transparent heating film 1000, the shape of the antenna 1600, and the connection between the antenna 1600 and the transparent substrate 1100.

As described above, the fourth linear distance d14 may be smaller than the sum of the second linear distance d12 and the third linear distance d13.

The fifth linear distance d15 may be defined as a linear distance between the electron movement plane 1240 corresponding to the second surface portion 1123 located on the second surface 1120 of the transparent substrate 1100 and the target member 2000. The transparent heating film 1000 may be in close contact with the target member 2000 or may be installed on the target member 2000 using a separate layer or adhesive member. The separate layer or adhesive member may not have a thickness equal to or greater than the step difference. The value of the fifth linear distance d15 may vary depending on the shape of the antenna 1600, the connection between the antenna 1600 and the transparent substrate 1100, and the connection between the transparent heating film 1000 and the target member 2000.

The fifth linear distance d15 may be greater than the first linear distance d11. In this case, the transparent heating film 1000 may be in close contact with the target member 2000, or may be installed on the target member 2000 using a separate layer or adhesive member. The separate layer or adhesive member may not have a thickness equal to or greater than the step difference. When the transparent heating film 1000 is in close contact with the target member 2000, the antenna 1600 may not be completely buried, enclosed, nor embedded in the transparent substrate 1100, and the antenna 1600 may be partially buried, enclosed, or embedded in the transparent substrate 1100. In addition, the antenna 1600 may not be partially buried, enclosed, nor embedded in the transparent substrate 1100.

When the fifth linear distance d15 is greater than the first linear distance d11 and the transparent heating film 1000 is in close contact with the target member 2000, the relationships of the first surface portion 1121, the second surface portion 1123, the electron movement plane 1240, the transparent substrate 1100, and the target member 2000 are as follows. The first surface portion 1121 and the second surface portion 1123 may not be located on the same plane. The second surface 1120 of the transparent substrate 1100 may not be flat. The first surface portion 1121 and the second surface portion 1123 may have the same distance from the electron movement plane 1240, and the distance between the first surface portion 1121 and the electron movement plane 1240 may be greater than the distance between the second surface portion 1123 and the electron movement plane 1240. The first surface portion 1121 and the second surface portion 1123 may have the same distance from the first surface 1110 of the transparent substrate 1100, and the distance between the first surface portion 1121 and the first surface 1110 may be greater than the distance between the second surface portion 1123 and the first surface 1110. The first surface portion 1121 may be located closer to the target member 2000 than the second surface portion 1123. That is, the distance between the first surface portion 1121 and the target member 2000 may be smaller than the distance between the second surface portion 1123 and the target member 2000, and the difference in distance may be caused due to the installed shape of the transparent heating film 1000, the shape of the antenna 1600, and the connection between the antenna 1600 and the transparent substrate 1100.

The fifth linear distance d15 may be greater than the second linear distance d12. In this case, the difference between the fifth linear distance d5 and the second linear distance d2 may be caused due to the connection between the transparent heating film 1000 and the target member 2000 and the antenna 1600.

The fifth linear distance d15 may be the sum of the second linear distance d11 and the third linear distance d13. In this case, the transparent heating film 1000 may be in close contact with the target member 2000.

The fifth linear distance d15 may be greater than the sum of the second linear distance d12 and the third linear distance d13. In this case, the transparent heating film 1000 may be installed on the target member 2000 using a separate layer or adhesive member. The separate layer or adhesive member may not have a thickness equal to or greater than the step difference. In addition, the above-described distance difference may be caused due to the connection between the transparent heating film 1000 and the target member 2000.

The fifth linear distance d15 may be greater than the fourth linear distance d14. In this case, the antenna 1600 may not be completely buried, enclosed, nor embedded in the transparent substrate 1100, and the antenna 1600 may be partially buried, enclosed, or embedded in the transparent substrate 1100. In addition, the antenna 1600 may not be partially buried, enclosed, nor embedded in the transparent substrate 1100.

When the fifth linear distance d15 is greater than the fourth linear distance d14, the relationships of the first surface portion 1121, the second surface portion 1123, the electron movement plane 1240, the transparent substrate 1100, and the target member 2000 are as follows. The first surface portion 1121 and the second surface portion 1123 may not be located on the same plane. The second surface 1120 of the transparent substrate 1100 may not be flat. The first surface portion 1121 and the second surface portion 1123 may have the same distance from the electron movement plane 1240, and the distance between the first surface portion 1121 and the electron movement plane 1240 may be greater than the distance between the second surface portion 1123 and the electron movement plane 1240. The first surface portion 1121 and the second surface portion 1123 may have the same distance from the first surface 1110 of the transparent substrate 1100, and the distance between the first surface portion 1121 and the first surface 1110 may be greater than the distance between the second surface portion 1123 and the first surface 1110. The first surface portion 1121 may be located closer to the target member 2000 than the second surface portion 1123. That is, the distance between the first surface portion 1121 and the target member 2000 may be smaller than the distance between the second surface portion 1123 and the target member 2000, and the difference in distance may be caused due to the installed shape of the transparent heating film 1000, the shape of the antenna 1600, and the connection between the antenna 1600 and the transparent substrate 1100.

The sixth linear distance d16 may be defined as a linear distance between the electron movement plane 1240 corresponding to the third surface portion 1125 located on the second surface 1120 of the transparent substrate 1100 and the target member 2000. The value of the sixth linear distance d16 may vary depending on the shape of the antenna 1600, the connection between the antenna 1600 and the transparent substrate 1100, and the connection between the transparent heating film 1000 and the target member 2000. The sixth straight line distance d16 is not constant and may vary continuously.

The sixth linear distance d16 may have a value greater than the fourth linear distance d14 and smaller than the fifth linear distance d15. That is, the sixth linear distance d16 may be a value between the fourth linear distance d14 and the fifth linear distance d15. The differences of the fourth, fifth and sixth straight distances d4, d5, and d6 may be caused due to the shape of the antenna 1600 and the connection between the antenna 1600 and the transparent substrate 1100. The sixth linear distance d16 becomes closer to the fourth linear distance d14 as approaching the first surface portion 1121, and becomes closer to the fifth linear distance d15 as approaching the second surface portion 1123.

The sixth linear distance d16 may be greater than the first linear distance d11 and the second linear distance d12. In this case, the transparent heating film 1000 may be in close contact with the target member 2000, or may be installed on the target member 2000 using a separate layer or adhesive member. The separate layer or adhesive member may not have a thickness equal to or greater than the step difference. The antenna 1600 may not be completely buried, enclosed, nor embedded in the transparent substrate 1100, and the antenna 1600 may be partially buried, enclosed, or embedded in the transparent substrate 1100. In addition, the antenna 1600 may not be partially buried, enclosed, nor embedded in the transparent substrate 1100.

When the sixth linear distance d16 is greater than the first linear distance d11 and the second linear distance d12, the relationships of the first surface portion 1121, the second surface portion 1123, the electron movement plane 1240, the transparent substrate 1100, and the target member 2000 are as follows. The first surface portion 1121, the second surface portion 1123, and the third surface portion 1125 may not be located on the same plane. The second surface 1120 of the transparent substrate 1100 may not be flat. The first surface portion 1121, the second surface portion 1123, and the third surface portion 1125 may have the same distance from the electron movement plane 1240, and the distance between the first surface portion 1121 and the third surface portion 1125 and the electron movement plane 1240 may be greater than the distance between the second surface portion 1123 and the electron movement plane 1240. The first surface portion 1121, the second surface portion 1123, and the third surface portion 1125 may have the same distance from the first surface 1110 of the transparent substrate 1100, and the distance between first surface portion 1121 and the third surface portion 1125 and the first surface 1110 may be greater than the distance between the second surface portion 1123 and the first surface 1110. The first surface portion 1121 may be located closer to the target member 2000 than the third surface portion 1125, and the third surface portion 1125 may be located closer to the target member 2000 than the second surface portion 1123. That is, the distance between the third surface portion 1125 and the target member 2000 may have a value between the distance between the first surface portion 1121 and the target member 2000 and the distance between the second surface portion 1123 and the target member 2000, and the above-described difference in distances may be caused due to the installed shape of the transparent heating film 1000, the shape of the antenna 1600, and the connection between the antenna 1600 and the transparent substrate 1100.

The central plane 1607 may be located on the antenna 1600. The central plane 1607 may be located parallel to the third surface 1601 and the fourth surface 1603 of the antenna 1600. The central plane 1607 may be located between the third surface 1601 and the fourth surface 1603. The central plane 1607 may be located at the same distance from the third surface 1601 and the fourth surface 1603. The central plane 1607 may be located at the center between the third surface 1601 and the fourth surface 1603. The central plane 1607 may be connected to the antenna side-surface 1605. The central plane 1607 may be connected to the center of the antenna side-surface 1605. When the antenna side-surface 1605 is orthogonal to the third surface 1601 and the fourth surface 1603, the central plane 1607 may be perpendicularly connected to the antenna side-surface 1605.

The central plane 1607 may be located at a distance from the transparent substrate 1100. The central plane 1607 may be parallel to the second surface portion 1123 of the transparent substrate 1100. The central plane 1607 may be located at a distance of half of the third straight distance d13 from the second surface portion 1123 of the transparent substrate 1100.

The central plane 1607 may be a plane that does not come into contact with the second surface 1120 of the transparent substrate 1100. The central plane 1607 may be a plane that does not come into contact with the first surface portion 1121, the second surface portion 1123, and the third surface portion 1125.

The first portion 1608 may be located on the antenna 1600. The first portion 1608 may be located between the central plane 1607 and the third surface 1601. The first portion 1608 may be located between the third surface 1601 and an arbitrary imaginary plane located between the central plane 1607 and the third surface 1601. The first portion 1608 may be located adjacent to the second surface portion 1123 of the second surface 1120 of the transparent substrate 1100. The first portion 1608 may be located to be spaced apart from the first surface portion 1121 of the second surface 1120 of the transparent substrate 1100.

The first portion 1608 may be a portion that does not come into contact with the first surface portion 1121. The first portion 1608 may be a portion that is in contact with the second surface portion 1123 or in contact with a separate layer or adhesive member. The first portion 1608 may or may not be in contact with the third surface portion 1125. When the first portion 1608 is in contact with the third surface portion 1125, the first portion 1608 may be in contact with the third surface portion 1125 at the periphery or edge of the second surface portion 1123.

When the first portion 1608 is in contact with the third surface portion 1125, the first portion 1608 may not be completely buried, enclosed, nor embedded in the transparent substrate 1100, or the first portion 1608 may be partially buried, enclosed, or embedded in the transparent substrate 1100. In this case, the acute angle between the target member 2000 and the third surface portion 1125 may or may not be close to a right angle. The first surface portion 1121 may be located farther from the electron movement plane 1240 than the second surface portion 1123. The first surface portion 1121 may be located farther from the first surface 1110 of the transparent substrate 1100 than the second surface portion 1123.

When the first portion 1608 is in contact with the third surface portion 1125, the first portion 1608 may not be partially buried, enclosed, nor embedded in the transparent substrate 1100. In this case, an acute angle between the target member 2000 and the third surface portion 1125 may increase. The acute angle may be close to a right angle. The inclination between the third surface portion 1125 and the target member 2000 may have a large value in a region adjacent to the second surface portion 1123. The first surface portion 1121 and the second surface portion 1123 may be located at the same distance from the electron movement plane 1240. The first surface portion 1121 and the second surface portion 1123 may be located at the same distance from the first surface 1110 of the transparent substrate 1100.

The distance between the first portion 1608 and the third surface portion 1125 may not be constant, but may change continuously. The distance between the first portion 1608 and the third surface portion 1125 may be smaller than the distance between the first portion 1608 and the first surface portion 1121. As the distance between the first portion 1608 and the third surface portion 1125 is shorter, the transparent heating film 1000 may well adhere to the target member 2000. As the acute angle between the target member 2000 and the third surface portion 1125 is increases, the transparent heating film 1000 may be in close contact with the target member 2000. As the inclination between the third surface portion 1125 and the target member 2000 in a region adjacent to the second surface portion 1123 increases, the transparent heating film 1000 may well adhere to the target member 2000.

The second portion 1609 may be located on the antenna 1600. The second portion 1609 may be located between the central plane 1607 and the fourth surface 1603. The second portion 1609 may be located between the fourth surface 1603 and an arbitrary imaginary plane located between the central plane 1607 and the fourth surface 1603. The second portion 1609 may be located adjacent to the target member 2000.

The second portion 1609 may be located to be spaced apart from the second surface 1120 of the transparent substrate 1100. The second portion 1609 may be located to be spaced apart from the first surface portion 1121, the second surface portion 1125, and the third surface portion 1125 of the second surface 1120.

The second portion 1609 may be a portion that is not in contact with the first surface portion 1121, the second surface portion 1123, and the third surface portion 1125. The reason why the second portion 1609 is not in contact the third surface portion 1125 may be due to an acute angle formed between the third surface portion 1125 and the target member 2000. In addition, the reason why the second portion 1609 is not in contact the third surface portion 1125 may be because the distance between the third surface portion 1125 and the target member 2000 is not constant. The reason why the second portion 1609 is not in contact the third surface portion 1125 may be because the third surface portion 1125 is not in completely contact with the antenna 1600 or the antenna side-surface 1605.

The distance between the second portion 1609 and the third surface portion 1125 may not be constant, but may change continuously. The distance between the second portion 1609 and the third surface portion 1125 may be smaller than the distance between the first portion 1608 and the first surface portion 1121. As the distance between the second portion 1609 and the third surface portion 1125 is shorter, the transparent heating film 1000 may well adhere to the target member 2000.

### 7. Seventh Embodiment

Hereinafter, a transparent heating film according to a seventh embodiment will be described.

The transparent heating film according to the seventh embodiment differs from the transparent heating films according to the fifth and sixth embodiments except that the former differs from the latter in terms of the shape to be installed on a target member and a middle layer is added to the former. Accordingly, in the description of the seventh embodiment, the same reference numerals are assigned to the components common to the above-described embodiments, and detailed descriptions thereof are omitted.

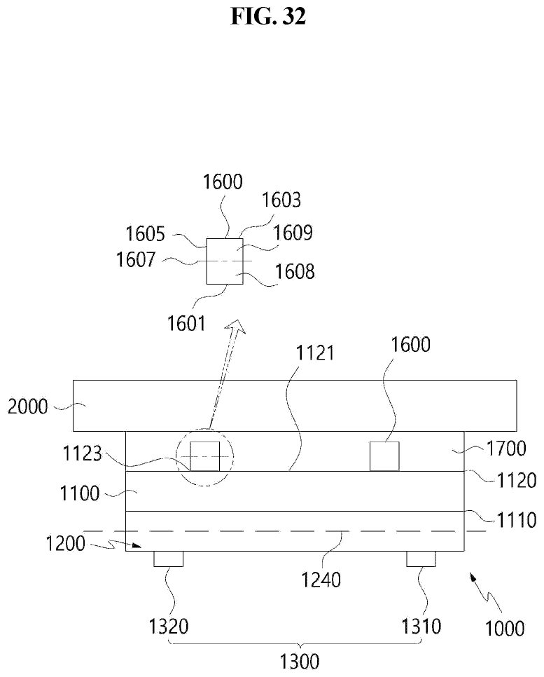

FIG. 32 is a cross-sectional view of the transparent heating film according to the seventh embodiment.

Referring to FIG. 32, the transparent heating film 1000 according to the seventh embodiment may be installed on one target member 2000. A middle layer 1700 may be further included between the target member 2000 and the transparent heating film 1000.

The middle layer 1700 may be located between the target member 2000 and the transparent heating film 1000. The middle layer 1700 may be adjacent to or in contact with the transparent substrate 1100. The middle layer 1700 may be adjacent to or in contact with the antenna 1600. The middle layer 1700 may be adjacent to or in contact with the second surface 1120 of the transparent substrate 1100. The middle layer 1700 may be adjacent to or in contact with the first surface portion 1121. The middle layer 1700 may not be adjacent to nor in contact with the second surface portion 1123.

The middle layer 1700 may be used for connecting the target member 2000 and the transparent heating film 1000. The middle layer 1700 may be used to seal the space between the target member 2000 and the transparent heating film 1000. The middle layer 1700 may be contact with the target member 2000 and the transparent heating film 1000. The middle layer 1700 may be used for fixing the transparent heating film 1000. The middle layer 1700 may be used for burying the transparent heating film 1000. The middle layer 1700 may be used for maintaining the shape of the transparent heating film 1000.

The transparent heating film 1000 may be blocked from external air and moisture via the middle layer 1700. Durability of the transparent heating film 1000 may be improved by the middle layer 1700. The transparent substrate 1100 and the antenna 1600 of the transparent heating film 1000 may be blocked from external air and moisture by the middle layer 1700, and may be improved in durability.

The transparent heating film 1000 may be installed on the target member 2000 using the middle layer 1700. The middle layer 1700 may have a thickness equal to or greater than the step difference. The step difference may be the same as the third linear distance d13 or smaller than the third linear distance d13. The shape of the transparent heating film 1000 installed on the target member 2000 may be similar to that before being installed on the target member 2000. The shape of the transparent heating film 1000 may not change in the process of being installed on the target member 2000. The transparent heating film 1000 may not form the third surface portion 1125 in the process of being installed on the target member 2000. The transparent heating film 1000 may not form a surface in which an object image is distorted in the process of being installed on the target member 2000. The middle layer 1700 may prevent the transparent heating film 1000 from forming a surface in which an object image is distorted in the process of being installed on the target member 2000.

A portion of the transparent heating film 1000 installed on the target member 2000 may not form an acute angle with the target member 2000. The transparent substrate 1100 of the transparent heating film 1000 may not include the third surface portion 1125 between the first surface portion 1121 and the second surface portion 1123. The transparent substrate 1100 of the transparent heating film 1000 may not include a surface in which an object image is distorted around the boundary between the first surface portion 1121 and the second surface portion 1123. The fourth linear distance d14 of the transparent heating film 1000 may be the same as the fifth linear distance d15.

Accordingly, the light blocking member 2100 may not need to cover the third surface portion 1125. The light blocking member 2100 may not be located to extend to a region beyond the sixth region 1060. The light blocking member 2100 may not be located to extend to a region beyond the sixth region 1060 for aesthetics. This effect may be implemented when the third surface portion 1125 is not formed. In addition, this effect may be implemented when the transparent heating film 1000 is installed on the target member 2000 using the middle layer 1700.

The middle layer 1700 may be an energy transfer path between the target member 2000 and the transparent heating film 1000. The middle layer 1700 may conduct heat. Heat generated in the transparent heating film 1000 may be transferred to the middle layer 1700 adjacent to the transparent heating film 1000. The heat transferred to the middle layer 1700 may be transferred to the target member 2000 adjacent to the middle layer 1700.

The middle layer 1700 may transmit light and electromagnetic waves. The middle layer 1700 may be optically transparent. The middle layer 1700 may include a polymer material, such as polyvinyl butyral (PVB), polycarbonate, ethylene vinyl acetate (EVA), thermoplastic polyurethane (TOU), ionomer, ionoplast, cast-in-place (CIP) resin (based on, for example, acryl, polyurethane, or polyester), a thermoplastic material, another suitable polymeric material, or a combination thereof, but is not limited thereto.

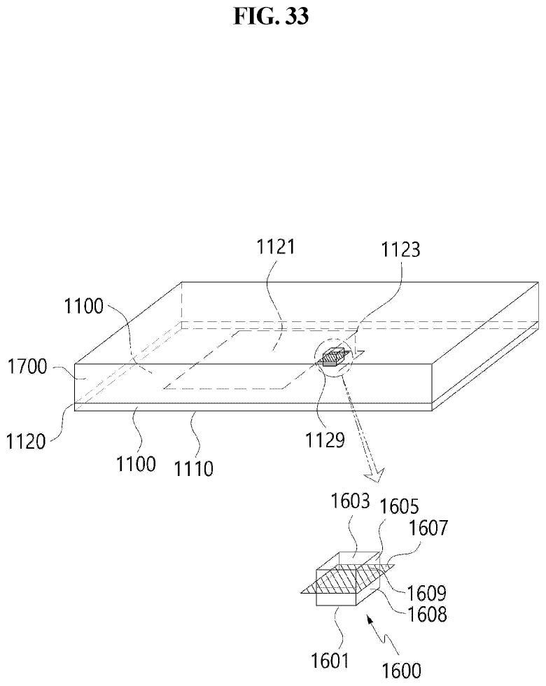

FIG. 33 is a perspective view illustrating the middle layer and the antenna of the transparent heating film according to the seventh embodiment. Referring to FIG. 33, the antenna 1600 of the transparent heating film 1000 according to the seventh embodiment may be adjacent to or in contact with the middle layer 1700.

The middle layer 1700 may be adjacent to or in contact with a surface on which the antenna absorbs and receives electromagnetic waves. The middle layer 1700 may not be in contact with the third surface 1601 of the antenna 1600. The middle layer 1700 may be adjacent to or in contact with the fourth surface 1603 of the antenna 1600. The middle layer 1700 may be adjacent to or in contact with the antenna side-surface 1605.

The middle layer 1700 may be adjacent to or in contact with the central plane 1607 of the antenna 1600. The middle layer 1700 may be adjacent to or in contact with an edge of the central surface 1607 of the antenna 1600. The middle layer 1700 may be adjacent to or in contact with the first portion 1608 and the second portion 1609. The middle layer 1700 may be adjacent to or in contact with the antenna 1600 along the boundary line 1129. The boundary line 1129 may be defined as a line shared by the first surface portion 1121 and the second surface portion 1123 when the first and second surfaces are in contact with each other. The middle layer 1700 may be adjacent to or in contact with the antenna side-surface 1605, the central plane 1607, the first portion 1608, and the second portion 1609 along the boundary line 1129. That is, the antenna 1600 may be buried, enclosed, or embedded in the middle layer 1700. The antenna 1600 may be blocked from external air and moisture by being buried in or in contact with the middle layer 1700. The antenna 1600 may be improved in durability by the middle layer 1700.

### 8. Eighth Embodiment

8.1 Transparent Heating Film

Hereinafter, a transparent heating film according to an eighth embodiment will be described.

The transparent heating film according to the eighth embodiment is the same as those of the fifth to seventh embodiments, except that the former further includes a middle layer compared to the latter, the installed shape of the former is different from those of the latter, and the former is applicable to a plurality of target members. Accordingly, in the description of the eighth embodiment, the same reference numerals are assigned to the components common to the above-described embodiments, and detailed descriptions thereof are omitted.

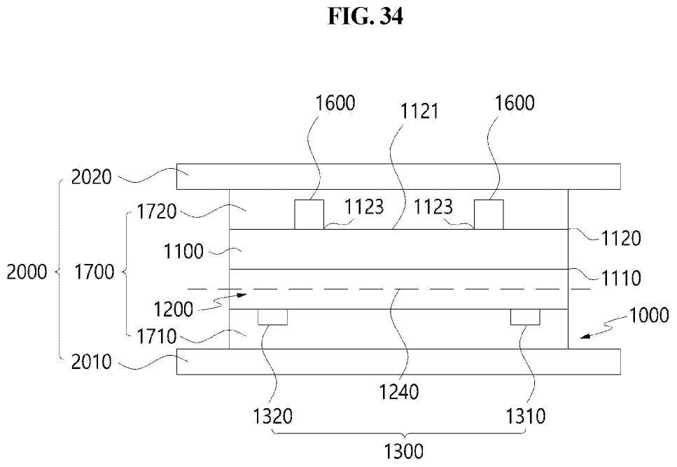

FIG. 34 is a cross-sectional view of the transparent heating film according to the eighth embodiment.

Referring to FIG. 34, the transparent heating film 1000 according to the eighth embodiment may be installed on one or more target members 2000. A middle layer 1700 may be further included between the target member 2000 and the transparent heating film 1000.

There may be two target members 2000, and when there are two target members 2000, the target members 2000 include a first target member 2010 and a second target member 2020. The transparent heating film 1000 is located between the first target member 2010 and the second target member 2020. The first target member 2010 and the second target member 2020 may be located on opposite surfaces of the transparent heating film 1000. When the target member 2000 is a window of a vehicle, the transparent heating film 1000 may be located between stacked structures (laminated glasses when the material is glass). Since the transparent heating film 1000 is located between the first target member 2010 and the second target member 2020, the transparent heating film 1000 may be protected from the outside. The durability of the transparent heating film 1000 may be improved.

The transparent heating film 1000 may be installed on one surfaces of the first target member 2010 and the second target member 2020, and the other surfaces of the first target member 2010 and the second target member 2020 may be in contact with air.

The first target member 2010 and the second target member 2020 may be located in the first direction r1 and the second direction r2 of the transparent heating film 1000. When the enclosed space is oriented in the first direction r1, the external space may be oriented in the second direction r2. The first target member 2010 is located in the first direction r1 of the transparent heating film 1000, and the second target member 2020 may be located in the second direction r2 of the transparent heating film 1000. The first target member 2010 may be located in the enclosed space, and the second target member 2020 may be located in the external space. When the target member 2000 is a window of a vehicle, the first target member 2010 may be located close to the inside of the vehicle, and the second target member 2020 may be located close to the outside of the vehicle. The interior of the vehicle located in the first target member 2010 may be the enclosed space.

The first target member 2010 may come into contact with the air inside the vehicle. The second target member 2020 may come into contact with the air outside the vehicle. The temperatures of surfaces of the first target member 2010 and the second target member 2020 that are in contact with air may be different from each other. In addition, the first target member 2010 and the second target member 2020 may be windows for construction.

The conductive network 1200 and the bus bar 1300 may be located at positions close to the first target member 2010 with reference to the transparent substrate 1100. The antenna 1600 may be located at a position close to the second target member 2020.

When the antenna 1600 is located close to the second target member 2020, the antenna 1600 may first receive electromagnetic waves incident from the outside. When the second target member 2020 is a window of a vehicle, the antenna 1600 may first receive electromagnetic waves incident from the outside of the vehicle.

The conductive network 1200 may include a conductive material and may have electrical conductivity. The conductive network 1200 may provide a passage for electrons to move. When an externally applied voltage is transferred to the conductive network 1200, heat may be generated in the transparent heating film 1000 as electrons move in the conductive network 1200. The heat generated from the transparent heating film 1000 may be transferred to the first target member 2010 and the second target member 2020. The first target member 2010 and the second target member 2020 may be heated.

The air temperature of the enclosed space and the air temperature of the external space may be different from each other. The temperature of one surface of the first target member 2010 located in the enclosed space and the temperature of one surface of the second target member 2020 located in the external space may be different from each other. Water vapor included in the air of the enclosed space and the external space may come into contact with the first target member 2010 and the second target member 2020. The temperatures of the first target member 2010 and the second target member 2020 may rise above the dew point temperature of water vapor due to the heat generated in the transparent heating film 1000. The heat generated from the transparent heating film 1000 may remove fogging or frost occurring on the first target member 2010 and the second target member 2020 or prevent the occurrence of fogging or frost.

The number of the middle layers 1700 may correspond to the number of the target members 2000. When there are two target members 2000, there may be two middle layers 1700. The middle layers 1700 may include a first middle layer 1710 and a second middle layer 1720. The first middle layer 1710 may be located in the first direction r1 of the transparent heating film 1000, and the second middle layer 1720 may be located in the second direction r2 of the transparent heating film 1000. With reference to the transparent heating film 1000, the first middle layer 1710 may be located to face the enclosed space, and the second middle layer 1720 may be located to face the external space.

The first middle layer 1710 and the second middle layer 1720 may be used for connecting the first target member 2010 and the second target member 2020 and the transparent heating film 1000. By being buried in or in contact with the first middle layer 1710 and the second middle layer 1720, the transparent heating film 1000 can be blocked from external air and moisture. The transparent heating film 1000 can be improved by the first middle layer 1710 and the second middle layer 1720 in terms of durability.

The first middle layer 1710 may be adjacent to or in contact with the first target member 2010, and the second middle layer 1720 may be adjacent to or in contact with the second target member 2020. When the first target member 2010 and the second target member 2020 are windows of a vehicle, the first middle layer 1710 may be located to face the inside of the vehicle, and the second middle layer 1720 may be located to face the outside of the vehicle.

The transparent heating film 1000 may be installed on the target member 2000 using the first middle layer 1710 and the second middle layer 1720. The second middle layer 1720 may have a thickness equal to or greater than the step difference. The step difference may be the same as the third linear distance d13 or smaller than the third linear distance d13. Since the transparent heating film 1000 is installed on the target member 2000 using the first middle layer 1710 and the second middle layer 1720, the third surface portion 1125 may not be formed. The structure and effects generated by not forming the third surface portion 1125 are the same as those of the seventh embodiment.

The first middle layer 1710 and the second middle layer 1720 may serve as energy transfer paths between the first target member 2010 and the second target member 2020 and the transparent heating film 1000 to conduct or transfer energy including heat. The heat generated from the transparent heating film 1000 may be transferred to the first target member 2010 via the first middle layer 1710. The heat generated from the transparent heating film 1000 may be transferred to the second target member 2020 via the second middle layer 1720.

The first middle layer 1710 may be adjacent to or in contact with the conductive network 1200 and the bus bar 1300. The conductive network 1200 and the bus bar 1300 of the transparent heating film 1000 may be blocked from external air and moisture by the first middle layer 1710 so that the durability thereof can be improved. Although not illustrated, the first middle layer 1710 may be adjacent to the conductive network 1200 and the bus bar 1300 with a separate layer therebetween.

The second middle layer 1720 may be adjacent to or in contact with the second surface 1120 of the transparent substrate 1100. The second middle layer 1720 may be adjacent to or in contact with the first surface portion 1121. The second middle layer 1720 may not be adjacent to nor in contact with the second surface portion 1123. The second middle layer 1720 may be adjacent to or in contact with the antenna 1600. The transparent substrate 1100 and the antenna 1600 of the transparent heating film 1000 can be improved by the second middle layer 1720 in terms of durability. The structure and effects of the antenna 1600, which is adjacent to or in contact with the second middle layer 1720, are the same as those of the seventh embodiment.

8.2 Electromagnetic Waves

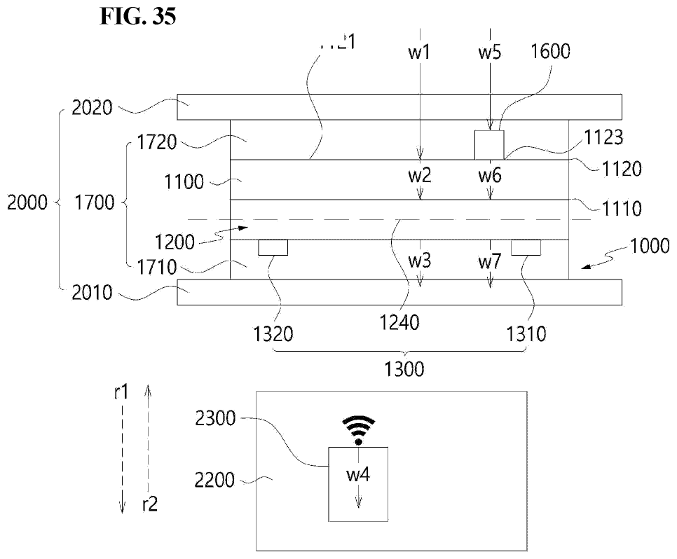

FIG. 35 is a view illustrating electromagnetic wave signal reception of the transparent heating film according to the eighth embodiment. Referring to FIG. 35, a reception space 2200 may be provided in relation to the transparent heating film 1000. An electronic device 2300 may be located inside the reception space 2200.

The first electromagnetic wave w1 may be incident toward the first surface portion 1121 of the transparent substrate 1100 from the target member 2000 in the first direction r1 via the second middle layer 1720.

The second electromagnetic wave w2 may be incident toward the conductive network 1200 from the first surface portion 1121 in the first direction r1.

The first surface portion 1121 of the second surface 1120 of the transparent substrate 1100 may receive the first electromagnetic wave w1 passing through the target member 2000 and the second middle layer 1720 and output it in the form of the second electromagnetic wave w2. The first surface portion 1121 may transmit the output second electromagnetic wave w2 toward the conductive network 1200.

The third electromagnetic wave w3 may be incident toward the reception space 2200 from the conductive network 1200 in the first direction r1 via the first middle layer 1710.

The conductive network 1200 may receive the second electromagnetic wave w2 from the transparent substrate 1100 and output it in the form of the third electromagnetic wave w3. The conductive network 1200 may transmit the output third electromagnetic wave w3 to the reception space 2200.

The fourth electromagnetic wave w4 may be that received and absorbed by the electronic device 2300 located in the reception space 2200.

The fifth electromagnetic wave w5 may be incident toward the second surface portion 1123 of the transparent substrate 1100 from the target member 2000 in the first direction r1 via the second middle layer 1720. The fifth electromagnetic wave w5 may correspond to the first electromagnetic wave w1. The fifth electromagnetic wave w5 may be the same electromagnetic wave as the first electromagnetic wave w1.

The antenna 1600 may absorb and receive the signal in the first frequency region received by the electronic device 2300. The antenna 1600 may not transmit the signal in the first frequency region to the second surface portion 1123. The antenna 1600 may receive the fifth electromagnetic wave w5 passing through the target member 2000 and the second middle layer 1720 and output it toward the second surface portion 1123.

The second surface portion 1123 may receive the electromagnetic wave output from the antenna 1600. The second surface portion 1123 may transmit an electromagnetic wave output after the fifth electromagnetic wave w5 passes through the antenna 1600 to the conductive network 1200 in the form of a sixth electromagnetic wave w6.

The sixth electromagnetic wave w6 may be incident toward the conductive network 1200 from the second surface portion 1123 along the first direction r1. The sixth electromagnetic wave w6 may not include a signal in a specific frequency region. The sixth electromagnetic wave w6 may not include the signal in the first frequency region received by the electronic device 2300.

The seventh electromagnetic wave w7 may be incident toward the reception space 2200 from the conductive network 1200 in the first direction r1 via the first middle layer 1710. The seventh electromagnetic wave w7 may not include a signal in a specific frequency region. The seventh electromagnetic wave w7 may not include the signal in the first frequency region received by the electronic device 2300.

The conductive network 1200 may receive the sixth electromagnetic wave w6 from the transparent substrate 1100 and output it in the form of the seventh electromagnetic wave w7. The conductive network 1200 may transmit the output seventh electromagnetic wave w7 to the first middle layer 1710 and the reception space 2200.

The fourth electromagnetic wave w4 received and absorbed by the electronic device 2300 may originate from the reception space 2200. The third electromagnetic wave w3 and the seventh electromagnetic wave w7 may be radiated to the reception space 2200, and an eighth electromagnetic wave w8 (not illustrated) that does not pass through the conductive network 1200 may be radiated to the reception space 2200. The signal in the first frequency region included in the fourth electromagnetic wave w4 may be more influenced by the signal in the first frequency region associated with the eighth electromagnetic wave w8 received by the antenna 1600 than the third electromagnetic wave w3 and the seventh electromagnetic wave w7.

The relationships and actions of the electronic device 2300, the antenna 1600, and the first to eighth electromagnetic waves w1, w2, w3, w4, w5, w6, w7, and w8 are the same as in the above-described embodiments.

The transparent heating film 1000 including the antenna 1600 of the seventh embodiment may be improved in durability by including the first middle layer 1710 and the second middle layer 1720. The antenna 1600 improved in durability may stably absorb and receive a signal in the first frequency region of electromagnetic waves. Accordingly, the electronic device 2300 may stably receive a signal with sufficient intensity in the first frequency region through the antenna 1600. Communication failure may not occur in the electronic device 2300 located in the enclosed space. A user located in the enclosed space may not have any inconvenience in using the electronic device 2300.

8.3 Light Blocking Member and Transparent Heating Film

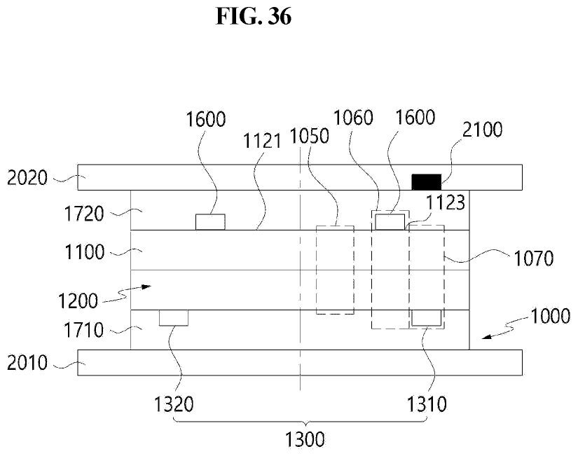

FIG. 36 is a cross-sectional view of the transparent heating film according to the eighth embodiment and a light blocking member. Referring to FIG. 36, the transparent heating film 1000 includes a fifth region 1050, a sixth region 1060, and a seventh region 1070, and the target member 2000 includes a light blocking member 2100. The middle layer 1700 may be located between the transparent heating film 1000 and the target member 2000.

The light blocking member 2100 is located on the target member 2000. When there are two target members 2000, the target members 2000 may include a first target member 2010 and a second target member 2020.

The light blocking member 2100 may be located on one of the first target member 2010 and the second target member 2020. Although not illustrated, the light blocking member 2100 may be located on both the first target member 2010 and the second target member 2020. There may be a plurality of light blocking member 2100.

Although not illustrated, the light blocking member 2100 may be located in the middle layer 1700. When there are two middle layers 1700, the middle layers 1700 may include the first middle layer 1710 and the second middle layer 1720. The light blocking member 2100 may be located on one or both of the first middle layer 1710 and the second middle layer 1720.

The light blocking member 2100 may be located between the middle layer 1700 and the target member 2000. The light blocking member 2100 may be located between the first middle layer 1710 and the first target member 2010. The light blocking member 2100 may be located between the second middle layer 1720 and the second target member 2020. Accordingly, one surface of the light blocking member 2100 may be adjacent to or in contact with a portion of the first middle layer 1710 or the second middle layer 1710, or may occupy a portion of the first middle layer 1710 or the second middle layer 1710.

The light blocking member 2100 may correspond to the seventh region 1070 of the transparent heating film 1000. The light blocking member 2100 may be used for covering the components or layers of the seventh region 1070 in order to improve aesthetics.

In addition, the structure and function of the light blocking member 2100 and the relationship of the light blocking member 2100 with the transparent heating film 1000 are the same as those of the fifth embodiment.

The transparent heating film 1000 may be installed on the first target member 2010 and the second target member 2020 by being buried in or brought into contact with the first middle layer 1710 and the second middle layer 1720. The third surface portion 1125 of the transparent heating film 1000 may not be formed. The transparent substrate 1100 of the transparent heating film 1000 may not include a surface in which an object image is distorted around the boundary between the first surface portion 1121 and the second surface portion 1123. Accordingly, the light blocking member 2100 may not need to cover the third surface portion 1125. The light blocking member 2100 may not be located to extend to a region beyond the sixth region 1060 for aesthetics. In addition, the structure and function of the light blocking member 2100, the relationship of the transparent heating film 1000 with the transparent heating film 1000, and the effect generated by not forming the third surface portion 1125 are the same as those of the seventh embodiment.

In the foregoing, the configuration and features of the present disclosure have been described with reference to embodiments according to the present disclosure. However, it will be apparent to a person ordinarily skilled in the art that the present disclosure is not limited the embodiments, various changes or modifications can be made within the spirit and scope of the present disclosure, and therefore such changes or modifications fall within the scope of the appended claims.

The best mode for carrying out the present disclosure may be included in the mode for carrying out the present disclosure, and related features have been described in the best mode for carrying out the disclosure.

What is claimed is:

1. A transparent heating film comprising:
a transparent substrate including a top surface in which a plurality of grooves are formed and a flat bottom surface; and
a plurality of metal nanostructures located on the top surface of the transparent substrate,
wherein the metal nanostructures have a first distance from a middle plane of the transparent heating film, and an imaginary line extending from the top surface of the transparent substrate has a second distance from the middle plane of the transparent heating film,
the transparent heating film includes a first region in which the first distance is shorter than the second distance,
the first distance is a shortest distance between a first point at which each of the metal nanostructure and the transparent substrate are in contact with each other and the middle plane, the first point is located in each of the grooves, and
a radius of curvature of the metal nanostructures in a region adjacent to the first points is equal to or smaller than a radius of curvature of the groove in the region adjacent to the first point.

2. The transparent heating film of claim 1, wherein a distance of the middle plane of the transparent heating film from the bottom surface of the transparent substrate is half of an average distance between the bottom surface of the transparent substrate and upper surfaces of the plurality of metal nanostructures.

3. The transparent heating film of claim 1, wherein a distance of the middle plane of the transparent heating film from the bottom surface of the transparent substrate is half of an average distance between the imaginary line and the bottom surface of the transparent substrate.

4. The transparent heating film of claim 1, wherein the metal nanostructures each include a first portion and a second portion,
the first portion is a portion located away from the bottom surface of the transparent substrate with reference to the imaginary line extending from the top surface of the transparent substrate, and
the second portion is a portion located close to the bottom surface of the transparent substrate with reference to the imaginary line.

5. The transparent heating film of claim 4, wherein the first portion includes a region having a smaller radius of curvature than the second portion.

6. The transparent heating film of claim 4, wherein, when the transparent heating film is cut in a plane perpendicular to the bottom surface of the transparent substrate, a cross-sectional area of the first portion is greater than a cross-sectional area of the second portion.

7. The transparent heating film of claim 1, wherein, when the transparent heating film is cut in a plane perpendicular to the bottom surface of the transparent substrate, the metal nanostructures each have a circular cross section,
the center of the cross-section has a third distance from the middle plane, and
the third distance is greater than the second distance.

8. The transparent heating film of claim 1, wherein, when the transparent heating film is cut in a plane perpendicular to the bottom surface of the transparent substrate, a cross section of the metal nanostructures has a short axis and a major axis,
the major axis has a fourth distance from the middle plane, and
the fourth distance is greater than the second distance.

9. The transparent heating film of claim 1, further comprising:
a coating layer coated on the metal nanostructures,
wherein the coating layer is in contact with the transparent substrate, but not in contact with the first point.

10. The transparent heating film of claim 9, wherein the radius of curvature of the metal nanostructure in the region adjacent to the first point is smaller than the radius of curvature of the groove in the region adjacent to the first point, and
the coating layer is enclosed into a space between the groove and the metal nanostructure.

11. The transparent heating film of claim 9, further comprising:
a bus bar,
wherein at least one of the metal nanostructures is in contact with the bus bar, but not in contact with the coating layer.

12. The transparent heating film of claim 11, wherein the radius of curvature of the at least one metal nanostructure in the region adjacent to the first point is smaller than the radius of curvature of the grooves in the region adjacent to the first point, and
the bus bar is interposed between the groove and the metal nanostructure.

13. The transparent heating film of claim 1, wherein heat is generated from the metal nanostructures due to movement of electrons transferred to the metal nanostructures via an external voltage,
the heat generated from the metal nanostructures is transferred to an outside of the bottom surface via the top surface of the transparent substrate, and
a temperature of the bottom surface of the transparent substrate facing the plurality of grooves corresponds to a temperature of the bottom surface of the transparent substrate not facing the plurality of grooves.

14. The transparent heating film of claim 1, wherein a second region is defined as a region in which the first distance and the second distance are equal to each other, and
no groove is formed on the top surface of the transparent substrate corresponding to the metal nanostructures of the second region.

15. The transparent heating film of claim 1, wherein the top surface of the transparent substrate of the first region includes protrusions,
the protrusion has a fifth distance from the middle plane, the fifth distance being greater than the second distance, and
an imaginary straight line connecting the protrusions passes through the metal nanostructures.

16. The transparent heating film of claim 15, wherein one metal nanostructure is located between two of the protrusions, and a distance between the two of the protrusions is greater than a diameter of the metal nanostructure.

17. The transparent heating film of claim 9, wherein at least one of metal nanostructures is enclosed in the coating layer, and
the coating layer is divided into three sections by planes parallel to the bottom surface of the transparent substrate, and when the sections are defined as a first space, a second space, and a third space from a space closest to the transparent substrate, a first area occupied by the metal nanostructures in the first space is greater than a second area occupied by the metal nanostructures in the second space, and the second area is greater than a third area occupied by the metal nanostructures in the third space.

18. The transparent heating film of claim 9, wherein an edge of the transparent substrate is curved,
the coating layer is curved in a same direction as the transparent substrate, and
the transparent substrate and the coating layer have different radii of curvature.

19. The transparent heating film comprising:
a transparent substrate including a first surface including curved surfaces and non-curved surfaces and a second surface located in a direction opposite to the first surface; and
a plurality of metal nanostructures located at positions corresponding to the curved surfaces, respectively, and forming a conductive network by intersecting each other,
wherein a distance between the second surface and the curved surfaces is smaller than a distance between the second surface and the non-curved surfaces.
